(19) United States
(12) Patent Application Publication
(10) Pub. No.: US 2025/0206934 A1
(43) Pub. Date: Jun. 26, 2025

(54) HEAT RESISTANT PROPYLENE-ETHYLENE COPOLYMERS AND ADHESIVES CONTAINING THE PROPYLENE-ETHYLENE COPOLYMERS

(71) Applicant: Synthomer Adhesive Technologies LLC, Beachwood, OH (US)

(72) Inventors: Jianning Liu, Johnson City, TN (US); Ke Feng, Kingsport, TN (US); Marc Stacey Somers, Kilgore, TX (US); Bennett Haines Novak, Longview, TX (US); Raymond Prescott Cottle, Longview, TX (US); Terri Roxanne Carvagno, Church Hill, TN (US); Stephen Thaddeus Branch, Bristol, TN (US); Xiaoxiao Li, Kingsport, TN (US); Antonius Wibowo, Gent (BE); Austin Neal Britton, Kingsport, TN (US); Charles Ray Chambers, JR., Kingsport, TN (US)

(21) Appl. No.: 18/845,787

(22) PCT Filed: Sep. 1, 2022
(86) PCT No.: PCT/US2022/042361

§ 371 Date: Sep. 10, 2024

Related U.S. Application Data
(60) Provisional application No. 63/269,737, filed on Mar. 22, 2022.
(60) Provisional application No. 63/269,738, filed on Mar. 22, 2022.
(60) Provisional application No. 63/269,742, filed on Mar. 22, 2022.
(60) Provisional application No. 63/269,743, filed on Mar. 22, 2022.

(51) Int. Cl. C08L 23/16; C09J 123/16

(52) U.S. Cl. CPC C08L 23/16; C09J 123/16; C08L 2201/08; C09J 2423/16

(57) ABSTRACT

A family of propylene-ethylene copolymers have been discovered can be readily utilized in high heat resistance applications and form adhesives with improved mechanical strength and heat resistance. More particularly, the propylene-ethylene copolymers have a particular propylene content, triad tacticity, Ring and Ball softening point, and crystallinity that provide copolymers that exhibit desirable high heat resistance, tensile strength, and elongation. Furthermore, the propylene-ethylene copolymers may be used to produce adhesives that exhibit excellent heat resistance characteristics and superior cohesive strength.

### RELATED APPLICATIONS

This application claims the priority benefit of U.S. Provisional Patent Application Ser. No. 63/269,737 entitled “HEAT RESISTANT PROPYLENE-ETHYLENE COPOLYMERS,” filed Mar. 22, 2022; U.S. Provisional Patent Application Ser. No. 63/269,738, entitled “PROCESS FOR MAKING HEAT RESISTANT PROPYLENE-ETHYLENE COPOLYMERS,” filed Mar. 22, 2022; U.S. Provisional Patent Application Ser. No. 63/269,742, entitled “COMPOSITIONS COMPRISING HEAT RESISTANT PROPYLENE-ETHYLENE COPOLYMERS,” filed Mar. 22, 2022; and U.S. Provisional Patent Application Ser. No. 63/269,743, entitled “PROPYLENE-ETHYLENE COPOLYMER BASED HOT MELT COMPOSITIONS WITH IMPROVED HEAT RESISTANCE,” filed Mar. 22, 2022, the entire disclosures of which are incorporated herein by reference.

### BACKGROUND OF THE INVENTION

Hot melt adhesives used in high heat applications require structure integrity and durability at elevated as well as sub-ambient temperatures. An example are durable assembly applications, such as appliances and automotive interior components located above the seat belt line. For these demanding applications, polyesters, polyamides, and moisture-curable polyurethane-based (PUR) hot melt reactive adhesives, solvent-based one-pack reactive adhesives, and water-based polyurethane (polyurethane dispersant) are frequently used.

Vehicle interior components, such as instrument panels and door trims, typically comprise olefin-based resins such as polypropylene (PP), acrylonitrile-butadiene-styrene copolymers (ABS), and vinyl chloride as base substrates with a PP or urethane foam skin material, typically with a fabric or artificial leather covering laminated on the surface to provide good appearance and feel. Thermoplastic polyolefins compounds (TPO), such as polypropylene blended with uncrosslinked EPDM rubber and/or polyethylene, have become more popular for components in automotive interiors, e.g., parts such as the instrument panel, center consoles, door panels, headliner and interior trims.

Solvent-based modified-chloroprene one-pack reactive adhesives can provide excellent thermal creep resistance properties. However, these chemistries can be expensive and environmentally hazardous, and there are still some disadvantages when using the reactive hot melt adhesives, such as short pot life, a narrow application temperature window, difficulty balancing pot life and cure time, and long curing time that can cause processing difficulties. Additionally, these adhesives typically show poor adhesion to polyolefin substrates. High costs combined with potential health hazards associated with unreacted monomers in car interiors are pushing the OEM and formulator to look for a polyolefin-based hot melt adhesive that can provide high temperature resistance and good adhesion to polyolefin-based substrates with good application temperature window.

It is desirable to have an adhesive with an extended open time (working time between dispensing the adhesive and the time when a bond between substrates can no longer be formed) and good heat resistance, specifically as measured by thermal creep resistance A practical heat resistance of about 80° C. has typically been required for vehicle interior components. For example, U.S. Patent Application Publication No. 2020/0017731 provides a polyolefin-based adhesive with thermal creep resistance at 80° C.; however, it has been observed that automobile dashboards may see temperatures as high as 90° C. or 100° C.

Hot melt adhesive compositions containing amorphous-poly-alpha-olefins (i.e., APO, amorphous polyolefins) or APO/isotactic polypropylene (IPP) blends are well known in the art and have good adhesion to polyolefin substrates without the presence of hazardous monomers. APO-based adhesives typically consist of at least one APO and a hydrocarbon type of tackifier resin, optionally with a wax that may be functionalized. However, it is well known that APO-based hot melt adhesives have poor heat resistance and low cohesive strength that makes them unsuitable for use in durable assembly applications, such as automotive interior components. Recent developments have shown that improved APOs can provide improved performance and be formulated with a variety of polymers, tackifier resins, waxes, and oils, but there is still a need for APOs with greater heat resistance while balancing improved mechanical strength and adhesion to desired substrates.

Amorphous propylene-ethylene copolymers made with Ziegler-Natta catalysts are known as useful ingredients in hot melt adhesive applications. Such copolymers may be intermolecularly heterogeneous in terms of tacticity and/or composition. Further, such copolymers may also be compositionally heterogeneous within a polymer chain. Such characteristics may be, but are not always, the result of reactor process conditions and/or type of catalyst systems used. However, the tensile strength, elongation, and heat resistance of such copolymers are generally not desirable for use in heat resistance applications.

Furthermore, it is known when formulating an adhesive compound for heat resistance that a high melting/softening point polypropylene wax can be added to the composition to improve the temperature resistance, with as much as 14 weight percent of the formulation being a PP wax with melting point of at least 145° C. These waxes are typically very high in crystallinity in order to achieve the desired high melting or softening points. However, these waxes are very brittle materials (as indicated by a low needle penetration) that are energy-intensive to melt. Thus, polypropylene waxes with high tacticity and melting/softening points generally have poor compatibility with the main polyolefin polymer of the adhesive, generally have a low molecular weight, and reduce the adhesive open time. Due to this incompatibility between the wax and the main polyolefin polymer, the resulting adhesive can exhibit poor cohesive strength, elongation, and viscosity.

Thus, there is still need for polyolefin polymers that exhibit desirable heat resistance and manageable processing properties for use in adhesive compositions. Additionally, there is a need for polyolefin polymers that can produce adhesives with high heat resistance and high cohesive strength.

### BRIEF SUMMARY OF THE INVENTION

One or more aspects of the present disclosure generally concern a propylene-ethylene copolymer comprising propylene and ethylene. Furthermore, the propylene-ethylene copolymer: (a) comprises 89 to 98 weight percent of propylene, (b) has a Ring and Ball softening point of at least 135° C., (c) has a triad tacticity (mm %) of at least 50 percent, and (d) has a heat of crystallization (Hc, 20° C./min cooling rate) of at least 25 J/g.

In reference to the propylene-ethylene copolymer disclosed above, one or more aspects of the present disclosure generally concern an adhesive comprising the above-referenced propylene-ethylene copolymer. As noted above, the propylene-ethylene copolymer: (a) comprises 89 to 98 weight percent of propylene, (b) has a Ring and Ball softening point of at least 135° C., (c) has a triad tacticity (mm %) of at least 50 percent, and (d) has a heat of crystallization (Hc, 20° C./min cooling rate) of at least 25 J/g. Furthermore, the adhesive comprises: (a) 5 to 100 weight percent of the propylene-ethylene copolymer; (b) 0 to 90 weight percent of at least one second polymer; (c) not more than 70 weight percent of at least one tackifier; (d) not more than 20 weight percent of a processing oil; and (e) not more than 35 weight percent of at least one wax.

The following statements refer to various aspects of the present disclosure. The following statements regarding the aspects may be combined in any combination or may be separately applicable to the associated aspect (e.g., one of the following limitations may be applicable to the first aspect, while another limitation may not be applicable to the first aspect).

According to a first aspect of the disclosure, there is provided propylene-ethylene copolymer comprising propylene and ethylene, wherein the propylene-ethylene copolymer: (a) comprises 89 to 98 weight percent of propylene, (b) has a Ring and Ball softening point of at least 135° C., (c) has a triad tacticity (mm %) of at least 50 percent, and (d) has a heat of crystallization (Hc, 20° C./min cooling rate) of at least 25 J/g.

In relation to the first aspect, the propylene-ethylene copolymer may comprise 0.5 to 11 weight percent of ethylene.

Additionally or alternatively, the propylene-ethylene copolymer has a viscosity at 190° C. of 1,000 to 50,000 cP.

Additionally or alternatively, the propylene-ethylene copolymer: (a) has a viscosity at 190° C. of 2,000 to 7,000 cP, (b) exhibits a needle penetration of 0.1 to 21 dmm, (c) exhibits a tensile strength at break of 1.5 to 8 MPa, and (d) a heat of crystallization of 25 to 55 J/g.

Additionally or alternatively, the propylene-ethylene copolymer: (a) has a viscosity at 190° C. of 7,000 to 15,000 cP, (b) exhibits a needle penetration of 0.1 to 21 dmm, (c) exhibits a tensile strength at break of 3 to 10 MPa, and (d) a heat of crystallization of 25 to 55 J/g.

Additionally or alternatively, the propylene-ethylene copolymer: (a) has a viscosity at 190° C. of 15,000 to 27,000 cP, (b) exhibits a needle penetration of 0.1 to 21 dmm, (c) exhibits a tensile strength at break of 3 to 14 MPa, and (d) a heat of crystallization of 25 to 55 J/g.

Additionally or alternatively, the propylene-ethylene copolymer: (a) has a viscosity at 190° C. of greater than 27,000 cP, (b) exhibits a needle penetration of 0.1 to 21 dmm, (c) exhibits a tensile strength at break of at least 7 MPa, and (d) a heat of crystallization of 25 to 50 J/g.

Additionally or alternatively, the propylene-ethylene copolymer has a Ring and Ball softening point ranging from 135 to 160° C.

Additionally or alternatively, the propylene-ethylene copolymer has a triad tacticity ranging from 50 to 70 percent.

Additionally or alternatively, the propylene-ethylene copolymer has a needle penetration ranging from 0.1 to 21 dmm.

Additionally or alternatively, the propylene-ethylene copolymer exhibits a tensile strength at break ranging from 1.5 to 14 MPa.

Additionally or alternatively, the propylene-ethylene copolymer has an elongation at break of greater than 300 percent.

Additionally or alternatively, the propylene-ethylene copolymer has a heat of crystallization (Hc, 20° C./min cooling rate) ranging from 20 to 55 J/g.

Additionally or alternatively, the propylene-ethylene copolymer: (a) exhibits a needle penetration of 0.1 to 21 dmm, (b) has a heat of crystallization of 25 to 55 J/g, and (c) has one of the following characteristics—
(i) has a viscosity at 190° C. of 2,000 to 7,000 cP and exhibits a tensile strength at break of 1.5 to 8 MPa, or
(ii) has a viscosity at 190° C. of 7,000 to 15,000 cP and exhibits a tensile strength at break of 3 to 8 MPa,
(iii) has a viscosity at 190° C. of 15,000 to 27,000 cP and exhibits a tensile strength at break of at 3 to 14 MPa, or
(iv) has a viscosity at 190° C. of greater than 27,000 cP, exhibits a tensile strength at break of at least 7 MPa, and a heat of crystallization of 25 to 50 J/g.

Additionally or alternatively, the propylene-ethylene copolymer: (a) has a triad tacticity in the range of 53 to 78 percent, (b) exhibits a Ring and Ball softening point of 135 to 165° C., and (c) exhibits a heat of crystallization of 28 to 60 J/g.

Additionally or alternatively, the propylene-ethylene copolymer: (a) has a viscosity at 190° C. of 15,000 to 50,000 cP, (b) exhibits a tensile strength at break of at least 3 MPa, and (c) exhibits an elongation at break of at least 300 percent.

According to a second aspect of the disclosure, there is provided a composition comprising the propylene-ethylene copolymer as discussed in the first aspect, and additions and alternatives relating to the first aspect.

According to a third aspect of the disclosure, there is provided a method for producing the propylene-ethylene copolymer as discussed in the first aspect, and additions and alternatives relating to the first aspect, in the presence of a Ziegler-Natta catalyst system.

According to a fourth aspect of the disclosure, there is provided an adhesive comprising:
(a) 5 to 100 weight percent of at least one propylene-ethylene copolymer, wherein the propylene-ethylene copolymer comprises ethylene and propylene, wherein the propylene-ethylene copolymer—
   (i) comprises 89 to 98 weight percent of propylene,
   (ii) has a Ring and Ball softening point of at least 135° C.,
   (iii) has a triad tacticity (mm %) of at least 50 percent, and
   (iv) has a heat of crystallization (Hc, 20° C./min cooling rate) of at least 25 J/g
(b) 0 to 90 weight percent of at least one second polymer;
(c) not more than 70 weight percent of at least one tackifier;
(d) not more than 20 weight percent of a processing oil; and
(e) not more than 35 weight percent of at least one wax.

In relation to the fourth aspect, the adhesive composition comprises 5 to 55 weight percent of the second polymer.

Additionally or alternatively, the adhesive composition has (a) a shear adhesion failure temperature at least 135° C., and/or (b) a thermal creep length of 5 mm or less at 110° C.

Additionally or alternatively, the adhesive composition has (a) a shear adhesion failure temperature at least about 135° C., and (b) a thermal creep length of 5 mm or less at 120° C.

Additionally or alternatively, the adhesive composition comprises: (a) 10 to 70 weight percent of the propylene-ethylene copolymer, (b) 5 to 55 weight percent of the second polymer, (c) not more than 70 weight percent of the tackifier, (d) not more than 20 weight percent of the processing oil, and (e) not more than 20 weight percent of the wax.

Additionally or alternatively, the adhesive composition comprises: (a) 5 to 95 weight percent of the propylene-ethylene copolymer, (b) 5 to 90 weight percent of the second polymer, (c) not more than 70 weight percent of the tackifier, (d) not more than 20 weight percent of the processing oil, and (e) not more than 20 weight percent of the wax.

Additionally or alternatively, the adhesive composition comprises: (a) 30 to 80 weight percent of the propylene-ethylene copolymer, (b) 1 to 45 weight percent of the second polymer, (c) not more than 70 weight percent of the tackifier, (d) not more than 20 weight percent of the processing oil, and (e) not more than 20 weight percent of the least one wax.

Additionally or alternatively, the adhesive composition comprises less than 10 weight percent of the wax.

Additionally or alternatively, the second polymer is at least one polymer selected from the group consisting of amorphous polyolefins, semi-crystalline polyolefins, alpha-polyolefins, reactor-ready polyolefins, metallocene-catalyzed polyolefin polymers and elastomers, reactor-made thermoplastic polyolefin elastomers, olefin block copolymers, thermoplastic polyolefins, atactic polypropylene, polyethylenes, ethylene-propylene polymers, propylene-hexene polymers, ethylene-butene polymers, ethylene-octene polymers, propylene-butene polymers, propylene-octene polymers, metallocene-catalyzed polypropylene polymers, metallocene-catalyzed polyethylene polymers, propylene-based terpolymers, copolymers produced from propylene and linear or branched C4-C10 alpha-olefin monomers, copolymers produced from ethylene and linear or branched C4-C10 alpha-olefin monomers, functionalized polyolefins, isoprene-based block copolymers, butadiene-based block copolymers, hydrogenated block copolymers, styrene-ethylene/butylene-styrene block copolymers (SEBS), styrene-isoprene-styrene block copolymers (SIS), styrene-ethylene/propylene-styrene (SEPS), ethylene vinyl acetate copolymers, polyesters, polyester-based copolymers, neoprenes, urethanes, acrylics, polyacrylates, acrylate copolymers, polyether ether ketones, polyamides, hydrogenated styrenic block copolymers, random styrenic copolymers, ethylene-propylene rubbers, ethylene vinyl acetate copolymers, butyl rubbers, styrene butadiene rubbers, butadiene acrylonitrile rubbers, natural rubbers, polyisoprenes, polyisobutylenes, and polyvinyl acetates.

Additionally or alternatively, the propylene-ethylene copolymer may comprise 0.5 to 11 weight percent of ethylene.

Additionally or alternatively, the propylene-ethylene copolymer has a viscosity at 190° C. of 1,000 to 50,000 cP.

Additionally or alternatively, the propylene-ethylene copolymer: (a) has a viscosity at 190° C. of 2,000 to 7,000 cP, (b) exhibits a needle penetration of 0.1 to 21 dmm, (c) exhibits a tensile strength at break of 1.5 to 8 MPa, and (d) a heat of crystallization of 25 to 55 J/g.

Additionally or alternatively, the propylene-ethylene copolymer: (a) has a viscosity at 190° C. of 7,000 to 15,000 cP, (b) exhibits a needle penetration of 0.1 to 21 dmm, (c) exhibits a tensile strength at break of 3 to 10 MPa, and (d) a heat of crystallization of 25 to 55 J/g.

Additionally or alternatively, the propylene-ethylene copolymer: (a) has a viscosity at 190° C. of 15,000 to 27,000 cP, (b) exhibits a needle penetration of 0.1 to 21 dmm, (c) exhibits a tensile strength at break of 3 to 14 MPa, and (d) a heat of crystallization of 25 to 55 J/g.

Additionally or alternatively, the propylene-ethylene copolymer: (a) has a viscosity at 190° C. of greater than 27,000 cP, (b) exhibits a needle penetration of 0.1 to 21 dmm, (c) exhibits a tensile strength at break of at least 7 MPa, and (d) a heat of crystallization of 25 to 50 J/g.

Additionally or alternatively, the propylene-ethylene copolymer has a Ring and Ball softening point ranging from 135 to 160° C.

Additionally or alternatively, the propylene-ethylene copolymer has a triad tacticity ranging from 50 to 70 percent.

Additionally or alternatively, the propylene-ethylene copolymer has a needle penetration ranging from 0.1 to 21 dmm.

Additionally or alternatively, the propylene-ethylene copolymer exhibits a tensile strength at break ranging from 1.5 to 14 MPa.

Additionally or alternatively, the propylene-ethylene copolymer has an elongation at break of greater than 300 percent.

Additionally or alternatively, the propylene-ethylene copolymer has a heat of crystallization (Hc, 20° C./min cooling rate) ranging from 20 to 55 J/g.

Additionally or alternatively, the propylene-ethylene copolymer: (a) exhibits a needle penetration of 0.1 to 21 dmm, (b) has a heat of crystallization of 25 to 55 J/g, and (c) has one of the following characteristics—
(i) has a viscosity at 190° C. of 2,000 to 7,000 cP and exhibits a tensile strength at break of 1.5 to 8 MPa, or
(ii) has a viscosity at 190° C. of 7,000 to 15,000 cP and exhibits a tensile strength at break of 3 to 8 MPa,
(iii) has a viscosity at 190° C. of 15,000 to 27,000 cP and exhibits a tensile strength at break of at 3 to 14 MPa, or
(iv) has a viscosity at 190° C. of greater than 27,000 cP, exhibits a tensile strength at break of at least 7 MPa, and a heat of crystallization of 25 to 50 J/g.

Additionally or alternatively, the propylene-ethylene copolymer: (a) has a triad tacticity in the range of 53 to 78 percent, (b) exhibits a Ring and Ball softening point of 135 to 165° C., and (c) exhibits a heat of crystallization of 28 to 60 J/g.

Additionally or alternatively, the propylene-ethylene copolymer: (a) has a viscosity at 190° C. of 15,000 to 50,000 cP, (b) exhibits a tensile strength at break of at least 3 MPa, and (c) exhibits an elongation at break of at least 300 percent.

According to a fifth aspect of the disclosure, is provided an article comprising the adhesive composition as discussed in the fourth aspect, and additions and alternatives relating to the fourth aspect.

In relation to the fifth aspect, the article is selected from the group consisting of adhesives, sealants, caulks, roofing membranes, waterproof membranes, compounds, and underlayments, carpet, laminates, laminated articles, tapes, labels, mastics, polymer blends, wire coatings, molded articles, heat seal coatings, disposable hygiene articles, insulating glass (IG) units, bridge decking, bitumen modification, asphalt modification, electronic housings, water proofing membranes, cable flooding/filling compounds, sheet molded compounds, dough molded compounds, overmolded compounds, rubber compounds, polyester composites, glass composites, fiberglass reinforced plastics, wood-plastic composites, polyacrylic blended compounds, lost-wax precision castings, investment casting wax compositions, book bindings, candles, windows, tires, films, gaskets, seals, o-rings, motor vehicles, motor bicycles, motor vehicle molded parts, motor vehicle extruded parts, clothing articles, rubber additive/processing aids, and fibers, wherein the adhesives comprise packaging adhesives, food contact grade adhesives, indirect food contact packaging adhesives, product assembly adhesives, woodworking adhesives, edge banding adhesives, profile wrapping adhesives, flooring adhesives, automotive assembly adhesives, structural adhesives, flexible laminating adhesives, rigid laminating adhesives, flexible film adhesives, flexible packaging adhesives, water activated adhesives, home repair adhesives, industrial adhesives, construction adhesives, furniture adhesives, mattress adhesives, pressure sensitive adhesives (PSA), PSA tapes, PSA labels, PSA protective films, self-adhesive films, laminating adhesives, flexible packaging adhesives, heat seal adhesives, industrial adhesives, hygiene nonwoven construction adhesives, hygiene core integrity adhesives, or hygiene elastic attachment adhesives.

### BRIEF DESCRIPTION OF THE FIGURES

Embodiments of the present invention are described herein with reference to the following drawing FIGURES, wherein:

FIG. 1 is a graph comparing the heat of crystallinity and the softening points of the copolymers and waxes of Tables 3A-3D.

### DETAILED DESCRIPTION OF THE INVENTION

We have discovered a family of propylene-ethylene copolymers, which are produced in the presence of a Ziegler-Natta catalyst, that can be readily utilized in high heat resistance applications and form adhesives with improved mechanical strength and heat resistance. More particularly, we have discovered that propylene-ethylene copolymers having a particular propylene content, isotacticity (i.e., triad tacticity), Ring and Ball softening point, and crystallinity exhibit desirable high heat resistance, tensile strength, and elongation. Furthermore, we have discovered that the unique isotacticity of the propylene-ethylene copolymers, as demonstrated by the triad tacticity, is critical in obtaining the desired heat resistant properties and improved mechanical properties.

These propylene-ethylene copolymers are produced by unique process conditions, more specifically, changed external donor/Ti ratio, and changed ethylene flow rate together with adjustment of hydrogen flow rate in the presence of a Ziegler-Natta catalyst.

Furthermore, we have discovered that these inventive propylene-ethylene copolymers may be used to produce adhesives that exhibit excellent heat resistance characteristics and superior cohesive strength. More particularly, the adhesives comprising the inventive propylene-ethylene copolymer exhibit improved heat resistance in performance tests and good peel strength that overcome the shortcomings of the prior art adhesives mentioned above. The adhesives comprising the inventive propylene-ethylene copolymers exhibit superior peel strength to substrates of interest and superior thermal creep resistance at elevated temperatures.

We have also discovered that the inventive propylene-ethylene copolymers have a unique balance of propylene content, isotacticity (as measured by triad tacticity), and softening point that provides a copolymer that can, with no propylene wax, maintain a T-peel strength at 90° C. and pass thermal creep testing at 110° C. Additionally, we have discovered that as much as 20 weight percent of polypropylene wax can be tolerated by the inventive propylene-ethylene copolymers. Furthermore, it was found that adhesives comprising the inventive propylene-ethylene copolymers can be formulated with 8 to 35 weight percent of combinations of polyethylene wax and polypropylene wax to adjust viscosity, fiber tear adhesion, open/set times and other characteristics of the adhesives.

### The Heat Resistant Propylene-Ethylene Copolymers

In an embodiment or in combination with any embodiment mentioned herein, a propylene-ethylene copolymer is provided comprising propylene and ethylene; wherein the amount of propylene ranges from 89 wt % to 98 wt %, wherein the propylene-ethylene copolymer has a Ring and Ball softening point of from 135° C. to 165° C., a triad tacticity (mm %) of 50 to 75%, and a heat of crystallization (Hc, 20° C./min cooling rate) of at least 25 J/g.

In an embodiment or in combination with any embodiment mentioned herein, a propylene-ethylene copolymer is provided comprising propylene and ethylene; wherein the amount of propylene ranges from about 89 wt % to about 98 wt %; wherein the propylene-ethylene copolymer has a Ring and Ball softening point of from about 135° C. to about 160° C., wherein the propylene-ethylene copolymer has a triad tacticity (mm %) of about 50 to about 70%.

According to various embodiments, the propylene-ethylene copolymers described herein can comprise varying amounts of ethylene. In an embodiment or in combination with any embodiment mentioned herein, the propylene-ethylene copolymers can comprise at least 0.5, 1, 2, 3, 4, 5, 6, 7, 8, 9, 10, or 11 weight percent of ethylene, based on the total weight of the copolymer. Additionally, or in the alternative, the propylene-ethylene copolymers can comprise less than 15, 14, 13, 12, 11, 10, 9, 8, 7, 6, 5, 4, or 3 weight percent of ethylene, based on the total weight of the copolymer.

In an embodiment or in combination with any embodiment mentioned herein, the propylene-ethylene copolymers can comprise in the range of about 0.5 to about 11, about 0.5 to about 10, about 0.5 to about 9, about 0.5 to about 8, about 0.5 to about 7, about 0.5 to about 6, about 0.5 to about 5, about 0.5 to about 4, or about 0.5 to about 3, about 1 to about 11, about 1 to about 10, about 1 to about 9, about 1 to about 8, about 1 to about 7, about 1 to about 6, about 1 to about 5, about 1 to about 4, or about 1 to about 3 weight percent of ethylene.

Furthermore, in various embodiments, the propylene-ethylene copolymers can contain varying amounts of propylene. In an embodiment or in combination with any embodiment mentioned herein, the propylene-ethylene copolymers can comprise at least 89, 90, 91, 92, 93, 94, 95, 96, 97, or 98 weight percent of propylene, based on the total weight of the copolymer. Additionally, or in the alternative, the propylene-ethylene copolymers can comprise less than 98, 97, 96, 95, 94, 93, or 92 weight percent of propylene, based on the total weight of the copolymer.

In an embodiment or in combination with any embodiment mentioned herein, the propylene-ethylene copolymers can comprise in the range of about 89 to about 97, about 89 to about 96, about 89 to about 95, about 89 to about 94, about 89 to about 93, about 89 to about 92, about 89 to about 91, about 90 to about 98, about 90 to about 97, about 90 to about 96, about 90 to about 95, about 90 to about 94, about 90 to about 93, about 90 to about 92, about 91 to about 98, about 91 to about 97, about 91 to about 96, about 91 to about 95, about 91 to about 94, about 91 to about 93, about 92 to about 98, about 92 to about 97, about 92 to 96, about 92 to about 95, about 92 to about 94, about 93 to about 97, about 93 to about 96, about 93 to about 95, about 94 to about 98, about 94 to about 97, about 94 to about 96, about 95 to about 98, about 95 to about 97, or about 96 to about 98 weight percent of propylene.

The ethylene and propylene contents of the copolymers is determined by NMR via the technique described in Macromolecules 2000, 33, 1157-1162 by Wang et al., which is incorporated herein by reference in its entirety.

In an embodiment or in combination with any embodiment mentioned herein, the copolymers can contain one or more C₄-C₁₀ alpha-olefins. Generally, C₄-C₁₀ alpha-olefins can be used to increase the resulting bond strength of the copolymers when utilized in adhesives. These C₄-C₁₀ alpha-olefins can include, for example, 1-butene, 1-pentene, 1-hexene, 1-heptene, 1-octene, 1-nonene, 1-decene, and combinations thereof. According to one or more embodiments, the copolymers can comprise not more than 10, 8, 5, 3, 2, 1, 0.5, or 0.1 weight percent of at least one C₄-C₁₀ alpha-olefin, based on the total weight of the copolymer. Moreover, in various embodiments, the copolymers can comprise in the range of 0.5 to 10, 1 to 10, 2 to 10, 3 to 10, 4 to 10, or 5 to 10 weight percent of at least one C₄-C₁₀ alpha-olefin, based on the total weight of the copolymer.

In certain embodiments, the propylene-ethylene copolymers may not contain any C₄-C₁₀ alpha-olefins.

Generally, the softening points of the propylene-ethylene copolymers may be modified and optimized by managing the comonomer content, the triad tacticity, the crystallinity, and the viscosity of the propylene-ethylene copolymers. Lower softening points for the copolymers can be desirable so that the copolymers can be utilized and processed at lower application temperatures. In an embodiment or in combination with any embodiment mentioned herein, the propylene-ethylene copolymers can exhibit a Ring and Ball softening point of at least 135° C., 140° C., or 145° C., as measured according to ASTM E28 Standard Test Method for Softening Point of Resins Derived from Pine Chemicals and Hydrocarbons, by Ring-and Ball Apparatus using a heating rate of 5° C. per minute and a bath liquid of USP Glycerin. Additionally, or in the alternative, the propylene-ethylene copolymers can exhibit a Ring and Ball softening point of less than 165° C., 163 C, 160° C., 158° C., 155° C., 153° C., 150° C., 147° C., 145° C., or 140° C., as measured according to ASTM E28 Standard Test Method for Softening Point of Resins Derived from Pine Chemicals and Hydrocarbons, by Ring-and Ball Apparatus using a heating rate of 5° C. per minute and a bath liquid of USP Glycerin.

In an embodiment or in combination with any embodiment mentioned herein, the copolymers can have a Ring and Ball softening point ranging from about 135 to about 165° C., 135 to about 163° C., about 135 to about 160° C., 135 to about 158° C., about 135 to about 155° C., about 135 to about 153° C., about 135 to about 150° C., about 135 to about 147° C., about 135 to about 145° C., about 135 to about 140° C., about 140 to about 165° C., about 140 to about 163° C., about 140 to about 160° C., about 140 to about 158° C., about 140 to about 155° C., about 140 to about 153° C., about 140 to about 150° C., about 140 to about 148° C., about 140 to about 145° C., about 145 to about 155° C., or about 145 to about 150° C., as measured according to ASTM E28 Standard Test Method for Softening Point of Resins Derived from Pine Chemicals and Hydrocarbons, by Ring-and Ball Apparatus using a heating rate of 5° C. per minute and a bath liquid of USP Glycerin or silicone oil.

In an embodiment or in combination with any embodiment mentioned herein, the propylene-ethylene copolymer may have a triad tacticity of at least 50, 51, 52, 53, 54, 55, 56, 57, 58, 59, 60, 61, 62, 63, 64, or 65 mm content %. Additionally, or the alternative, the propylene-ethylene copolymers may have a triad tacticity of less than 78, 77, 76, 75, 74, 73, 72, 71, or 70, 69, 68, 67, 66, 65, 64, 63, 62, 61, or 60 mm content %.

In an embodiment or in combination with any embodiment mentioned herein, the propylene-ethylene copolymer can have a triad tacticity ranging from about 50 to about 78 mm content %, about 53 to about 78 mm content %, or about 50 to about 70 mm content %. Other ranges are from about 50 to about 65 mm content %, about 50 to about 60 mm content %, about 50 to about 55 mm content %, about 55 to about 70%, about 55 to about 66 mm content %, about 55 to about 65 mm content %, about 55 to about 60 mm content %, about 60 to about 70%, or about 65 to about 70 mm content %.

In an embodiment or in combination with any embodiment mentioned herein, the propylene-ethylene copolymer may have a triad tacticity in the range of 52 to 78, 52 to 77, 52 to 76, 52 to 75, 52 to 74, 52 to 70, 52 to 65, 52 to 60, 53 to 78, 53 to 77, 53 to 76, 53 to 75, 53 to 74, 53 to 70, 53 to 65, 53 to 60, 54 to 78, 54 to 77, 54 to 76, 54 to 75, 54 to 74, 54 to 70, 54 to 67, 54 to 66, 54 to 65, 54 to 60, 55 to 78, 55 to 77, 55 to 76, 55 to 75, 55 to 74, 55 to 70, 55 to 65, 55 to 60, 58 to 78, 58 to 77, 58 to 76, 58 to 75, 58 to 74, 58 to 70, 58 to 68, 60 to 78, 60 to 77, 60 to 76, 60 to 75, 60 to 74, 60 to 70, 60 to 68, 61 to 78, 61 to 77, 61 to 76, 61 to 75, 61 to 74, 61 to 70, or 61 to 68 mm content %.

The triad tacticity of a polymer is the relative tacticity of a sequence of three adjacent propylene units, a chain consisting of head to tail bonds, expressed as a binary combination of meso (m) and racemic (r) sequences. The methodology for measuring triad tacticity is described in the Examples section below.

Generally, the crystallinity of the propylene-ethylene copolymers can be determined via the heat of crystallization. In an embodiment or in combination with any embodiment mentioned herein, the propylene-ethylene copolymers can have a heat of crystallization (Hc, 20° C./min cooling rate, DSC) ranging from about 20 to about 30 J/g, about 20 to about 35 J/g, about 20 to about 40 J/g, about 20 to about 45 J/g, about 20 to about 50 J/g, about 20 to about 55 J/g, about 25 to about 30 J/g, about 25 to about 50 J/g, about 25 to about 55 J/g, about 27 to about 40 J/g, about 28 to about 60 J/g, about 30 to about 35 J/g, about 30 to about 40 J/g, about 30 to about 45 J/g, about 30 to about 50 J/g, about 30 to about 55 J/g, about 35 to about 40 J/g, about 35 to about 45 J/g, about 35 to about 50 J/g, about 40 to about 45 J/g, about 40 to about 50 J/g, or about 40 to about 55 J/g.

In an embodiment or in combination with any embodiment mentioned herein, the propylene-ethylene copolymer may have a heat of crystallization (Hc, 20° C./min cooling rate, DSC) of at least 20, 21, 22, 23, 24, 25, 26, 27, 28, 29, 30, 31, 32, 33, 34, 35, 36, 37, 38, 39, or 40 J/g. Additionally, or the alternative, the propylene-ethylene copolymers may have a heat of crystallization (Hc, 20° C./min cooling rate, DSC) of less than 65, 64, 63, 62, 61, 60, 59, 58, 57, 56, 55, 54, 53, 52, 51, 50, 49, 48, 47, 46, 45, 44, 43, 42, 41, or 40 J/g.

In an embodiment or in combination with any embodiment mentioned herein, the propylene-ethylene copolymer can have a viscosity at 190° C. ranging from about 1,000 to about 120,000 cP, about 1,000 to about 100,000, about 1,000 to about 75,000, about 1,000 to about 50,000, about 1,000 to about 45,000, about 1,000 to about 40,000, about 1,000 to about 35,000 cP, about 1,000 to about 30,000 cP, about 1,000 to about 25,000 cP, about 1,000 to about 20,000 cP, about 1,000 to about 15,000 cP, about 1,000 to about 10,000 cP, about 1,000 to about 5,000 cP, about 1,000 to about 3,000 cP, 2,000 to about 120,000 cP, about 2,000 to about 100,000, about 2,000 to about 75,000, about 2,000 to about 50,000, about 2,000 to about 45,000, about 2,000 to about 40,000, about 2,000 to about 35,000 cP, about 2,000 to about 30,000 cP, about 2,000 to about 25,000 cP, about 2,000 to about 20,000 cP, about 2,000 to about 15,000 cP, about 2,000 to about 10,000 cP, about 2,000 to about 5,000 cP, about 2,000 to about 7,000 cP, or about 2,000 to about 3,000 cP.

In an embodiment or in combination with any embodiment mentioned herein, the propylene-ethylene copolymers can have a low viscosity ranging from about 1,000 to about 7,000 cP at 190° C. (ASTM D-3236). Other low viscosity ranges at 190° C. are from about 1,000 to about 5,000 cP, about 1,000 to about 3,000 cP, or about 2,000 to about 3,000 cP.

In an embodiment or in combination with any embodiment mentioned herein, the propylene-ethylene copolymers can have a medium viscosity ranging from about 7,000 to about 15,000 cP at 190° C. Other medium viscosity ranges at 190° C. are from about 7,000 to about 12,000 cP, about 7,000 to about 10,000 cP, or about 7,000 to about 9,000 cP.

In an embodiment or in combination with any embodiment mentioned herein, the propylene-ethylene copolymers can have a high viscosity ranging from about 15,000 to about 27,000 cP at 190° C. Other high viscosity ranges at 190° C. are from about 15,000 to about 25,000 cP, about 15,000 to about 20,000 cP, or about 15,000 to about 18,000 cP.

In an embodiment or in combination with any embodiment mentioned herein, the propylene-ethylene copolymers can have an ultra-high viscosity at 190° C. of greater than 27,000 cP, greater than 30,000 cP, greater than 35,000 cP, greater than 40,000 cP, greater than 45,000 cP, or greater than 50,000 cP. Other ultra-high viscosity ranges at 190° C. are from about 27,000 to 150,000 cP, about 27,000 to about 125,000 cP, about 27,000 to about 100,000 cP, about 27,000 to about 75,000 cP, about 27,000 to about 70,000, about 27,000 to about 65,000, about 27,000 to about 60,000 cP, about 27,000 to about 55,000 cP, about 27,000 to about 50,000 cP, about 27,000 to about 45,000 cP, about 27,000 to about 40,000 cP, or about 27,000 to about 35,000 cP.

Generally, the needle penetration of the propylene-ethylene copolymers may be modified and optimized by managing the comonomer content, the triad tacticity, and the crystallinity of the propylene-ethylene copolymers. In an embodiment or in combination with any embodiment mentioned herein, the propylene-ethylene copolymers can have a needle penetration ranging from about 0.1 to about 21 decimillimeters (“dmm”) as measured according to ASTM D5. Other exemplary needle penetration ranges are from 1 to 19 dmm, 1 to 16 dmm, 2 to 10 dmm, 2 to 8 dmm, 3 to 21 dmm, 3 to 19 dmm, 3 to 16 dmm, 3 to 10 dmm, 3 to 8 dmm, 4 to 21 dmm, 4 to 19 dmm, 4 to 16 dmm, 4 to 10 dmm, 4 to 8 dmm 2 to about 21 dmm. Other ranges are from 2 to 19 dmm, 2 to 16 dmm, 2 to 10 dmm, 2 to 8 dmm, 3 to 21 dmm, 3 to 19 dmm, 3 to 16 dmm, 3 to 10 dmm, 3 to 8 dmm, 4 to 21 dmm, 4 to 19 dmm, 4 to 16 dmm, 4 to 10 dmm, or 4 to 8 dmm.

Generally, the tensile strength at break of the propylene-ethylene copolymers may be modified and optimized by managing the comonomer content, the triad tacticity, the crystallinity, and the viscosity, of the propylene-ethylene copolymers. In an embodiment or in combination with any embodiment mentioned herein, the propylene-ethylene copolymers can have a tensile strength at break (MPa) ranging from about 1.5 to about 25 MPa, about 1.5 to about 18 MPa, about 1.5 to about 17 MPa, about 3 to about 17 MPa, about 1.5 to about 14 MPa, about 3 to about 18 MPa, about 3 to about 15 MPa, about 3 to about 14 MPa, about 3 to about 12 MPa, about 3 to about 10 MPa, about 3 to about 8 MPa, about 3 to about 6 MPa, about 4 to about 14 MPa, about 4 to about 12 MPa, about 4 to about 10 MPa, about 4 to about 8 MPa, about 4 to about 6 MPa, about 5 to about 14 MPa, about 5 to about 12 MPa, about 5 to about 10 MPa, 5 to about 8 MPa, about 6 to about 14 MPa, about 6 to about 12 MPa, about 6 to about 10 MPa, about 6 to about 8 MPa, about 7 to about 14 MPa, about 7 to about 12 MPa, about 7 to about 10 MPa, about 8 to about 14 MPa, or about 8 to about 12 MPa, as measured according to ASTM D412.

In an embodiment or in combination with any embodiment mentioned herein, the propylene-ethylene copolymers can have an elongation at break (MPa) of greater than 100%, greater than 200%, greater than 300%, greater than 350%, greater than 375% greater than 400%, greater than 425%, greater than 450%, greater than 475%, and greater than 500%, as measured according to ASTM D412. For example, the propylene-ethylene copolymer can have an elongation at break (MPa) ranging from 300% to 2,000%, 300% to 1,000%, from 300% to about 800%

In an embodiment or in combination with any embodiment mentioned herein, the propylene-ethylene copolymers can have a heat of fusion (Hf, 20° C./min heating rate, DSC) ranging from about 18 to about 45 J/g, about 10 J/g to about 36 J/g, about 10 to about 30 J/g, about 10 to about 25 J/g, about 10 to about 20 J/g, about 10 to about 15 J/g, 10 J/g to about 36 J/g, about 10 to about 30 J/g, about 10 to about 25 J/g, about 10 to about 20 J/g, about 10 to about 15 J/g, 15 J/g to about 36 J/g, about 15 to about 30 J/g, about 15 to about 25 J/g, about 15 to about 20 J/g, about 20 J/g to about 36 J/g, about 20 to about 30 J/g, or about 20 to about 25 J/g.

Table 1 shows various embodiments of the propylene-ethylene copolymers. Generally, the inventive ethylene copolymers comprise from about 89 to about 98 weight percent of propylene, have a Ring and Ball softening point of from about 135° C. to about 165° C., a triad tacticity of about 50 to about 78%, and at least one other property selected from Table 1. For ease of reference and not to be considered as limiting the invention, the polymers are designated in four “families” in Table 1A and Table 1B: (1) High viscosity, high tensile and high RBSP polymers; (2) Medium viscosity, high tensile and high RBSP polymers; (3) Ultra-high viscosity and high RBSP polymers; and (4) Low viscosity and high RBSP polymers.

TABLE 1A

| | Propylene-Ethylene | | Propylene-Ethylene | |
|---|---|---|---|---|
| | Copolymer (High | | Copolymer (Medium | |
| | Viscosity, family 1) | | Viscosity, family 2) | |
| Viscosity, cP@190 | 15000-27000 | cP | 7000-15000 | cP |
| C. | | | | |
| Needle Penetration | 0.1-21 dmm, 1-19 dmm, | | 0.1-21 dmm, 1-15 dmm, | |
| (dmm) | or 3-12 dmm | | or 3-16 dmm | |
| Tensile strength at | 3-13 MPa or | | 3-10 | MPa |
| break (MPa) | 3-10 MPa | | | |
| Elongation at | >200%, >300%, | | >200%, >300%, | |
| break (%) | or >500% | | or >500% | |
| Heat of crystal- | 29-52 | J/g | 28-42 | J/g |
| lization (Hc, 20° | | | | |
| C./min cooling rate) | | | | |
| Heat of fusion (Hf, | 19-36 | J/g | 19-31 | J/g |
| 20° C./min heating | | | | |
| rate) | | | | |

TABLE 1B

| | Ultra-high viscosity, | | Low viscosity, | |
|---|---|---|---|---|
| | family 3 | | family 4 | |
| Viscosity, cP@190 C. | >27000 | cP | 2000-7000 | cP |
| Needle Pen (dmm) | 0.1-21 dmm, 2-8 dmm, | | 0.1-21 dmm, 0.1-14 | |
| | or 3-16 dmm | | dmm, or 3-16 dmm | |
| Tensile strength at break | 3-18 MPa or 7-18 MPa | | 2-7 | MPa |
| (MPa) | | | | |
| Elongation at break (%) | >300% or >500% | | <300% or <500% | |
| Heat of crystallization | 29-45 | J/g | 29-59 | J/g |
| (Hc, 20° C./min | | | | |
| cooling rate) | | | | |
| Heat of fusion (Hf, 20° | 19-39 | J/g | 18-45 | J/g |
| C./min heating rate) | | | | |

In an embodiment or in combination with any embodiment mentioned herein, the copolymers described herein do not exhibit substantial changes in color when subjected to storage conditions at elevated temperatures over extended periods of time. Before any aging due to storage occurs, the inventive copolymers can have an initial Gardner color of less than 4, 3, 2, or 1 as measured according to ASTM D1544. After being heat aged at 177° C. for at least 96 hours, the inventive copolymers can exhibit a final Gardner color of less than 7, 5, 3, or 2 as measured according to ASTM D1544. Thus, the inventive copolymers can retain a desirable color even after prolonged storage and exposure.

Additionally, the copolymers described herein can be amorphous or semi-crystalline. As used herein, “amorphous” means that the copolymers have a crystallinity of less than 5 percent as measured using Differential Scanning calorimetry (“DSC”) according to ASTM E 794-85. As used herein, “semi-crystalline” means that the copolymers have a crystallinity in the range of 5 to 40 percent as measured at 20° C./min scan rate, using DSC according to ASTM E 794-85. In various embodiments, the copolymers can have a crystallinity of not more than 60, 40, 30, 20, 10, 5, 4, 3, 2, or 1 percent as measured at 20° C./min scan rate, using DSC according to ASTM E 794-85. Additionally, or in the alternative, the copolymers can have a crystallinity of less than 60, 50, 45, 40, 35, 30, 25, 24, 23, or 22 percent, as measured using DSC at 20° C./min according to ASTM E 794-85. For example, the copolymers can have a crystallinity in the range of 2 to 50, 3 to 46, 4 to 40, 4 to 30, 4 to 20, 16 to 25, 16 to 23, 17 to 25, 17 to 23, 20 to 35, or 20 to 30 percent, as measured using DSC at 20° C./min according to ASTM E 794-85.

### The Processes for Producing the Propylene-Ethylene Copolymers

An objective of the present invention is to provide a group of propylene-ethylene copolymers that can be used in high heat resistance applications and that exhibit improved mechanical strength. While not wishing to be bound by theory, it is believed that the unique heat resistance and the ability to support a load at elevated temperature are obtainable due to a combination of several different copolymer characteristics, such as the propylene/ethylene contents of the copolymers, the triad tacticity content (mm %) of the copolymers, the Ring and Ball softening points of the copolymers, and the heat of crystallization of the copolymers. The objectives of the present invention are met by a specific range of polymer composition, more specific, propylene/ethylene comonomer ratio together with a preferred range of propylene triad tacticity content (mm %). Those polymer compositions are met by improved process conditions.

In an embodiment or in combination with any embodiment mentioned herein, the copolymers can be produced by reacting propylene monomers and ethylene monomers in the presence of a catalyst system comprising at least one electron donor.

In an embodiment or in combination with any embodiment mentioned herein, the catalyst system can comprise a Ziegler-Natta catalyst. According to one or more embodiments, the Ziegler-Natta catalyst can contain a titanium-containing component, an aluminum component, and an electron donor. In certain embodiments, the catalyst comprises titanium chloride on a magnesium chloride support.

The catalyst systems, in certain embodiments, can comprise a heterogeneous-supported catalyst system formed from titanium compounds in combination with organoaluminum co-catalysts. In various embodiments, the co-catalyst can comprise an alkyl aluminum co-catalyst, such as triethyl aluminum (“TEAL”).

In one or more embodiments, the catalyst system can have an aluminum to titanium molar ratio of at least 1:1, 2:1, 3:1, 4:1, 5:1, 6:1, 7:1, 8:1, 9:1, 10:1, or 15:1 and/or not more than 100:1, 50:1, 35:1, or 25:1. Moreover, the catalyst system can have an aluminum to titanium molar ratio in the range of 1:1 to 100:1, 5:1 to 50:1, 10:1 to 35:1, or 15:1 to 25:1. Additionally or alternatively, in various embodiments, the catalyst system can have a molar ratio of aluminum to silicon of at least 0.1:1, 0.5:1, 1:1, 2:1, 3:1, 4:1, 5:1, or 6:1 and/or not more than 100:1, 50:1, 35:1, 20:1, 15:1, 10:1, or 8:1. Moreover, the catalyst system can have a molar ratio of aluminum to silicon in the range of 0.5:1 to 100:1, 1:1 to 50:1, 2:1 to 35:1, 2:1 to 20:1, 2:1 to 15:1, 2:1 to 10:1, or 2:1 to 8:1.

Electron donors are capable of increasing the copolymer's stereospecificity. However, it can be important to closely regulate the contents of the electron donors since they can suppress catalyst activity to unacceptable levels in some circumstances. The electron donors used during the polymerization process can include, for example, organic esters, ethers, alcohols, amines, ketones, phenols, phosphines, and/or organosilanes. Furthermore, the catalyst system can comprise internal donors and/or external donors.

There have been numerous generations of internal donors for Ziegler-Natta Catalyst systems, as defined in “Stereospecific α-Olefin Polymerization with Heterogeneous Catalysts,” by J. Severn and R. L. Jones Jr, Handbook of Transition Metal Polymerization Catalysts, (2018) Chapter 9, p 229-312, herein incorporated by reference in its entirety. The Ziegler-Natta catalyst generations as described by Severn and Jones as follows:

Ziegler-Natta catalyst Generation 3 (Benzoate): The third-generation catalysts commonly comprise MgCl₂, TiCl₄ and an internal electron donor that are combined with an aluminum alkyl cocatalyst such as Al(CH₂CH₃)₃. An “external” electron donor can be added to the catalyst system. The internal donor in third-generation catalysts is typically ethyl benzoate, which is used in combination with a second aromatic ester, such as methyl p-toluate or ethyl p-ethoxybenzoate (PEEB), as an external donor. An external donor is required due to the fact that a large proportion of the internal donor is lost as a result of reaction involving the cocatalyst, such as alkylation and/or complexation reactions. To a large extent, the external donor replaces the internal donor in the solid catalyst, maintaining high catalyst stereospecificity.

Ziegler-Natta catalyst Generation 4 (Phthalate): The fourth generation catalysts comprise MgCl₂, TiCl₄ and an internal electron donor that are combined with an aluminum alkyl cocatalyst such as Al(CH₂CH₃)₃. And an “external” electron donor can be added to the catalyst system. The internal donor in fourth-generation catalysts is phthalate/alkoxysilane-based. It was found that bidentate phthalate donors may form strong chelating complexes with tetracoordinate Mg atoms on the (110) face of MgCl₂ or binuclear complexes with two pentacoordinate Mg atoms on the (100) face.

Ziegler-Natta catalyst Generation 5 (Diethers and Succinates): It was found that certain diether compounds, in particular 2,2-disubstituted-1,3-dimethoxypropanes with an oxygen-oxygen distance in the range 2.8-3.2 Å, similar to those of the alkoxysilane external donors, are not extracted when the catalyst is brought into contact with the Al(CH₂CH₃)₃ cocatalyst. As a result of this, high stereospecificity can be obtained even in the absence of external donor for fifth generation diether catalyst systems. Fifth generation diether catalyst systems can show particularly high polymerization activity and good stability. They also give relatively narrow molecular weight distribution (MWD) and show high sensitivity to hydrogen. Lately, new types of internal donor compounds based on aliphatic dicarboxylic esters, such as malonates and glutarates, and in particular succinates and polyol esters, have been employed. An alkoxysilane is often used as external donor.

Ziegler-Natta catalyst Generation 6 (Phthalate replacement): The new 1,2-phenylene dibenzoate internal donors used in Generation 6 Ziegler-Natta catalysts are important as phthalate replacements. In addition, there has been an increase in disclosures of mixed internal donors, for example, blending succinate and diether, or blending succinate and dimethoxytoluene. Generation 6 catalysts can also result in high stereospecificity in the absence of external donor. Thus, depending on crystallinity targets, external donors may or may not be used to reach the desired crystallinity targets.

In an embodiment or in combination with any embodiment mentioned herein, the higher generation than the third- and fourth-generation Ziegler-Natta catalyst system can be operated in the absence of external electron donor Depending on crystallinity targets, external donors may or may not be used to reach the desired crystallinity targets when using Generation 5 and Generation 6 catalyst systems.

In an embodiment or in combination with any embodiment mentioned herein, the catalyst systems may comprise the third generation Ziegler-Natta Catalyst, the fourth generation Ziegler-Natta Catalyst, the fifth generation Ziegler-Natta Catalyst, or the sixth generation Ziegler-Natta Catalyst.

Generally, the catalyst system comprises at least one external electron donor. In an embodiment or in combination with any embodiment mentioned herein, the external electron donor comprises at least one alkoxy silane, such as a “D” donor (e.g., dicyclopentyldimethoxysilane), a “C” donor (e.g., cyclohexylmethyldimethoxysilane), or a combination thereof. Moreover, in some embodiments, the alkoxy silane can comprise, consist essentially of, or consist entirely of a “D” donor or a “C” donor.

In one embodiment of the invention, an electron donor is not utilized in the process.

It has been observed that the addition of the above external donors to the catalyst system can increase the hardness (i.e., decrease the needle penetration) and viscosities of the copolymers. However, contrary to what has been previously observed in the art, the electron donors described above can lower the softening points of the produced copolymers instead of increasing them. Furthermore, it has been observed that substantially all (i.e., greater than 95 percent) of the ethylene added to the reactor during the polymerization process can react when the above electron donors are used. Thus, this can result in copolymers having higher ethylene contents and lower propylene contents. Consequently, when using the above electron donors, propylene-ethylene copolymers can be produced that have higher ethylene contents, but still exhibit desired balances between softening point and hardness.

In addition, according to various embodiments, the catalyst system can have a molar ratio of external electron donor to titanium of at least 0.1:1, 0.5:1, 1:1, 1.5:1, 2:1, 2.5:1, 3:1, 3.5:1, or 4:1 and/or less than 10:1, 9:1, or 8:1. Additionally, or alternatively, the catalyst system can have a molar ratio of external electron donor to titanium in the range of 0.1:1 to 10:1, 0.5:1 to 10:1, 1:1 to 10:1, 1.5:1 to 10:1, 2:1 to 10:1, 2.5:1 to 10:1, 3:1 to 10:1, 3.5:1 to 10:1, 4:1 to 10:1, 0.5:1 to 9:1, 1:1 to 9:1, 1.5:1 to 9:1, 2:1 to 9:1, 2.5:1 to 9:1, 3:1 to 9:1, 3.5:1 to 9:1, 4:1 to 9:1, 0.5:1 to 8:1, 1:1 to 8:1, 1.5:1 to 8:1, 2:1 to 8:1, 2.5:1 to 8:1, 3:1 to 8:1, 3.5:1 to 8:1, or 4:1 to 8:1.

Additionally or alternatively, in various embodiments, the catalyst system can comprise a molar ratio of TEAL co-catalyst to the electron donor of at least 0.5:1, 1:1, 2:1, 3:1, 4:1, 5:1, or 6:1 and/or not more than 100:1, 50:1, 35:1, 20:1, 15:1, 10:1, or 8:1. Moreover, the catalyst system can comprise a molar ratio of TEAL co-catalyst to the electron donor in the range of 0.5:1 to 100:1, 1:1 to 50:1, 2:1 to 35:1, 2:1 to 20:1, 2:1 to 15:1, 2:1 to 10:1, or 2:1 to 8:1.

In certain embodiments, the type of electron donor can influence the necessary TEAL/electron donor ratio. For instance, in embodiments where the electron donor is a “D” donor or a “C” donor, the TEAL/electron donor ratio can be less than 20:1.

The catalyst system can exhibit a catalyst activity in the range of 200 to 2,000, 400 to 1,200, 500 to 1,000, 1,000 to 6,000, or 6,000 to 18,000 g/g. Catalyst activity is calculated by measuring the ratio of the weight the polymer made in the reactor to the weight of the catalyst charged into the reactor. These measurements are based on a reaction time of one hour.

Since the addition of external donors can increase viscosity and molecular weight, the addition of hydrogen can be required to act as a chain terminator during polymerization. For example, the process can be carried out at a hydrogen pressure in the range of 5 to 100, 10 to 80, or 15 to 50 psig.

In an embodiment or in combination with any embodiment mentioned herein, the polymerization reaction can occur at a temperature equal to or less than 160° C., equal to or less than 155° C., equal to or less than 150° C., or equal to or less than 145° C., equal to or less than 140° C., in the range of 100 to 200, 110 to 180, 110 to 155, 120 to 160, 140 to 155, or 120 to 150° C. Furthermore, the polymerization reaction can be carried out at a pressure in the range of 500 to 2,000, 600 to 1,500, 700 to 1,250 or 800 to 1,100 psig.

In embodiments of this invention, the ratio of ethylene flow to propylene flow into the polymerization reaction can be in the range of 0.1:100 to 18:100, 0.1:100 to 10:100, 0.1:100 to 5:100, 0.1:100 to 4:100, 0.5:100 to 3:100, 0.5:100 to 2:100, 0.5:100 to 1.5:100, 0.5:100 to 1:100, 1:100 to 4:100, 1:100 to 3:100, 1:100 to 2:100, 1.5:100 to 4:100, 1.5:100 to 3:100, 1.5:100 to 2:100, 2:100 to 4:100, 2:100 to 3:100, 3:100 to 18:100, 3:100 to 14:100, 3:100 to 12:100, 3:100 to 10:100, 4:100 to 18:100, 4:100 to 14:100, 4:100 to 12:100, 4:100 to 10:100, 7:100 to 18:100, 7:100 to 14:100, 7:100 to 12:100, 7:100 to 10:100, 8:100 to 18:100, 8:100 to 14:100, 8:100 to 12:100, or 8:100 to 10:100.

In embodiments of this invention, the ratio of hydrogen flow to propylene flow into the polymerization reaction may be in the range of 0.03:100 to 0.5:100, 0.04:100 to 0.4:100, 0.15:100 to 0.4:100, 0:100 to 0.3:100, 0:100 to 0.2:100, 0.100:100 to 0.02:100, 0:100 to 0.01:100, 0.01:100 to 0.02:100, 0.04:100 to 0.2:100, 0.05:100 to 0.1:100, 0.07:100 to 0.3:100, or 0.08:100 to 0.4:100.

In certain embodiments, the reactor can comprise a stirred reactor and the polymerization reaction can have a residence time in the reactor in the range of 0.1 to 6, 0.5 to 4, or 1 to 2 hours. In some embodiments the polymerization reaction can have a residence time in the reactor in the range of 6 to 72, 16 to 36, 16 to 24, 12 to 48, or 12 to 24 hours. In other embodiments, the reactor can comprise a loop reactor and the polymerization reaction can have a residence time in the reactor in the range of 8 to 72, 12 to 48, 12 to 24, or 16 to 36 hours. In an embodiment or in combination with any embodiment mentioned herein, the ethylene can be added to the reactor as a gas and the propylene can be added as a liquid.

### End Uses Comprising the Heat Resistant Propylene-Ethylene Copolymer

The inventive propylene-ethylene copolymers described herein and compositions comprising these copolymers can be utilized in a wide array of applications including, for example, adhesives (e.g. automotive adhesives, woodworking adhesives, packaging adhesives), sealants, caulks, roofing membranes, waterproof membranes, compounds, and underlayments, carpet, laminates, laminated articles, tapes (e.g., tamper evident tapes, water activated tapes, gummed tape, sealing tape, scrim reinforced tape, veneer tape, reinforced and non-reinforced gummed paper tape, box makers tape, paper tape, packaging tape,), labels, mastics, polymer blends, wire coatings, molded articles, heat seal coatings, disposable hygiene articles, insulating glass (IG) units, bridge decking, bitumen modification, asphalt modification, cable flooding/filling compounds, sheet molded compounds, dough molded compounds, overmolded compounds, rubber compounds, polyester composites, glass composites, fiberglass reinforced plastics, plastic fiber reinforced compounds, wood-plastic composites, lost-wax precision castings, investment casting wax compositions, candles, windows, films, gaskets, seals, o-rings, motor vehicle molded parts, motor vehicle extruded parts, clothing articles, rubber additive/processing aids, and fibers.

Films comprising the inventive propylene-ethylene copolymer described herein and compositions comprising these copolymers include, but are not limited to, multilayer films, coextruded films, calendared films, and cast films. Laminates comprising the inventive propylene-ethylene polymer or compositions comprising the inventive propylene-ethylene polymer include, but are not limited to, paper-foil laminates, paper-film laminates, and nonwoven-film laminates.

Adhesive compositions comprising the inventive propylene-ethylene copolymer described herein and compositions comprising these copolymers include packaging adhesives, food contact grade adhesives, indirect food contact packaging adhesives, product assembly adhesives, woodworking adhesives, edgebanding adhesives, profile wrapping adhesives, flooring adhesives, automotive assembly adhesives, structural adhesives, mattress adhesives, pressure sensitive adhesives (PSA), PSA tapes, PSA labels, PSA protective films, self-adhesive films, laminating adhesives, flexible packaging adhesives, heat seal adhesives, industrial adhesives, hygiene nonwoven construction adhesives, hygiene core integrity adhesives, and hygiene elastic attachment adhesives.

In certain embodiments, the copolymers described herein can be utilized in adhesives, such as, for example, hot melt adhesives, water-based adhesives, solvent-based adhesives, hot melt pressure-sensitive adhesives, solvent-based pressure-sensitive adhesives, hot melt nonwoven/hygiene adhesives, hot melt product assembly adhesives, hot melt wood working adhesives, hot melt automotive component assembly adhesives, hot melt lamination adhesives, and hot melt packaging adhesives. In particular, due to their unique combination of softening point, heat resistance, and needle penetration as previously described, adhesives produced from the inventive copolymers can be utilized in a vast array of end products, including hygienic packaging, household appliances, automotive components, woodworking and packaging applications that require heat resistance. In many embodiments, the various properties of the inventive copolymers, such as softening point and needle penetration, can be selected to suit the intended end use of the composition incorporating the inventive heat resistant copolymers.

In certain embodiments, the inventive copolymers can be used to produce adhesive compositions useful for automotive interior assemblies, packaging, product assembly, heat sealing, laminating, gap sealing, e.g., cable filling, caulks, and window sealants, wood working, edge banding, and/or profile wrapping. The terms “adhesive,” ‘adhesive compositions” and “compositions” are used interchangeably.

In an embodiment or in combination with any embodiment mentioned herein, the adhesive compositions of the present invention comprise hot melt adhesives. Hot melt adhesives can be applied to a substrate while in its molten state and cooled to harden the adhesive layer. Such adhesives are widely used for various commercial and industrial applications such as product assembly, lamination, and packaging. In these applications, adhesive is applied to at least one substrate for binding the substrate to a second similar or different substrate.

Adhesive, sealant and other formulators and users generally want thermally stable, low color hot melt adhesives with favorable balance of physical properties, including temperature resistance, chemical resistance, cohesive strength, viscosity, adhesion to a variety of substrates, and open and set times that can be tailored to the particular use and application conditions. The balance of desired properties varies with the application, and the inventive hot melt compositions described herein provide an improved balance of properties for multiple end uses.

The hot melt adhesive compositions can have melt rheology and thermal stability suitable for use with conventional hot melt adhesive application equipment. In an embodiment or in combination with any embodiment mentioned herein, the blended components of the hot melt adhesive compositions have low melt viscosity at the application temperature, thereby facilitating flow of the compositions through a coating apparatus, e.g., coating die or nozzle.

The hot melt adhesive composition is useful for bonding a variety of substrates including, e.g., cardboard, coated cardboard, paperboard, fiber board, virgin and recycled kraft, high and low density kraft, chipboard, treated and coated kraft and chipboard, and corrugated versions of the same, clay coated chipboard carton stock, composites, leather, polymer film (e.g., polyolefin films (e.g., polyethylene and polypropylene), polyvinylidene chloride films, ethylene vinyl acetate films, polyester films, metalized polymer film, multi-layer film, and combinations thereof), fibers and substrates made from fibers (e.g., virgin fibers, recycled fibers, synthetic polymer fibers, cellulose fibers, and combinations thereof), release liners, porous substrates (e.g., woven webs, nonwoven webs, nonwoven scrims, and perforated films), cellulose substrates, sheets (e.g., paper, and fiber sheets), paper products, tape backings, and combinations thereof. Useful composites include, e.g., chipboard laminated to metal foil (e.g., aluminum foil), which optionally can be laminated to at least one layer of polymer film, chipboard bonded to film, Kraft bonded to film (e.g., polyethylene film), and combinations thereof.

The hot melt adhesive composition is useful in bonding a first substrate to a second substrate in a variety of applications and constructions including, e.g., packaging, bags, boxes, cartons, cases, trays, multi-wall bags, articles that include attachments (e.g., straws attached to drink boxes), ream wrap, cigarettes (e.g., plug wrap), filters (e.g., pleated filters and filter frames), bookbinding, footwear, disposable absorbent articles (e.g., disposable diapers, sanitary napkins, medical dressings (e.g., wound care products), bandages, surgical pads, drapes, gowns, and meat-packing products), paper products including, e.g., paper towels (e.g., multiple use towels), toilet paper, facial tissue, wipes, tissues, towels (e.g., paper towels), sheets, veneers, mattress covers, automotive foils, TPO compounds, and components of absorbent articles including, e.g., an absorbent element, absorbent cores, impermeable layers (e.g., backsheets), tissue (e.g., wrapping tissue), acquisition layers and woven and nonwoven web layers (e.g., top sheets, absorbent tissue), and combinations thereof.

The hot melt adhesive composition is also useful in forming laminates of porous substrates and polymer films such as those used in the manufacture of disposable articles including, e.g., medical drapes, medical gowns, sheets, feminine hygiene articles, diapers, adult incontinence articles, absorbent pads for animals (e.g., pet pads) and humans (e.g., bodies and corpses), and combinations thereof.

The hot melt adhesive composition can be applied to a substrate in any useful form including, e.g., as fibers, as a coating (e.g., a continuous coatings and discontinuous coatings (e.g., random, pattern, and array)), as a bead, as a film (e.g., a continuous films and discontinuous films), and combinations thereof, using any suitable application method including, e.g., slot coating, curtain coating, spray coating (e.g., spiral spray, random spraying, and random fiberization (e.g., melt blowing)), foaming, extrusion (e.g., applying a bead, fine line extrusion, single screw extrusion, and twin screw extrusion), wheel application, noncontact coating, contacting coating, gravure, engraved roller, roll coating, transfer coating, screen printing, flexographic, and combinations thereof.

One embodiment of the present invention relates to a vehicle having a vehicle interior material (preferably an automobile interior material) comprising a skin material (preferably a polyolefin-based substrate) to which the hot melt composition is applied. Examples of the vehicle according to the present invention include, but not particularly limited to, vehicles such as motor vehicles (automobiles), motor bicycles (motorcycles), buses, trucks, and streetcars. In the present specification, although a term “automobile interior material” is used in some sentences, the term may be construed to mean an interior material for vehicles other than automobiles as long as the hot melt composition of the present invention can be applied.

The inventive compositions can be used to form bonds to produce a laminate and multilayer laminates. The term “laminate” and “multilayer laminate” may be used interchangeably.

The inventive compositions according to one or more embodiments of the present invention can be bonded to various adherends including but not limited to: cellulosic polymer materials such as paper, cotton, linen, cloth, and wooden boards; synthetic polymer materials, including polyolefin resins such as polypropylene (PP) and polyethylene (PE), styrene resins such as polystyrene, styrene-butadiene block copolymers (SBS resins), styrene-acrylonitrile copolymers (AS resins), acrylonitrile-ethylene/propylene styrene copolymers (AES resins), and acrylonitrile-butadiene-styrene copolymers (ABS resins), polycarbonate resins (PC resins), PC-ABS resins. (meth)acrylic resins, polyester resins, polyamide resins such as nylon and polyurethane, phenol resins, and epoxy resins, a wood material, a metallic material, a plastic material, an elastomeric material, a composite material, a paper material, a fabric material, a glass material, a foamed material, a metal, a mesh material, a leather material, a synthetic leather material, a vinyl material, poly(acrylonitrile butadiene styrene) (ABS), polypropylene (PP), glass filled PP, talc filled PP, impact-modified PP, urethane elastomers, thermoplastic polyolefin (TPO) compounds, pigmented TPO compounds, filled TPO compounds, rubber-modified TPO compounds, a primed (painted) material. The material for the adherend may be a mixture or combination of two or more different materials. In the case that the laminate is formed by bonding two different adherends via an adhesive layer comprising the inventive propylene-ethylene polymers or hot melt adhesives of the present invention, the materials of the two adherends may be the same as or different from each other.

The laminate comprising the inventive polymer or compositions can be suitably used in applications where a covering material and a formed article are used as adherends, such as interior materials for automobiles and the like (e.g., ceiling materials for automobile interiors, door components for automobile interiors, dashboard components for automobile interiors, instrument panels), components for household electrical appliances (e.g., housings for personal computers, frames of flat-screen televisions), and housing materials (e.g., interior wall boards, decorating films, etc.).

The covering material refers to one that has been formed into a film, a sheet, a foam, or a non-woven or woven material of any type. Examples include decorating polymer sheets made of polyvinyl chloride, various polyolefins, ABS, thermoplastic polyolefin compounds (TPO) such as polypropylene blended with uncrosslinked EPDM rubber and/or polyethylene, polyester non-woven fabrics, raised knits, fabrics, polyurethane artificial leathers, and polyolefin foams formed mainly from polypropylene, polyethylene, polybutylene, or copolymers of these olefins. Examples of the formed article include injection-molded articles of various polymer materials such as ABS, PC/ABS, polyolefins, glass fiber-reinforced polyolefins, and glass fiber-reinforced nylons; and ligneous formed articles and ligneous boards prepared by encasing a material such as wood chips or ligneous powder in a thermosetting resin or a polyolefin resin by hot press molding.

In the preparation of a multi-layer laminate by bonding the covering material such as a decorating sheet and a formed article used as a base material via an adhesive layer comprising the inventive propylene-ethylene polymers or hot melt adhesive compositions various forming methods such as heat lamination, vacuum forming, vacuum pressure forming, hot pressing, heat rolling, and hot stamping can be used. The curved formed article denotes, among formed articles as made of the above-mentioned materials, one which has a planar arcshaped surface as the surface to be bonded to the covering material. Such formed articles are used to form shape skeletons in automobile interiors or housings of household electrical appliances.

In an embodiment or in combination with any embodiment mentioned herein, there is provided a process wherein at least one composition useful in the invention can be applied to a first substrate or, optionally, can be applied to two or more substrates, wherein each substrate can be selected independently, wherein the first substrate and the second substrate can be each independently selected from the group consisting of poly(acrylonitrile butadiene styrene) (ABS); polycarbonate (PC); PC-ABS blends; thermoplastic polyolefins such as polypropylene (PP); TPO compounds; textiles, e.g., fabric materials, mesh, plywood, birch wood, veneer, MDF board, wovens, and/or nonwovens; foam materials; leather materials; vinyl materials; and/or others that would be apparent to one of ordinary skill in the art. These materials can be used with or without fillers.

Typical, but non-limiting, industrial applications of the hot melt adhesive compositions include packaging, particularly for high temperature uses such as case and cartons in warehouses, wood working, and vehicle (e.g., automotive) interior component assembly. Traditional end use applications such as bookbinding, sanitary disposable consumer articles, and labeling will also benefit from the heat resistance and the efficiency of end use in automated means of applying the hot melt adhesive compositions to various substrates.

Furthermore, in various embodiments, the inventive copolymers described herein can also be used to modify existing polymer blends that are typically utilized in plastics, elastomeric applications, roofing applications, asphalt modification, cable filling, and tire modifications. The inventive copolymers can improve the adhesion, processability, stability, viscoelasticity, thermal properties, and mechanical properties of these polymer blends.

In an embodiment or in combination with any embodiment mentioned herein, the inventive propylene-ethylene copolymers can be modified to produce graft copolymers. In such embodiments, the inventive copolymers can be grafted with maleic anhydride, fumarate and maleate esters, methacrylate esters (e.g., glycidyl methacrylate and hydroxethyl methacrylate), methacrylic acid, vinyl derivatives, silane derivatives, or combinations thereof. These graft copolymers can be produced using any conventional process known in the art including, for example, transesterification and free radical induced coupling.

The various end uses and end products noted above can utilize the inventive copolymer by itself or can combine it with other additives and polymers. Suitable polymers that can be combined with the inventive copolymers to form a polymer blend may include, for example, isoprene-based block copolymers; butadiene-based block copolymers; hydrogenated block copolymers; styrene-ethylene/butylene-styrene block copolymers (SEBS); styrene-isoprene-styrene block copolymers (SIS); styrene-ethylene/propylene-styrene (SEPS); ethylene vinyl acetate copolymers; polyesters; polyester-based copolymers; neoprenes; urethanes; acrylics; polyacrylates; acrylate copolymers, such as, but not limited to, ethylene acrylic acid copolymer, ethylene n-butyl acrylate copolymers, and ethylene methyl acrylate copolymers; polyether ether ketones; polyamides; styrenic block copolymers; hydrogenated styrenic block copolymers; random styrenic copolymers; ethylene-propylene rubbers; ethylene vinyl acetate copolymers; butyl rubbers; styrene butadiene rubbers; butadiene acrylonitrile rubbers; natural rubbers; polyisoprenes; polyisobutylenes; polyvinyl acetates; and polyolefins.

Polyolefins used with the inventive propylene-ethylene copolymers in this invention can be any that is known in the art. In an embodiment or in combination with any embodiment mentioned herein, the polyolefins can be at least one selected from the group consisting of amorphous polyolefins, semi-crystalline polyolefins, alpha-polyolefins, reactor-ready polyolefins, metallocene-catalyzed polyolefin polymers and elastomers, reactor-made thermoplastic polyolefin elastomers, olefin block copolymers, thermoplastic polyolefins, atactic polypropylene, polyethylenes, ethylene-propylene polymers, propylene-hexene polymers, ethylene-butene polymers, ethylene-octene polymers, propylene-butene polymers, propylene-octene polymers, metallocene-catalyzed polypropylene polymers, metallocene-catalyzed polyethylene polymers, propylene-based terpolymers including ethylene-propylene-butylene terpolymers, copolymers produced from propylene and linear or branched C₄-C₁₀ alpha-olefin monomers, copolymers produced from ethylene and linear or branched C₄-C₁₀ alpha-olefin monomers, and functionalized polyolefins.

Multiple methods exist in the art for functionalizing polymers that may be used with the polymers described here. These include selective oxidation, free radical grafting, ozonolysis, epoxidation, and the like. Functionalized components include, but are not limited to, functionalized olefin polymers, (such as functionalized C₂ to C₄₀ homopolymers, functionalized C₂ to C₄₀ copolymers, functionalized higher Mw waxes), functionalized oligomers (such as functionalized low Mw waxes, functionalized tackifiers), beta nucleating agents, and combinations thereof. Functionalized olefin polymers and copolymers useful in this invention include maleated polyethylene, maleated metallocene polyethylene, maleated metallocene polypropylene, maleated ethylene propylene rubber, maleated polypropylene, maleated ethylene copolymers, functionalized polyisobutylene (typically functionalized with maleic anhydride typically to form a succinic anhydride), and the like.

In an embodiment or in combination with any embodiment mentioned herein, the inventive propylene-ethylene copolymers described herein can be used to produce a hot melt adhesive. According to one or more embodiments, the adhesive compositions can comprise at least 1, 5, 6, 7, 8, 9, 10, 15, 20, 23, 25, 30, 35, 37, 40, 45, 47, or 50 and/or not more than 95, 90, 85, 80, 76, 75, 70, 66, 63, 60, 59, 56, 55, 52, 50, 45, 40, 35, 30, 25, 20, 15, or 10 weight percent of the inventive copolymer. Moreover, the adhesive compositions can comprise in the range of 1 to 95, 5 to 90, 10 to 80, 20 to 70, 30 to 60, 40 to 55, 50 to 80, 50 to 70, 30 to 90, 30 to 80, 30 to 70, 30 to 60, 30 to 50, or 30 to 40 weight percent of the inventive copolymers. In certain embodiments, the adhesive composition can be entirely comprised of the inventive copolymer.

Furthermore, depending on the intended end use, these hot melt adhesive compositions can also comprise various additives including, for example, polymers, tackifiers, processing oils, waxes, antioxidants, plasticizers, pigments, and fillers.

In an embodiment or in combination with any embodiment mentioned herein, the adhesive compositions can comprise at least 1, 5, 6, 7, 10, 12, 20, 23, 30, 35, 40 or 47 and/or not more than 90, 80, 70, 56, or 55 weight percent of at least one polymer that is different from the inventive copolymers. Moreover, the adhesives can comprise in the range of 10 to 90, 20 to 80, 30 to 70, or 40 to 55 weight percent of at least one polymer that is different from the inventive copolymers. In other embodiments, the adhesives can comprise at least 1, 5, 6, 7, 8, 9, 10, 15, 20, 23, 25, 30, 35, 40, 45, 47 or 50 weight percent of at least one polymer that is different from the inventive copolymers. These polymers can include but are not limited to any of the polymers listed above.

Furthermore, it has been discovered that blends of the inventive copolymers with various types of polyolefins may provide adhesives with improved adhesion, cohesive strength, temperature resistance, viscosity, and open and set times. Thus, in various embodiments, the above-described polymers that may be combined with the inventive propylene-ethylene copolymers can comprise at least one polyolefin. In certain embodiments, the adhesives can comprise at least 1, 5, 6, 7, 10, 12, 15, 20, 23, 25, 30, 35, 40, 45, 47, or 50 weight percent of at least one polyolefin in addition to the inventive propylene-ethylene copolymer. Additionally or in the alternative, the adhesive compositions can comprise not more than 99, 95, 90, 85, 80, 75, 70, 65, 60, 55, 50, 45, 40, 35, 30, 25, 20, 15, 10, 7, or 5 weight percent of at least one polyolefin in addition to the inventive propylene-ethylene copolymer. For example, the adhesive compositions can comprise in the range of 1 to 90, 1 to 60, 1 to 40, 1 to 20, 10 to 90, 20 to 80, 20 to 40, 30 to 70, 30 to 40, or 40 to 55 weight percent of at least one polyolefin based on the total weight. In one or more embodiments, these polyolefins can be amorphous polyolefins having a heat of fusion less than 25 J/g or less than 15 J/g. In one or more embodiments, these polyolefins can be metallocene-catalyzed polyolefin polymers.

Commercial examples of acceptable polyolefins include Aerafin™ 17 by Eastman; Aerafin™ 180 by Eastman; Rextac™ polymers made by REXtac LLC including Rextac™ E-63, E-65, 2760, 2815, 2730, and 2830; Vestoplast®, polymers made by Evonik Industries, including Vestoplast® 408 and 708; and Eastoflex® by Eastman, including Eastoflex® E1060 and P1010.

Some examples of metallocene-catalyzed polymers include polyolefins, such as polyethylene, polypropylene, and copolymers thereof. Exemplary polypropylene-based elastomers include those sold by ExxonMobil Chemical under the trade name VISTAMAXX™ and those sold by Idemitsu Kosan (Japan) under the trade name L-MODU™; Exemplary polyethylene-based elastomers and plastomers include those sold by Dow Chemical Company under the trade names AFFINITY™, AFFINITY™ GA, INFUSE™, and ENGAGE™; those sold by ExxonMobil Chemical Company (Houston, Texas) under the trade name VISTAMAXX™, and those sold by Clariant under the trade name LICOCENE™.

In an embodiment or in combination with any embodiment mentioned herein, olefin polymers include a mixture of at least two different olefin polymers, e.g., a blend that includes an olefin homopolymer and an olefin copolymer, a blend that includes different olefin homopolymers of the same or different monomer, a blend that includes different olefin copolymers, and various combinations thereof. Useful olefin polymers also include, e.g., modified, unmodified, grafted, and ungrafted olefin polymers, uni-modal olefin polymers, multi-modal olefin polymers, and combinations thereof.

In an embodiment or in combination with any embodiment mentioned herein, these added polyolefins can increase the cohesive strength, adhesion properties, tackiness, low temperature flexibility, total crystallinity, and/or temperature resistance of the inventive adhesive compositions. Furthermore, the addition of the aforementioned polyolefins may decrease the production costs of the compositions due to their widespread availability.

In certain embodiments, the adhesive compositions can comprise the inventive propylene-ethylene copolymer and a metallocene-catalyzed polyethylene copolymer, e.g., an ethylene-octene copolymer. In such embodiments, the inventive propylene-ethylene copolymer can be used to replace the polyethylene in various types of adhesives, such as those used for packaging applications.

In certain embodiments, the added polymer and/or polyolefin can be functionalized with groups including, but not limited to, silanes, acid anhydride such as maleic anhydride, hydroxyl, ethoxy, epoxy, siloxane, amine, aminesiloxane, carboxy, and acrylates, at the polymer chain ends and/or pendant positions within the polymer.

The additional polymers and polyolefins that can be added to the inventive adhesive compositions may be prepared by a Ziegler-Natta catalyst, a single site catalyst (metallocene), multiple single site catalysts, non-metallocene heteroaryl catalysts, combinations thereof, or another polymerization means. The additional polymers may comprise a combination of amorphous, semi-crystalline, random, branched, linear, or blocky structures.

Any conventional polymerization synthesis processes may prepare the additional polyolefin components. In one or more embodiments, one or more catalysts, which are typically metallocene catalysts or Zeigler-Natta, catalysts, are used for polymerization of an olefin monomer or monomer mixture. Polymerization methods include high pressure, slurry, gas, bulk, suspension, supercritical, or solution phase, or a combination thereof. The catalysts can be in the form of a homogeneous solution, supported, or a combination thereof. Polymerization may be carried out by a continuous, a semi-continuous or batch process and may include use of chain transfer agents, scavengers, or other such additives as deemed applicable. In one or more embodiments, the additional polymer is produced in a single or multiple polymerization zones using a single polymerization catalyst. Metallocene (or heterophase) polymers are typically made using multiple metallocene catalyst blends that obtain the desired heterophase structure.

In an embodiment or in combination with any embodiment mentioned herein, the crystalline content of the added polymers or polyolefins can increase the cohesive strength of the adhesive compositions. Generally, formulations based on metallocene polymerized semicrystalline copolymers can eventually build sufficient crystalline content over time to achieve good cohesive strength in the formulation.

In an embodiment or in combination with any embodiment mentioned herein, the adhesive compositions can comprise at least 5, 10, 15, 20, 25, 30, 35, 40, or 45 and/or not more than 90, 80, 70, 55, 50, 45, or 40 weight percent of at least one tackifier. Moreover, the adhesives can comprise in the range of 5 to 90, 20 to 80, 20 to 40, 20 to 30, 30 to 70, or 40 to 55 weight percent of at least one tackifier. The tackifier gives tack to the adhesive and may also lower the viscosity of the adhesive. Lower viscosity can improve application flow characteristics, allowing for easier processing, lower energy requirements, and lower processing temperatures. Lower viscosity also helps the adhesive to “wet out,” or to substantially uniformly coat the surface and penetrate the substrate. Tack is required in most adhesive formulations to allow for proper joining of articles prior to solidification of the hot melt adhesive. The desirability and selection of the particular tackifying agent can depend upon the specific types of olefin copolymer and additional polymers employed.

Suitable tackifiers can include, for example, cycloaliphatic hydrocarbon resins, C₅ hydrocarbon resins; C₅/C₉ hydrocarbon resins; aromatically-modified C₅ resins; C₉ hydrocarbon resins; pure monomer resins such as copolymers or styrene with alpha-methyl styrene, vinyl toluene, para-methyl styrene, indene, methyl indene, C₅ resins, and C₉ resins; terpene resins; terpene phenolic resins; terpene styrene resins; rosin esters; modified rosin esters; liquid resins of fully or partially hydrogenated rosins; fully or partially hydrogenated rosin esters; fully or partially hydrogenated modified rosin resins; fully or partially hydrogenated rosin alcohols; fully or partially hydrogenated C₅ resins; fully or partially hydrogenated C₅/C₉ resins; fully or partially hydrogenated aromatically-modified C₅ resins; fully or partially hydrogenated C₉ resins; fully or partially hydrogenated pure monomer resins; fully or partially hydrogenated C₅/cycloaliphatic resins; fully or partially hydrogenated C₅/cycloaliphatic/styrene/C₉ resins; fully or partially hydrogenated cycloaliphatic resins; and combinations thereof. Exemplary commercial hydrocarbon resins include Regalite™ hydrocarbon resins (Eastman Chemical). In certain embodiments, the tackifiers can comprise functionalized tackifiers.

In an embodiment or in combination with any embodiment mentioned herein, the adhesive compositions can comprise at least 1, 2, 5, 8, or 10 and/or not more than 40, 30, 25, 20, or 15 weight percent of at least one processing oil. Moreover, the adhesives can comprise in the range of 2 to 40, 5 to 30, 8 to 25, or 10 to 20 weight percent of at least one processing oil. Processing oils can include, for example, mineral oils, naphthenic oils, paraffinic oils, aromatic oils, castor oils, rape seed oil, triglyceride oils, or combinations thereof. As one skilled in the art would appreciate, processing oils may also include extender oils, which are commonly used in adhesives. The use of oils in the adhesives may be desirable if the adhesive is to be used as a pressure-sensitive adhesive to produce tapes or labels or as an adhesive to adhere nonwoven articles. In certain embodiments, the adhesive may not comprise any processing oils.

In an embodiment or in combination with any embodiment mentioned herein, the adhesive compositions can comprise at least 1, 2, 3, 4, 5, 6, 7, 8, 9, 10, 11, 12, 15, 16, 17, 18, 19, 20, 21, 22, 23, 24, 25, and/or not more than 40, 35, 34, 33, 32, 31, 30, 29, 28, 27, 26, 25, 24, 23, 22, 21, 20, 19, 18, 17, 16, or 15 weight percent of at least one wax. Moreover, the adhesives can comprise in the range of 0 to 15, 1 to 40, 5 to 30, 8 to 25, 10 to 20, 1 to 25, 1 to 20, 1 to 15, 1 to 10 or 1 to 5 weight percent of at least one wax. Waxes serve to reduce the overall viscosity of the adhesive, thereby allowing it to liquefy and allowing for the proper application or coating of the hot melt adhesive onto an intended substrate. The type and melting point of a wax, and its compatibility with other components of the adhesive composition, control the open time and setting speed of the adhesive. Open time is known in the art as being the amount of time for an adhesive to wet out and bond to a substrate after application. Any conventionally known wax, which is suitable for use in formulating hot melt adhesives, may be used in the practice of the invention.

In an embodiment or in combination with any embodiment mentioned herein, the adhesive compositions can comprise at least 1, 2, 3, 4, or 5 weight percent of a polyethylene wax, a polypropylene wax, a maleated polyolefin wax, or a combination of two or more thereof. Additionally, or in the alternative, the adhesive compositions can comprise not more than 40, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 weight percent of a polyethylene wax, a polypropylene wax, a maleated polyolefin wax, or a combination of two or more thereof.

Suitable waxes can include, for example, microcrystalline wax, paraffin wax, waxes produced by Fischer-Tropsch processes, functionalized waxes (maleated, fumerated, or wax with functional groups etc.), polyolefin waxes, petroleum waxes, polypropylene waxes, polyethylene waxes, ethylene vinyl acetate waxes, and vegetable waxes. The use of waxes in the adhesives may be desirable if the adhesive is to be used as a hot melt packaging adhesive.

Non-limiting examples of commercially available waxes that are suitable for this invention include SasolWax® H-1, available from Sasol Wax Americas, Inc.; A-C™-9, AC-596, and A-C 810, available from Honeywell International Inc.; EPOLENE™ N-15 and E-43 available from Westlake Chemical; and POLYWAX™ 400, 850, 1000, and 3000 from Baker Hughes Inc. Other exemplary waxes include, but are not limited to, Clariant Licocene™ PE4201; Westlake EPOLENE™ C-10, EPOLENE™ C-17 and EPOLENE™ C-18; and microcrystalline wax Be Square™ 195.

As used herein, “functionalized” is meant that the component is either prepared in the presence of a functional group that is incorporated into the component or is contacted with a functional group, and, optionally, a catalyst, heat, initiator, or free radical source to cause all or part of the functional group (such as maleic acid or maleic anhydride) to incorporate, graft, bond to, physically attach to, and/or chemically attach to the polymer.

Exemplary functionalized polymers useful as functionalized components include those modified with an alcohol, an acid, a ketone, an anhydride, and the like. Commercial functionalized waxes include maleated polypropylene was available from Chusei under the tradename MAPP 40; maleated metallocene waxes (such as TP LICOCENE pp 1602 available from Clariant); maleated polyethylene waxes and maleated polypropylene waxes available from Westlake under the tradenames EPOLENE C-16, EPOLENE C-18, EPOLENE E43; EASTMAN G-3003 from Eastman Chemical; maleated polypropylene wax LICOMONT AR 504 available from Clariant; grafted functional polymers available from Dow Chemical Co. under the tradenames AMPLIFY EA 100 and AMPLIFY VA 200; and CERAMER™ maleated ethylene polymers available from Baker Hughes under the tradenames CERAMER 1608, CERAMER 1251, CERAMER 67, and CERAMER 24. Useful waxes also include polyethylene and polypropylene waxes having an Mw of 15,000 of less, preferably from 3,000 to 10,000, and a crystallinity of 5 wt % or more, preferably 10 weight percent or more, having a functional group content of up to 10 weight percent. Additional functionalized polymers that may be used as functional components include A-C 575P, A-C 573P, A-C X596A, A-C X596P, A-C X597A, A-C X597P, A-C X950P, A-C X1221, A-C 395A, A-C 395A, A-C 1302P, A-C 540, A-C 54A, A-C 629, A-C 629A, A-C 307, and A-C 307A available from Honeywell International Inc.

In certain embodiments, the adhesive composition may not comprise a wax. For instance, the adhesive composition may comprise less than 10, 5, 4, 3, 2, or 1 weight percent of a wax such as, but not limited to, a polyethylene wax, and/or a Fischer Tropsch wax.

In an embodiment or in combination with any embodiment mentioned herein, the adhesive compositions can comprise at least 0.1, 0.2, 0.5, 1, 2, or 3 and/or not more than 20, 10, 8, 5, 1, or 0.5 weight percent of at least one antioxidant. Moreover, the adhesive compositions can comprise in the range of 0.1 to 20, 1 to 10, 2 to 8, or 3 to 5 weight percent of at least one antioxidant.

In an embodiment or in combination with any embodiment mentioned herein, the adhesive compositions can comprise at least 0.5, 1, 2, or 3 and/or not more than 20, 10, 8, or 5 weight percent of at least one plasticizer. Moreover, the adhesives can comprise in the range of 0.5 to 20, 1 to 10, 2 to 8, or 3 to 5 weight percent of at least one plasticizer. Suitable plasticizers can include, for example, olefin oligomers, low molecular weight polyolefins such as liquid polybutylene, polyisobutylene, mineral oils, dibutyl phthalate, dioctyl phthalate, chlorinated paraffins, and phthalate-free plasticizers. Commercial plasticizers can include, for example, Benzoflex™ plasticizers (Eastman Chemical); Eastman 168™ (Eastman Chemical); Oppanol® B10 (BASF); REGALREZ 1018 (Eastman Chemical); Calsol 5550 (Calumet Lubricants); Kaydol oil (Chevron); or ParaLux oil (Chevron).

In an embodiment or in combination with any embodiment mentioned herein, the adhesive compositions can comprise at least 10, 20, 30, or 40 and/or not more than 90, 80, 70, or 55 weight percent of at least one filler. Moreover, the adhesives can comprise in the range of 1 to 90, 20 to 80, 30 to 70, or 40 to 55 weight percent of at least one filler. Suitable fillers can include, for example, carbon black, calcium carbonate, clay, titanium oxide, zinc oxide, or combinations thereof.

The adhesive compositions can be produced using conventional techniques and equipment. For example, the components of the adhesive composition may be blended in a mixer such as a sigma blade mixer, a plasticorder, a brabender mixer, a twin screw extruder, or an in-can blend (pint-cans). In an embodiment or in combination with any embodiment mentioned herein, the adhesive may be shaped into a desired form, such as a tape or sheet, by an appropriate technique including, for example, extrusion, compression molding, calendaring or roll coating techniques (e.g., gravure, reverse roll, etc.), curtain coating, slot-die coating, or spray coating.

Furthermore, the adhesive compositions may be applied to a substrate by solvent casting processes or by melting the adhesive and then using conventional hot melt adhesive application equipment known in the art. Suitable substrates can include, for example, nonwoven, textile fabric, paper, glass, plastic, films (Polyethylene, Polypropylene, Polyester etc.), and metal. Generally, about 0.1 to 100 g/m², about 0.1 to about 150 g/m², or about 1 to about 1000 g/m² of the adhesive composition can be applied to a substrate.

According to one or more embodiments, the hot melt adhesive compositions can have a Brookfield viscosity at 177° C. of at least 100, 300, 500, 750, or 1,000 and/or not more than 60,000, 40,000, 30,000, 20,000, 10,000, 5,000, 4,000, 3,000, or 2,500 cps as measured according to ASTM D3236. Moreover, the hot melt adhesives can have a Brookfield viscosity at 177° C. in the range of 100 to 60,000, 300 to 10,000, 500 to 5,000, 750 to 2,500, 400 to 3,000, 500 to 1,000, 500 to 5,000, 500 to 10,000, 500 to 15,000, 500 20,000, 1,000 to 5,000, 1,000 to 10,000, 1,000 to 15,000, 1,000 20,000, 1,000 to 40,000, 1,000 to 60,000 cps.

In an embodiment or in combination with any embodiment mentioned herein, the hot melt adhesive compositions can have a Brookfield viscosity at 190° C. of at least 100, 500, 1,000, 2,000, 3,000, 4,000, 5,000, 6,000, 7,000, 8,000, or 9,000 and/or not more than 60,000, 50,000, 40,000, 30,000, 20,000, 15,000 or 10,000 cps as measured according to ASTM D3236. For example, the hot melt adhesives can have a Brookfield viscosity at 190° C. in the range of 100 to 60,000, 500 to 30,000, 1,000 to 40,000, 1,000 to 10,000, 2,000 to 20,000, 2,000 to 10,000, 2,000 to 15,000, 3,000 to 15,000, 2,500 to 25,000, or 2,000 to 30,000 cps.

Furthermore, in various embodiments, the hot melt adhesive compositions can have a 90 degree peel strength (T-peel) of at least 1, 2, 5, 10, or 15 and/or not more than 50, 40, 35, 30, or 25 g/mm as measured according to ASTM D903. Moreover, the hot melt adhesives can have a peel strength in the range of 1 to 50, 2 to 40, 5 to 35, 10 to 30, or 15 to 25 g/mm as measured according to ASTM D903. Additionally or alternatively, the hot melt adhesives can have a 90 degree peel strength of at least 0.05, 0.1, 0.2, or 0.5 and/or not more than 20, 10, 5, or 1 lbf/inch as measured according to ASTM D903.

According to various embodiments, the adhesive compositions containing the inventive copolymers can have a broad operating window and may have an application window from 80 to 230° C. This broad operating window can be demonstrated by the peel strengths of the adhesives at different temperatures.

In an embodiment or in combination with any embodiment mentioned herein, the hot melt adhesive compositions can have a holding power at 50° C. of at least 0.1, 0.5, or 1 and/or not more than 50,000, 10,000, 5,000, 1,000, 500, 100, 50, 20, 10, 7, or 4 hours as measured according to ASTM D3654. Moreover, the hot melt adhesives can have a holding power at 50° C. in the range of 0.1 to 10, 0.5 to 7, or 1 to 4 hours as measured according to ASTM D3654.

In other embodiments, the hot melt adhesive compositions can exhibit a holding power at 60° C. of at least 5, 15, 20, or 25 minutes and/or not more than 150 minutes. Additionally or alternatively, the hot melt adhesives can exhibit a holding power at 50° C. of at least 400, 600, 800, or 1,000 minutes. The holding power at 50° C. and 60° C. can be measured by stabilizing glued carton substrates overnight at room temperature, which is normally 20 to 23° C., and then hanging the substrates in a shear bank oven in the peel mode. A weight is then hung under the glued substrate. The time at which the weight drops due to failure is recorded for each specimen.

The hot melt adhesive compositions can exhibit a shear adhesion failure temperature (“SAFT”) of at least 2, 3, 30, 50, 75, 80, 85, 90, 95, 100, 110, 120, 130, 135 and/or not more than 200, 160, 155, 150, 140, 135, 134, 133, 130 or 135° C. as measured according to ASTM D4498. Moreover, the hot melt adhesives can have a SAFT in the range of 2 to 200, 30 to 200, 50 to 150, 75 to 125, 130 to 160, 130 to 155, 130 to 150, 130 to 145, 135 to 155, 135 to 150, 140 to 160, 140 to 155, 140 to 150, 145 to 160, 145 to 155, or 145 to 150° C. as measured according to ASTM D4498.

In an embodiment or in combination with any embodiment mentioned herein, the hot melt adhesive compositions can exhibit a high temperature performance fiber tear (“HTFT”) at 60° C. of at least 50, 65, 70, 75, 80, 85, 90 or 95 percent. The HTFT test consists of manually tearing a glued corrugated cardboard (carton) substrate by hand under the condition of 60° C. The glued carton substrates must be stabilized under the condition of 60° C. for 4 hours plus or minus 5 minutes before the tearing. If 80% fiber of the substrates breaks, the test is considered a pass, and therefore, the hot melt adhesive is considered to perform well. For some applications, if 50% fiber of the substrates breaks, the test is considered a pass and the adhesive is considered to perform well at 60° C.

In an embodiment or in combination with any embodiment mentioned herein, the adhesives containing the inventive copolymers do not exhibit substantial changes in color when subjected to storage conditions at elevated temperatures over extended periods of time. Before any aging due to storage occurs, the adhesives can have an initial Gardner color of less than 18, 15, 10, 8, 5, 4, 3, 2, or 1 as measured according to ASTM D1544. After being heat aged at 177° C. for at least 96 hours, the adhesives can exhibit a final Gardner color of less than 18, 15, 10, 7, 5, 3, 2 or 1 as measured according to ASTM D1544. Thus, the adhesives can retain a desirable color even after prolonged storage and exposure.

In an embodiment or in combination with any embodiment mentioned herein, the inventive propylene-ethylene copolymer can be utilized in adhesive compositions as described previously in this disclosure. In particular, the inventive propylene-ethylene copolymer can be utilized to produce hot melt adhesives having a wide process window and a high peel strength for the laminated materials, such as, but not limited to, dashboard components for automobile interiors. In various embodiments of the present invention, the adhesive formulation is utilized as a hot melt adhesive and comprises at least one inventive copolymer and at least one tackifier resin. Optionally, the hot melt adhesive can further comprise a wax, optionally oil, and/or antioxidant. In one particular embodiment, the hot melt adhesive comprises about 40 to about 85% by weight of the inventive copolymer and about 15 to about 45% by weight of tackifier resin. In another embodiment, the hot melt adhesive composition comprises no tackifier resin.

One embodiment of the present invention relates to a vehicle having a vehicle interior material (preferably an automobile interior material) comprising a skin material (preferably a polyolefin-based substrate) to which the hot melt composition is applied. Examples of the vehicle according to the present invention include, but not particularly limited to, vehicles such as motor vehicles (automobiles), motor bicycles (motorcycles), buses, and streetcars. In the present specification, although a term “automobile interior material” is used in some sentences, the term may be construed to mean an interior material for vehicles other than automobiles as long as the hot melt composition of the present invention can be applied.

The inventive compositions can be used to form bonds to produce a laminate and multilayer laminates. The term “laminate” and “multilayer laminate” are used interchangeably.

The inventive compositions according to one or more embodiments of the present invention can be bonded to various adherends including but not limited to: cellulosic polymer materials such as paper, cotton, linen, cloth, and wooden boards; synthetic polymer materials, including polyolefin resins such as polypropylene and polyethylene, styrene resins such as polystyrene, styrene-butadiene block copolymers (SBS resins), styrene-acrylonitrile copolymers (AS resins), acrylonitrile-ethylene/propylene styrene copolymers (AES resins), and acrylonitrile-butadiene-styrene copolymers (ABS resins), polycarbonate resins (PC resins), (meth)acrylic resins, polyester resins, polyamide resins such as nylon and polyurethane, phenol resins, and epoxy resins. The material for the adherend may be a mixture or combination of two or more different materials. In the case that the laminate is formed by bonding two different adherends via an adhesive layer comprising the inventive propylene-ethylene polymers or hot melt adhesives of the present invention, the materials of the two adherends may be the same as or different from each other.

The laminate comprising the inventive polymer or compositions can be suitably used in applications where a covering material and a formed article are used as adherends, such as interior materials for automobiles and the like (e.g., ceiling materials for automobile interiors, door components for automobile interiors, dashboard components for automobile interiors, instrument panels), components for household electrical appliances (e.g., housings for personal computers, frames of flat-screen televisions), and housing materials (e.g., interior wall boards, decorating films

The covering material refers to one that has been formed into a film, a sheet, a foam, or a non-woven or woven material of any type. Examples include decorating polymer sheets made of polyvinyl chloride, various polyolefins, or ABS, thermoplastic polyolefin compounds (TPO) such as polypropylene blended with uncrosslinked EPDM rubber and/or polyethylene, polyester non-woven fabrics, raised knits, fabrics, polyurethane artificial leathers, and polyolefin foams formed mainly from polypropylene, polyethylene, polybutylene, or copolymers of these olefins. Examples of the formed article include injection-molded articles of various polymer materials such as ABS, PC/ABS, polyolefins, glass fiber-reinforced polyolefins, and glass fiber-reinforced nylons; and ligneous formed articles and ligneous boards prepared by encasing a material such as wood chips or ligneous powder in a thermosetting resin or a polyolefin resin by hot press molding.

In the preparation of a multi-layer laminate by bonding the covering material such as a decorating sheet and a formed article used as a base material via an adhesive layer comprising the inventive propylene-ethylene polymers or hot melt adhesives various forming methods such as heat lamination, vacuum forming, vacuum pressure forming, hot pressing, heat rolling, and hot stamping can be used. The curved formed article denotes, among formed articles as made of the above-mentioned materials, one which has a planar arcshaped surface as the surface to be bonded to the covering material. Such formed articles are used to form shape skeletons in automobile interiors or housings of household electrical appliances.

In other embodiments of this invention, adhesive composition formulations are provided. Each of the subsequent embodiments contain the propylene-ethylene copolymer of this invention as described previously in this disclosure.

In an embodiment or in combination with any embodiment mentioned herein, an adhesive composition is provided comprising at least one propylene-ethylene copolymer, wherein the propylene-ethylene copolymer comprises ethylene and propylene; wherein the amount of propylene ranges from about 89 to about 95 wt %; wherein the ethylene-propylene copolymer has a Ring and Ball softening point from about 135 to 160 C, and wherein the ethylene-propylene copolymer has a triad tacticity of amount 50 to about 70%; wherein the composition comprises:
(a) 5 to 100 weight percent of the at least one propylene-ethylene copolymer;
(b) 0 to 55 weight percent of at least one second polymer;
(c) not more than 70 weight percent of at least one tackifier;
(d) not more than 20 weight percent of a processing oil; and
(e) not more than 35 weight percent of at least one wax.

In an embodiment or in combination with any embodiment mentioned herein, an adhesive composition is provided wherein the composition comprises:
(a) 5 to 100 weight percent of the at least one propylene-ethylene copolymer;
(b) 0 to 50 weight percent of at least one second polymer;
(c) not more than 70 weight percent of at least one tackifier;
(d) not more than 20 weight percent of a processing oil; and
(e) not more than 35 weight percent of at least one wax.

These adhesive compositions can have a Brookfield viscosity at 177° C. in the range of about 2,000 to about 20,000 cP; and/or shear adhesion failure temperature of at least about 135° C.; and/or a thermal creep length of 5 mm or less at 110° C.; and/or a thermal creep length of 5 mm or less at 120° C.

These adhesive compositions can have a Brookfield viscosity at 190° C. in the range of about 2,000 to about 20,000 cP; and/or shear adhesion failure temperature of at least about 135° C.; and/or a thermal creep length of 5 mm or less at 110° C.; and/or a thermal creep length of 5 mm or less at 120° C.

In an embodiment or in combination with any embodiment mentioned herein, these adhesive compositions can have a composition has a Brookfield viscosity at 177° C. in the range of about 2,000 to about 20,000 cP; and/or shear adhesion failure temperature at least about 135° C.; and/or a thermal creep length of 5 mm or less at a temperature at least 10° C. greater than the temperature at which the equivalent composition that does not comprise the at least one propylene-ethylene copolymer has a thermal creep length of 5 mm or less.

In an embodiment or in combination with any embodiment mentioned herein, these adhesive compositions can have a composition has a Brookfield viscosity at 190° C. in the range of about 2,000 to about 20,000 cP; and/or shear adhesion failure temperature at least about 135° C.; and/or a thermal creep length of 5 mm or less at a temperature at least 10° C. greater than the temperature at which the equivalent composition that does not comprise the at least one propylene-ethylene copolymer has a thermal creep length of 5 mm or less.

In an embodiment or in combination with any embodiment mentioned herein, an adhesive composition is provided comprising:
(a) 10 to 70 weight percent of the at least one propylene-ethylene copolymer;
(b) 5 to 55 weight percent of at least one second polymer;
(c) not more than 70 weight percent of at least one tackifier;
(d) not more than 20 weight percent of a processing oil; and
(e) not more than 20 weight percent of at least one wax

In an embodiment or in combination with any embodiment mentioned herein, an adhesive composition is provided comprising:
(a) 5 to 95 weight percent of the at least one propylene-ethylene copolymer;
(b) 5 to 90 weight percent of the at least one second polymer;
(c) not more than 70 weight percent of at least one tackifier;
(d) not more than 20 weight percent of a processing oil; and
(e) not more than 20 weight percent of at least one wax.

In an embodiment or in combination with any embodiment mentioned herein, an adhesive composition is provided comprising:
(a) 30 to 80 weight percent of the at least one propylene-ethylene copolymer;
(b) 1 to 45 weight percent of the at least one second polymer;
(c) not more than 70 weight percent of at least one tackifier;
(d) not more than 20 weight percent of a processing oil; and
(e) not more than 20 weight percent of at least one wax.

In an embodiment or in combination with any embodiment mentioned herein, an adhesive composition is provided comprising:
a) 35 to 85 weight percent of the at least one propylene-ethylene copolymer;
(b) 0 to 45 weight percent of the at least one second polymer;
(c) 5 to 35 weight percent of at least one tackifier;
(d) not more than 33 weight percent of at least one wax; and
(e) not more than 17 weight percent of at least one polypropylene wax.

In an embodiment or in combination with any embodiment mentioned herein, an adhesive composition is provided comprising:
(a) 35 to 85 weight percent of the at least one propylene-ethylene copolymer;
(b) 0 to 45 weight percent of the at least one second polymer;
(c) 5 to 35 weight percent of at least one tackifier;
(d) not more than 26 weight percent of at least one polyethylene wax; and
(e) not more than 7 weight percent of at least one polypropylene wax.

In an embodiment or in combination with any embodiment mentioned herein, an adhesive composition is provided comprising:
(a) 50 to 95 weight percent of the at least one propylene-ethylene copolymer;
(b) 0 to 55 weight percent of at least one second polymer;
(c) 5 to 35 weight percent of at least one tackifier; and
(d) 0 to 15 weight percent of at least one wax.

In any of these adhesive compositions, the composition can further comprises at least one second polymer selected from the group consisting of amorphous polyolefins, semi-crystalline polyolefins, alpha-polyolefins, reactor-ready polyolefins, metallocene-catalyzed polyolefin polymers and elastomers, reactor-made thermoplastic polyolefin elastomers, olefin block copolymers, thermoplastic polyolefins, atactic polypropylene, polyethylenes, ethylene-propylene polymers, propylene-hexene polymers, ethylene-butene polymers, ethylene-octene polymers, propylene-butene polymers, propylene-octene polymers, metallocene-catalyzed polypropylene polymers, metallocene-catalyzed polyethylene polymers, propylene-based terpolymers including ethylene-propylene-butylene terpolymers, copolymers produced from propylene and linear or branched C₄-C₁₀ alpha-olefin monomers, copolymers produced from ethylene and linear or branched C₄-C₁₀ alpha-olefin monomers, functionalized polyolefins, isoprene-based block copolymers; butadiene-based block copolymers; hydrogenated block copolymers; styrene-ethylene/butylene-styrene block copolymers (SEBS); styrene-isoprene-styrene block copolymers (SIS); styrene-ethylene/propylene-styrene (SEPS); ethylene vinyl acetate copolymers; polyesters; polyester-based copolymers; neoprenes; urethanes; acrylics; polyacrylates; acrylate copolymers, such as, but not limited to, ethylene acrylic acid copolymer, ethylene n-butyl acrylate copolymers, and ethylene methyl acrylate copolymers; polyether ether ketones; polyamides; styrenic block copolymers; hydrogenated styrenic block copolymers; random styrenic copolymers; ethylene-propylene rubbers; ethylene vinyl acetate copolymers; butyl rubbers; styrene butadiene rubbers; butadiene acrylonitrile rubbers; natural rubbers; polyisoprenes; polyisobutylenes; and polyvinyl acetates.

In an embodiment or in combination with any embodiment mentioned herein, a process of making an adhesive composition is provided comprising mixing:
(a) 5 to 100 weight percent of the at least one propylene-ethylene copolymer; wherein the propylene-ethylene copolymer comprises ethylene and propylene; wherein the amount of propylene ranges from about 89 to about 95 wt %; wherein the ethylene-propylene copolymer has a Ring and Ball softening point from about 135 to 160 C, and wherein the ethylene-propylene copolymer has a triad tacticity of amount 50 to about 70%;
(b) 0 to 55 weight percent of at least one second polymer;
(c) not more than 70 weight percent of at least one tackifier;
(d) not more than 20 weight percent of a processing oil; and
(e) not more than 35 weight percent of at least one wax.

In this process, the adhesive composition can be used to bond to a substrate and subsequently laminating to another substrate.

In an embodiment or in combination with any embodiment mentioned herein, a process for preparing an automotive assembly component is provided comprising:
(a) applying the adhesive composition to the surface of at least one layer of a substrate, and
(b) forming a laminate by contacting the surfaces to be adhered each with the other.

Various articles can be produced using the adhesive compositions. An article comprising the adhesive composition is provided wherein the article is selected from the group consisting of adhesives, sealants, caulks, roofing membranes, waterproof membranes, compounds, and underlayments, carpet, laminates, laminated articles, tapes, labels, mastics, polymer blends, wire coatings, molded articles, heat seal coatings, disposable hygiene articles, insulating glass (IG) units, bridge decking, bitumen modification, asphalt modification, electronic housings, water proofing membranes, cable flooding/filling compounds, sheet molded compounds, dough molded compounds, overmolded compounds, rubber compounds, polyester composites, glass composites, fiberglass reinforced plastics, wood-plastic composites, polyacrylic blended compounds, lost-wax precision castings, investment casting wax compositions, book bindings, candles, windows, tires, films, gaskets, seals, o-rings, motor vehicles (automobiles), motor bicycles (motorcycles), buses, and streetcars, trucks, motor vehicle molded parts, motor vehicle extruded parts, clothing articles, rubber additive/processing aids, and fibers; wherein the adhesives include: packaging adhesives, food contact grade adhesives, indirect food contact packaging adhesives, product assembly adhesives, woodworking adhesives, edge banding adhesives, profile wrapping adhesives, flooring adhesives, automotive assembly adhesives, structural adhesives, flexible laminating adhesive, rigid laminating adhesive, flexible film adhesive, flexible packaging adhesive, water activated adhesives, home repair adhesive, industrial adhesive, construction adhesive, furniture adhesive, mattress adhesives, pressure sensitive adhesives (PSA), PSA tapes, PSA labels, PSA protective films, self-adhesive films, laminating adhesives, flexible packaging adhesives, heat seal adhesives, industrial adhesives, hygiene nonwoven construction adhesives, hygiene core integrity adhesives, and hygiene elastic attachment adhesives.

This invention can be further illustrated by the following examples of embodiments thereof, although it will be understood that these examples are included merely for the purposes of illustration and are not intended to limit the scope of the invention unless otherwise specifically indicated

### EXAMPLES

### Polymerization of Heat Resistant Propylene-Ethylene Copolymers

Various inventive propylene-ethylene copolymers were produced that had specific propylene contents, desirable triad tacticites (mm %) (i.e., a reflection of isotactic structure), and high ring and ball softening points (RBSP). The propylene-ethylene copolymers were produced in accordance with the following polymerization process.

The reactants propylene, ethylene, and hydrogen, along with diluent, external donor and catalyst are fed into a 5-gallon continuously stirred tank reactor (CSTR) at the ratios, flow rates, and temperatures provided in Tables 2A, 2B, and 2C for each of the produced samples. The inventive samples and comparative samples (i.e., the comparative samples that were produced) in Tables 3A and 3B were made with the Generation 3 (Benozate) catalyst and an alkoxy silane as the external electron donor described above, and the inventive samples and comparative samples in Table 3C were made with the Generation 5 and 6 catalysts both with and without the external electron donor described above. The reactor operated at a pressure ranging from 790 to 850 psi. Furthermore, a hot oil system provided tracing for the reactor jacket. A dip tube carried the product out of the reactor, and an equilibar (pressured by helium) maintained pressure control of the reactor.

The copolymer from the letdown tank was then stripped of diluent, and residual catalyst was then deactivated in a hot oil jacketed exchanger using steam and nitrogen. Molten copolymer was then collected from the bottom of the deactivator and pumped to a final product collection tank.

The resulting copolymers in Table 1 were prepared as described above using the conditions listed in Tables 2A, 2B, and 2C. The properties of the copolymers obtained from the given conditions in Tables 2A, 2B, and 2C are given in Tables 3A, 3B, and 3C.

Inventive examples in Tables 2A, 3A, 2B, and 3B were produced using the aforementioned Generation 3 or Generation 4 ZN catalyst system and an external electron donor. Compared to Comparative Examples 1-6, the combination of Donor ratio lower than about 1:1 and Ethylene flow lower than 40 g/hr unexpectedly resulted in a ring and ball softening point higher than 135° C. with a needle penetration typically less than about 21 and tensile strength typically higher than about 2.5 MPa.

As shown in Tables 3A and 3B, the addition of the external donor generally increased hardness, which was indicated by a decrease in needle penetration, along with increasing the viscosity of the copolymers. In addition, reduced ethylene flow results in copolymer with high propylene-to-ethylene comonomer ratio, therefore, increase RBSP and hardness represented by decreased needle penetration. Compared to Comparative Example 6 (Example C1 from U.S. Pat. No. 942,859 Eastman Chemical Company), the inventive examples were produced at lower relative ethylene flow (referring to lower relative ethylene flow at comparable propylene flow) and use of external donor. As shown in Table 3, it was observed that copolymer Inventive Example 1 had about 20% increasement in ring and ball softening point (RBSP) and about 95% lower Needle Penetration than Comparative Example 6.

Unexpectedly, the inventive polymers with low ethylene content from about 2% to about 11 wt % and with about 50% to about 70% trial tacticity content (mm % by proton NMR) simultaneously have high RBSP (heat resistance) and high tensile. Additionally, the inventive polymers have a surprisingly wide range of viscosities from about 2000 cP to about 50000 cP at 190° C.

The inventive copolymers and the comparative samples produced under the conditions provided in Tables 2A, 2B, and 2C were subjected to testing to verify the properties and characteristics of the copolymers. The various properties were tested using the test methodologies described, unless otherwise noted.

The techniques for determining the ethylene and propylene composition by NMR can be found in Macromolecules 2000, 33, 1157-1162 (Wang et al), and formula for measuring triad tacticity may be found in U.S. Pat. No. 5,504,172 and the article by Tsutsui et al. (Polymer 1989, 30, 1350-1356), all of which are incorporated by reference in their entireties.

Samples were prepared by adding 0.4 g of the polyolefin sample and 100 mg Cr(acac)3 to a 4-dram vial, followed by 0.5 mL of orthodichlorobenzene-d4 and 3.5 mL of trichlorobenzene (non-deuterated). The resulting solution was stirred magnetically at 120° C. until complete dissolution of the copolymer was observed by visual inspection. Dissolution was typically complete within 1 hour. A 10 mm NMR tube was warmed to 80° C. While wearing heat-resistant gloves, the warm solution was poured into the 10 mm NMR tube until the sample height was about 4.5-5 cm. The tube was then capped with a push-on cap. It was important to transfer the solution to the NMR tube while it was still warm so that it did not solidify before the transfer is complete. Spectra were analyzed using MNova software. After a Fourier transform was applied to the FID data, spectra were phased, and the baselines were corrected, and calculations performed as described in the references given. It was determined that the standard deviation on PP % was 0.7 and on mm % was 0.3 It was determined that the standard deviation on PP % was 0.7 and on mm % was 0.3.

The triad tacticity of a polymer is the relative tacticity of a sequence of three adjacent propylene units, a chain consisting of head to tail bonds, expressed as a binary combination of meso (m) and racemic (r) sequences. The triad tacticity expressed herein as “mm %” is determined by 13C nuclear magnetic resonance (NMR) and the following formula:

$$m m Fraction = \frac{P P P ( m m )}{P P P ( m m ) + P P P ( mr ) + P P P ( r r )} \qquad ( eq 1 )$$

where PPP (mm), PPP (mr) and PPP (rr) denote peak areas derived from the methyl groups on a propylene sequence relative to next corresponding propylene sequences methyl group orientations as shown by chemical shifts below:
   PPP (mm)=21.3-22.0 ppm;
   PPP (mr)=20.6-21.3 ppm;
   PPP (rr)=18.0-22.5 ppm.

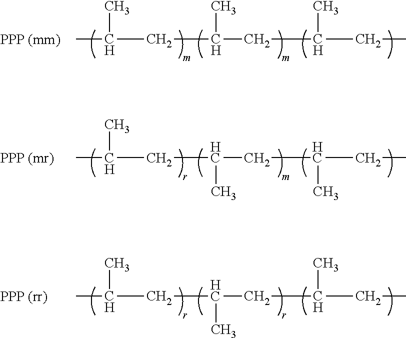

Triad tacticity of Polypropylene by the relative tacticity of a sequence of three adjacent propylene units.

For comparison purposes, Table 3D provides the properties of various Commercially-Available Copolymers (“CAC”) and Commercial Waxes.

TABLE 2A

| | Inv. | Inv. | Inv. | Inv. | Inv. | Comp | Comp | Comp | Comp | Comp | Comp |
|---|---|---|---|---|---|---|---|---|---|---|---|
| Example No. | Ex. 1 | Ex. 2 | Ex. 3 | Ex. 4 | Ex. 5 | Ex. 1 | Ex. 2 | Ex. 3 | Ex. 4 | Ex. 5 | Ex. 6 |
| Donor ratio | 0.3:1 | 0.3:1 | 0.3:1 | 0.4:1 | 0.3:1 | 0.65:1 | 3:1 | 0.9:1 | 5:1 | 3:1 | 0 |
| (External | | | | | | | | | | | |
| Donor/Ti | | | | | | | | | | | |
| ratio) | | | | | | | | | | | |
| Propylene | 682 | 682 | 682 | 682 | 682 | 682 | 682 | 682 | 682 | 927 | 682 |
| flow (g/hr) | | | | | | | | | | | |
| Ethylene | 15 | 5 | 2.5 | 5 | 15 | 42 | 47 | 75 | 70 | 10 | 122.8 |
| flow (g/hr) | | | | | | | | | | | |
| Reactor | 145 | 150 | 140 | 150 | 145 | 150 | 140 | 145 | 145 | 154 | 140 |
| temp (° C.) | | | | | | | | | | | |
| H₂ flow | 0.03 | 0.08 | 0 | 0.12 | 0.13 | 0.25 | 0.57 | 0.38 | 1.4 | 1.7 | — |
| (g/hr Eth. | | | | | | | | | | | |
| Flow) | | | | | | | | | | | |

TABLE 2B

| | Inv | Inv | Inv | Inv | Inv | Inv | Inv | Inv | Inv |
|---|---|---|---|---|---|---|---|---|---|
| Ex No. | Ex 7 | Ex 8 | Ex 9 | Ex 10 | Ex 11 | Ex 12 | Ex 13 | Ex 14 | Ex 15 |
| Donor ratio | 0.3 | 0.3 | 0.3 | 0.3 | 0.3 | 0.5 | 0.3 | 0.3 | 0.3 |
| (External | | | | | | | | | |
| Donor/Ti | | | | | | | | | |
| ratio) | | | | | | | | | |
| Propylene | 682 | 682 | 682 | 682 | 682 | 682 | 682 | 682 | 682 |
| flow (g/hr) | | | | | | | | | |
| Ethylene | 14 | 15 | 15 | 15.5 | 14 | 7.5 | 15 | 5 | 15 |
| flow (g/hr) | | | | | | | | | |
| Reactor | 145 | 145 | 145 | 145 | 145 | 150 | 145 | 150 | 145 |
| temp (° C.) | | | | | | | | | |
| H₂ flow | 0.028 | 0.06 | 0.048 | 0.095 | 0.02 | 0.1 | 0.1 | 0.1 | 0.028 |
| (g/hr Eth. | | | | | | | | | |
| Flow) | | | | | | | | | |

| | Inv | Inv | Inv | Inv | Inv | Inv | Inv | Inv |
|---|---|---|---|---|---|---|---|---|
| Ex No. | Ex 16 | Ex 17 | Ex 18 | Ex 19 | Ex 20 | Ex 21 | Ex 22 | Ex 23 |
| Donor ratio | 0.3 | 0.3 | 0.3 | 0.3 | 0.3 | 0.3 | 0.2 | 0.3 |
| (External | | | | | | | | |
| Donor/Ti | | | | | | | | |
| ratio) | | | | | | | | |
| Propylene | 682 | 682 | 682 | 682 | 682 | 682 | 682 | 682 |
| flow (g/hr) | | | | | | | | |
| Ethylene | 10 | 5 | 14 | 14 | 15 | 15 | 15 | 5 |
| flow (g/hr) | | | | | | | | |
| Reactor | 145 | 150 | 145 | 145 | 145 | 145 | 145 | 150 |
| temp (° C.) | | | | | | | | |
| H₂ flow | 0.033 | 0.09 | 0.028 | 0.02 | 0.031 | 0.033 | 0 | 0.1 |
| (g/hr Eth. | | | | | | | | |
| Flow) | | | | | | | | |

TABLE 2C

| | Inv | Inv | Inv | Inv | Inv | Inv | Inv | Inv |
|---|---|---|---|---|---|---|---|---|
| Ex No. | Ex 98 | Ex 99 | Ex 100 | Ex 101 | Ex 102 | Ex 103 | Ex 104 | Ex 105 |
| Donor ratio | 0.75:1 | 0.75:1 | 0 | 0 | 0 | 0 | 0 | 0 |
| (External | | | | | | | | |
| Donor/Ti | | | | | | | | |
| ratio) | | | | | | | | |
| Propylene | 682 | 682 | 682 | 682 | 682 | 682 | 682 | 682 |
| flow (g/hr) | | | | | | | | |
| Ethylene | 10 | 10 | 8 | 12 | 10 | 10 | 8 | 8 |
| flow (g/hr) | | | | | | | | |
| Reactor | 143 | 143 | 143 | 144 | 144 | 144 | 143 | 143 |
| temp (° C.) | | | | | | | | |
| H₂ flow | 0.250 | 0.230 | 0.150 | 0.120 | 0.120 | 0.120 | 0.145 | 0.145 |
| (g/hr Eth. | | | | | | | | |
| Flow) | | | | | | | | |

| | Inv | Inv | Inv | Inv | Inv | Inv | Inv |
|---|---|---|---|---|---|---|---|
| Ex No. | Ex 106 | Ex 107 | Ex 108 | Ex 109 | Ex 110 | Ex 111 | Ex 112 |
| Donor ratio | 0 | 0 | 0.75:1 | 0.75:1 | 0.75:1 | 0 | 0 |
| (External | | | | | | | |
| Donor/Ti | | | | | | | |
| ratio) | | | | | | | |
| Propylene | 682 | 682 | 682 | 682 | 682 | 682 | 682 |
| flow (g/hr) | | | | | | | |
| Ethylene | 8 | 6 | 20 | 20 | 10 | 10 | 10 |
| flow (g/hr) | | | | | | | |
| Reactor | 145 | 145 | 142.5 | 142.5 | 142.5 | 150 | 145 |
| temp (° C.) | | | | | | | |
| H₂ flow | 0.140 | 0.400 | 0.350 | 0.300 | 0.300 | 0.200 | 0.350 |
| (g/hr Eth. | | | | | | | |
| Flow) | | | | | | | |

TABLE 3A

| | Inv | Inv | Inv | Inv | Inv | Inv | Comp | Comp | Comp | Comp | Comp | Comp |
|---|---|---|---|---|---|---|---|---|---|---|---|---|
| Example # | Ex 1 | Ex 2 | Ex 3 | Ex 4 | Ex 5 | Ex 6 | Ex 1 | Ex 2 | Ex 3 | Ex 4 | Ex 5 | Ex 6 |
| Viscosity, | 26830 | 21600 | 15730 | 22280 | 17850 | 15870 | 7642 | 3325 | 10560 | 23550 | 9313 | 7013 |
| cP@190 C. | | | | | | | | | | | | |
| Needle Pen | 6 | 8 | 5 | 2 | 4 | 3 | 29 | 13 | 14 | 78 | 14 | 82 |
| (dmm) | | | | | | | | | | | | |
| Ring and Ball | 145 | 145 | 158 | 150 | 146 | 138 | 113 | 124 | 115 | 99 | 106 | 121 |
| softening point | | | | | | | | | | | | |
| (° C.) | | | | | | | | | | | | |
| triad tacticity | 62 | 56 | N/A | 69 | 65 | 52 | 47 | N/A | N/A | 35 | 55 | N/A |
| mm content % | | | | | | | | | | | | |
| Tensile | 8 | 6 | 5 | 9 | 7 | 3 | 1 | 4 | 4 | too | 2 | too soft |
| strength at | | | | | | | | | | soft | | and tacky |
| break (MPa) | | | | | | | | | | | | |
| Elongation at | 500 | 593 | 50 | 33 | 267 | 354 | 91 | 22 | 326 | too | 70 | too soft |
| break (%) | | | | | | | | | | soft | | and tacky |
| Heat of | 39 | 32 | 38 | 52 | 40 | 22 | 14 | 27 | 23 | 0.7 | 17 | N/A |
| crystallization | | | | | | | | | | | | |
| (Hc, 20° C./min | | | | | | | | | | | | |
| cooling rate), J/g | | | | | | | | | | | | |
| Heat of fusion, | 28 | 22 | 30 | 36 | 30 | 15 | 8.7 | 20 | 17 | 1 | 12 | N/A |
| 20° C./min | | | | | | | | | | | | |
| heating rate | | | | | | | | | | | | |
| (Hf, J/g) | | | | | | | | | | | | |
| Propylene, wt % | 93 | 92 | N/A | 93 | 93 | 92 | 81 | N/A | N/A | 66 | 55 | N/A |

TABLE 3B

| | Inv | Inv | Inv | Inv | Inv | Inv | Inv | Inv | Inv |
|---|---|---|---|---|---|---|---|---|---|
| Example | Ex 7 | Ex 8 | Ex 9 | Ex10 | Ex11 | Ex12 | Ex13 | Ex14 | Ex15 |
| Viscosity, | 46700 | 6225 | 17230 | 22230 | 13480 | 19920 | 25830 | 9500 | 8725 |
| cP@190 C. | | | | | | | | | |
| Needle Pen | 5 | 10 | 5 | 10 | 15 | 11 | 8 | 10 | 13 |
| (dmm) | | | | | | | | | |
| Ring and Ball | 144 | 144 | 144 | 148 | 141 | 142 | 145 | 145 | 146 |
| softening | | | | | | | | | |
| point (° C.) | | | | | | | | | |
| triad tacticity | 63 | 56 | 59 | 59 | 55 | 56 | 63 | 55 | 53 |
| mm content % | | | | | | | | | |
| Tensile | 8 | 4 | 6 | 5 | 4 | 4 | 10 | 4 | 5 |
| strength at | | | | | | | | | |
| break (MPa) | | | | | | | | | |
| Elongation at | 547 | 363 | 402 | 421 | 518 | 353 | 553 | 334 | 473 |
| break (%) | | | | | | | | | |
| Heat of | 37 | 30 | 34 | 33 | 25 | 29 | 36 | 31 | 29 |
| crystallization | | | | | | | | | |
| (Hc, 20° C./min | | | | | | | | | |
| cooling rate), J/g | | | | | | | | | |
| Heat of fusion, | 21 | 21 | 23 | 22 | 16 | 19 | 27 | 22 | 22 |
| 20° C./min | | | | | | | | | |
| heating rate | | | | | | | | | |
| (Hf, J/g) | | | | | | | | | |
| Propylene, wt % | 93 | 93 | 93 | 90 | 92 | 90 | 93 | 92 | 94 |

| | Inv | Inv | Inv | Inv | Inv | Inv | Inv | Inv |
|---|---|---|---|---|---|---|---|---|
| Example | Ex16 | Ex17 | Ex18 | Ex19 | Ex20 | Ex21 | Ex22 | Ex23 |
| Viscosity, | 23280 | 7928 | 21700 | 22650 | 20350 | 18000 | 2950 | 5608 |
| cP@190 C. | | | | | | | | |
| Needle Pen | 6 | 15 | 8 | 8 | 7 | 9 | 14 | 12 |
| (dmm) | | | | | | | | |
| Ring and Ball | 147 | 144 | 146 | 143 | 145 | 143 | 146 | 147 |
| softening | | | | | | | | |
| point (° C.) | | | | | | | | |
| triad tacticity | 63 | 57 | 58 | 56 | 60 | 58 | 53 | 54 |
| mm content % | | | | | | | | |
| Tensile | 9 | 6 | 6 | 6 | 6 | 5 | 2 | 3 |
| strength at | | | | | | | | |
| break (MPa) | | | | | | | | |
| Elongation at | 542 | 515 | 411 | 530 | 420 | 399 | 29 | 47 |
| break (%) | | | | | | | | |
| Heat of | 37 | 28 | 34 | 30 | 36 | 31 | 29 | 32 |
| crystallization | | | | | | | | |
| (Hc, 20° C./min | | | | | | | | |
| cooling rate), J/g | | | | | | | | |
| Heat of fusion, | 29 | 20 | 25 | 21 | 24 | 22 | 22 | 21 |
| 20° C./min | | | | | | | | |
| heating rate | | | | | | | | |
| (Hf, J/g) | | | | | | | | |
| Propylene, wt % | 93 | 93 | 93 | 92 | 93 | 92 | 94 | 93 |

TABLE 3C

| | Inv | Inv | Inv | Inv | Inv | Inv | Inv | Inv |
|---|---|---|---|---|---|---|---|---|
| Ex No. | Ex 98 | Ex 99 | Ex 100 | Ex 101 | Ex 102 | Ex 103 | Ex 104 | Ex 105 |
| Viscosity, | 15730 | 17630 | 24880 | 23300 | 21630 | 22430 | 33210 | 31000 |
| cP at 190° C. | | | | | | | | |
| Needle Pen | 4 | 1 | 0.8 | 3 | 3 | 1 | 4 | 2 |
| (dmm) | | | | | | | | |
| RBSP (° C.) | 136 | 142 | 145 | 141 | 144 | 144 | 142 | 145 |
| Triad tacticity | 66.9 | 67.8 | 70.2 | 60.5 | 61.7 | 59.2 | 68.7 | 69.1 |
| mm content (%) | | | | | | | | |
| Tensile | 10.4 | 10.2 | 12.4 | 10.4 | 11.2 | 9.7 | 15.2 | 11 |
| strength at | | | | | | | | |
| break (MPa) | | | | | | | | |
| Elong. at | 560 | 530 | 670 | 700 | 650 | 620 | 650 | 560 |
| break (%) | | | | | | | | |
| Hc, 20° C./min | 29 | 39 | 42 | 35 | 38 | 35 | 39 | 45 |
| cooling rate (J/g) | | | | | | | | |
| Hf, 20° C./min | 19 | 25 | 25 | 21 | 35 | 21 | 33 | 39 |
| heating rate, (J/g) | | | | | | | | |
| Prop. (wt %) | 92 | 91 | 94 | 91 | 93 | 91 | 94 | 91 |

| | Inv | Inv | Inv | Inv | Inv | Inv | Inv |
|---|---|---|---|---|---|---|---|
| Ex No. | Ex 106 | Ex 107 | Ex 108 | Ex 109 | Ex 110 | Ex 111 | Ex 112 |
| Viscosity, | 28500 | 3117 | 1303 | 13080 | 12200 | 13350 | 4235 |
| cP at 190° C. | | | | | | | |
| Needle Pen | 2 | 7 | 0.2 | 3 | 0.8 | 2 | 7 |
| (dmm) | | | | | | | |
| RBSP (° C.) | 141 | 144 | 145 | 148 | 142 | 139 | 141 |
| Triad tacticity | 65.7 | 61.3 | 78.2 | 62.9 | 62.6 | 65.8 | 61.6 |
| mm content (%) | | | | | | | |
| Tensile | 13.2 | 5.4 | NT | 6.5 | 10.1 | 9.2 | 4.9 |
| strength at | | | | | | | |
| break (MPa) | | | | | | | |
| Elong. at | 630 | 20 | NT | 10 | 640 | 590 | 20 |
| break (%) | | | | | | | |
| Hc, 20° C./min | 39 | 40 | 56 | 43 | 38 | 28 | 31 |
| cooling rate (J/g) | | | | | | | |
| Hf, 20° C./min | 33 | 27 | 37 | 30 | 23 | 19 | 18 |
| heating rate, (J/g) | | | | | | | |
| Prop. (wt %) | 91 | 93 | 95 | 96 | 88 | 89 | 93 |

TABLE 3D
Properties of Commercially-Available Copolymers (“CAC”) and Commercial Waxes

| Sample | CAC 1 | CAC 2 | CAC 3 | CAC 4 | CAC 5 | CAC 6 | CAC 7 | CAC 8 |
|---|---|---|---|---|---|---|---|---|
| Vis. @ | 25000 | 8000 | 8000 | 20000 | 7000 | 1000 | 2300 | 6000 |
| 190° C. (cP) | | | | | | | | |
| NP (dmm) | 16 | 10 | 15 | 25 | 7 | 18 | 18 | 40 |
| SP (° C.) | 161 | 157 | 146 | 143 | 161 | 155 | 155 | 135 |
| PP (Wt %) | NT | 96.3 | 93.8 | 88.4 | NT | 98.8 | 98.6 | 88.5 |
| Peak | 158 | 151 | 140 | 131 | 156 | 150 | 151 | 127 |
| Tm (° C.) | | | | | | | | |
| TSB (MPa) | 0.9 | 4.0 | 1.3 | 0.8 | 4.5 | 1.8 | 1.7 | 0.5 |
| EB (%) | 468 | 591 | 180 | 580 | 480 | 33 | 70 | 84 |
| H_{F} (J/g) | 10 | 12 | 14 | 11 | 15 | 21 | 19 | 10 |
| H_{C} (J/g) | 11 | 23 | 19 | 8 | 16 | 27 | 27 | 12 |

| Sample | CAC 9 | WAX1 | WAX2 | WAX3 | WAX4 | WAX5 | WAX6 |
|---|---|---|---|---|---|---|---|
| Vis. @ | 3300 | 8 cP @ | 60 cP @ | 600 | 150 | 2000 | 425 |
| 190° C. (cP) | | 135 C. | 170 C. | | | | |
| NP (dmm) | 14 | 1 | — | <1 | <0.5 | <0.5 | <1 |
| SP (° C.) | 120 | 98 | 145 | 165 | 141 | 149 | 157.5 |
| PP (Wt %) | 82.8 | NT | Polypropylene wax | | | | |
| Peak | 105 | 91 | 130 | 157 | 133 | 146 | 155 |
| Tm (° C.) | | | | | | | |
| TSB (MPa) | 2.7 | too | too | too | too | too | too |
| | | brittle | brittle | brittle | brittle | brittle | brittle |
| EB (%) | 40 | too | too | too | too | too | too |
| | | brittle | brittle | brittle | brittle | brittle | brittle |
| H_{F} (J/g) | 16 | 237 | 46 | 81 | 47 | 79 | 60 |
| H_{C} (J/g) | 25 | 213 | 52 | 82 | 61 | 81 | 69 |

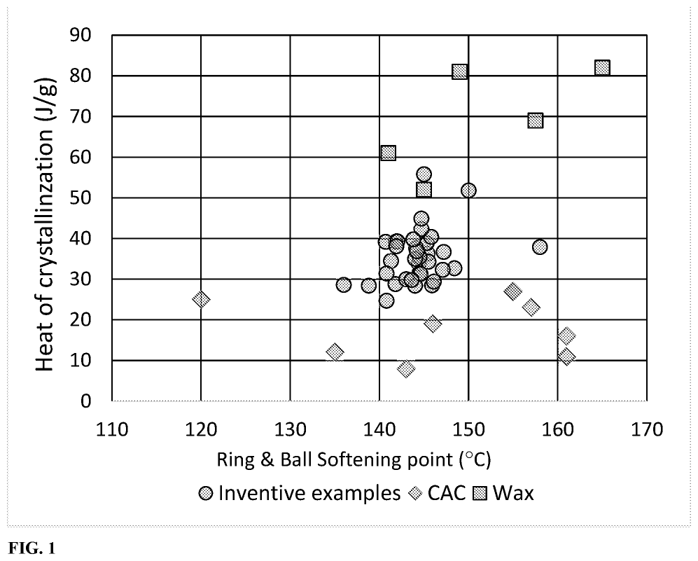

As demonstrated in Table 3D, there are a lot of commercially-available copolymers on the market with softening points that overlap with the inventive copolymers; however, as shown in FIG. 1, these commercially-available copolymers exhibit one or more deficiencies that limit them from being used in high heat resistance applications. Furthermore, to improve the heat resistance properties of adhesives, commercially-available highly crystalline low molecular weight waxes with high crystallinity, such as those depicted in Table 3D, may be added. As shown in Table 3D and in FIG. 1, while these commercial waxes may exhibit ideal softening points, they are incredibly brittle (as indicated by the heat of crystallization). Thus, there are some general issues of blending polyolefins with these waxes due to their brittleness. Consequently, the use of these waxes may negatively impact the viscosity and cohesion strength of the resulting adhesive.

As shown in FIG. 1, the inventive copolymers of TABLES 3A-3C had superior crystallinities and softening points relative to the commercial copolymers and waxes of Table 3D.

### Experimental Procedures for Hot Melt Compositions, Laminate, and Bond Formation, and Testing

TABLE 4A
Substrates

| | |
|---|---|
| PP | Polypropylene sheet with ⅛″ thickness, |
| | part #52420841, MSC Industrial Supply, then cut |
| | into 4″ × 1″ and 2″ × 1″ size. |
| PP-1 | Polypropylene sheet with 1″ thickness, part # |
| | 16596595 from MSC Industrial Supply, then cut into |
| | 1″ × 1″ size for dead load test. |
| ABS - beige | Acrylonitrile-Butadiene-Styrene sheet, ⅛″ |
| | thickness, part # 11902186, MSC Industrial Supply, |
| | then cut into 4″ × 1″ size. |
| TPO-1 foil | Thermoplastic Polyolefin foil, single layer, 0.83 mm |
| | thickness, Canadian General-Tower Limited, |
| | Cambridge, Ontario, Canada |
| TPO-2 foil | Thermoplastic Polyolefin foil composed of a contact |
| | layer, foam layer and textile backing, 2.0 mm thickness, |
| | obtained from Continental German. |
| Medium- | 4.8 mm thickness, A-1 Woodworking Shop, Kingsport |
| density | TN, USA |
| fiberboard | |
| (MDF) wood | |
| board | |
| Birch wood | 3.2 mm thickness, A-1 Woodworking Shop, Kingsport |
| board | TN, USA |
| Paper veneer | TecoFoil V10 (Amenity Maple#19) basis weight |
| | 30 gsm, Bauschlinnemann South Carolina LLC, |
| | Conway, SC, USA |
| Kraft paper | 40 lb virgin Kraft paper from Uline.com (S-20806) |
| Cardboard | ChemRecycled corrugated, sheet B-flute 32ECT |
| | recycled corrugated, Smurfit Stone Container, |
| | Item # 27175 |

TABLE 4B
Materials

| | | |
|---|---|---|
| Eastotac ™ | Hydrocarbon tackifier resin | Eastman Chemical |
| H-130R | (HCR), softening point 130° C., | Co., USA |
| | ASTM D-6090 | |
| Eastotac ™ | HCR, softening point 130° C., | Eastman Chemical |
| H-130W | ASTM D-6090 | Co., USA |
| Eastotac ™ | HCR, softening point 142° C., | Eastman Chemical |
| H-142R | ASTM D-6090 | Co., USA |
| Regalrez ™ | HCR, ring and ball softening | Eastman Chemical |
| 1126 | point (RBSP) 124° C., | Co., USA |
| | ASTM E-28 | |
| Plastolyn ™ | HCR, RBSP 140° C., | Eastman Chemical |
| R1140 | ASTM E-28 | Co., USA |
| Regalite ™ | HCR, RBSP 124° C., | Eastman Chemical |
| R1125 | ASTM E-28 | Co., USA |
| Poly-Pale ™ | Modified rosin acid tackifier | Eastman Chemical |
| | resin, softening point 103° C. | Co., USA |
| Dymerex ™ | Modified rosin acid tackifier | Eastman Chemical |
| | resin, softening point 144° C. | Co., USA |
| Epolene ™ E43 | Maleic anhydride grafted PP | Westlake Chemical, |
| | wax, softening point 158° C., | USA |
| | viscosity 150-700 cp at 190° C. | |
| Epolene ™ N15 | Polypropylene homopolymer, | Westlake Chemical, |
| | softening point 165° C., | USA |
| | viscosity 250-950 cp at | |
| | 190° C. | |
| Polywax ™ 850 | Polyethylene homopolymer, | Baker-Hughes, USA |
| | softening point 107° C., | |
| | viscosity 10 cp at 150° C., | |
| Eastman ™ | Maleic anhydride grafted PP, | Eastman Chemical |
| G-3015 | softening point 156° C., | Co., USA |
| | viscosity 18,000 at 190° C. | |
| Eastman ™ | Maleic anhydride grafted PE, | Eastman Chemical |
| G-3003 | softening point 158° C., | Co., USA |
| | viscosity 60,000 at 190° C. | |
| A-C ™ 1325P | Propylene maleic anhydride | Honeywell Corp., |
| | copolymer, softening point 149° | USA |
| | C., viscosity 1,600 cp at 190° C. | |
| A-C ™ 596P | Propylene Maleic Anhydride | Honeywell Corp., |
| | Copolymer, softening point | USA |
| | 141° C., viscosity | |
| | 150 cp at 190° C. | |
| Licocene ™ | Polypropylene wax, softening | Clariant, |
| PP 6102 | point 146° C., viscosity | Switzerland |
| | 60 cp at 170° C. | |
| Irganox ™ 1010 | Antioxidant | BASF, Germany |

### Preparation of Hot-Melt Adhesive Compositions

A heating block was pre-heated to ˜180° C. Polymer, wax, resin, and antioxidant were weighed into a pint aluminum container. The container was subsequently placed in the heating mantle. Once the mixture shows sign of melting, stirrer was inserted and mixed at a speed of about 150 rpm until it was homogeneous. The adhesive was poured onto a silicon-coated release paper and cooled to room temperature.

### Viscosity Measurement Hot Melt Adhesives

Viscosity was measured using a Brookfield DV2Textra viscometer equipped with a Thermosel™ and a #27 spindle following an internal method that conforms to ASTM D-3236. 10.5 grams of adhesive was placed in a Brookfield tube, and the sample was heated to temperature (if not molten) for 10 minutes. The sample was then allowed to equilibrate under shear for 20 minutes at each respective test temperature. Spindle rpm was adjusted to maximize motor % and no adjustments were made during the last 20 minutes of shear equilibration time. Values are reported in centipoise (cP). The viscosity readings were taken from low to high temperature.

### Adhesive Ring and Ball Softening Point (RBSP)

Adhesive ring and ball softening point was measured using a Herzog ring and ball softening point apparatus following ASTM method E-28. Formulated adhesives were decanted into brass rings and allowed to cool overnight or more than 16 hours. Samples were trimmed flat before testing. Silicone oil was heated at 5° C. per minute until the ball passed through softened specimen, at which point the temperature was measured. Reported values are the average of two readings.

### Adhesive Open Time Measurement

Determination of open time in the lab was done using an internal method based on ASTM D4497-10 “Determining the open time of hot melt adhesives.” The molten adhesive (180° C.) was applied as a film of 127 or 635 μm (5 or 25 mil) using hot drawdown bar on Kraft paper. Final film thickness was 3-5 mil (0.1 mm) or 20-25 mil (0.5 mm). Strips of paper were pressed into the film by a 1 kg weighted block at certain intervals (depending on open time). 30 mins after the last strip was applied, a 90-degree peel was performed by hand to determine which of the applied paper strips could be removed without pulling out the paper fibers (50% fiber tear). The time at which this strip was applied was noted and the open time calculated.

### Preparation of Polymer Samples for Tensile Strength Measurement

### Tensile Strength Sample Preparation:

Carver press was used to prepare film samples for tensile tests. 20 grams of molten samples were placed in the 5 inch×5 inch (137 mm×137 mm) aluminum square mold frame with thickness of 1 mm. Then samples were sandwiched by silicone coated PET films, release papers and metal plates and then heated in the Carver press with zero pressure applied. Samples were held at 177° C. to 188° C. for 12 minutes, then 6000 PSI pressure was applied for 5 seconds and released, then pressure was increased to 12000 PSI and released again. Finally, 18000 PSI pressure was applied and held for 2 minutes. Samples were then taken out of press and quickly transferred from the hot metal plates to a set of room temperature plates with a 10 kg weight block on top to act as heat sink. After 8 minutes cooling time, the block and metal plates were removed. The resulting 137 mm×137 mm×1 mm films were stored in a controlled temperature and humidity room (25° C., 50% RH) for 24 hours, then cut using dumbbell shape cutter based on ASTM-D412 die C.

### Polymer Tensile Strength Measurement

### Tensile Test:

Tensile strength and elongation at break were measured at 20 in/min (51 cm/min) according to the procedure described in ASTM D412 (die C). All testing was performed in a temperature- and humidity-controlled (CTH) room at 25 C, 50% RH. Tensile strength at break was calculated by the force magnitude at break divided by cross-sectional area of unstrained specimen. Elongation at break was calculated by extended distance at break recorded and normalized by original normal gage length 62.5 mm within tensile grips.

### Melt Viscosity for Polyolefin

The melt viscosity of a polyolefin polymer was measured at 190° C. with a 27 # spindle and a Brookfield RVDVI+ viscometer.

### Performance Measurement

### 1. Lamination of TPO Foil and PP or ABS Substrate

### 1.1 TPO-1 and PP or ABS

Adhesive in an aluminum pan and a square film applicator (frame 2 inches with 5-50 mil gap clearances) were heated in a 180° C. oven for at least 30 minutes. The hot film applicator from the oven was placed on a TPO-1 sheet (ca. 9″×5″) and molten adhesive was immediately poured inside of the applicator. Subsequently a film of adhesive with 5 mil thickness was drawn down on the TPO-1 foil. After cooling, the coated foil was cut into 1.0 inch or larger wide for bonding with PP or ABS substrate.

Above TPO-1 foil with precoated adhesive was put into 175° C. oven with the adhesive layer up, then a PP or ABS substrate with size of 4″×1″ and ⅛″ thickness was placed on to the coated TPO-1 followed by a weight of 1 Kg. After the oven door was closed for 2 minutes, the laminate of TPO-1/PP or TPO-1/ABS was removed from the oven and cooled to room temperature.

### 1.2 TPO-2 and PP

After the adhesive melted at 180° C. was introduced into a 2-inch square film applicator with 5 mil gap clearance, a film of adhesive of 2″ width and about 10″ length was drawn down on a silicon paper. The silicon paper was cut into 2″ long and 1″ wide or larger size with adhesive film on one end of the paper. TPO-2 foil was cut into strips that were approximately 5.5″ long and 1″ wide. Next, the assembly from bottom to top with following sequence was made: the film on silicon paper, TPO-2 (contact layer down and decorative layer up) and a weight, then put on to a hotplate with surface temperature ˜180° C. After 15 seconds, the assembly was removed from the hotplate and cooled. Careful removal of the silicon paper led to an adhesive film coated on TPO-2 foil with a coating weight 60-80 gsm (gram per square meter).

The adhesive pre-coated TPO-2 foil was put under an IR heater (Chromalox CPL-0612) for 25 seconds so that adhesive surface reached 140° C. or above. Immediately a PP substrate (4″×1″×⅛″ size) was placed on top of adhesive. The laminate of PP/TPO-2 was removed from the IR heating area and a weight of 2 Kg was applied.

### 2. Shear Adhesion Failure Temperature (SAFT)

### 2.1 PP and PP, 1 kg SAFT

Shear Adhesion Failure Temperature (SAFT) was tested with two PP substrates (size 2″×1″) bonded with the adhesive. The adhesive was melted at 180-200° C. for at least 20 minutes, then applied to one of surface of PP substrate with a laboratory spatula. Immediately another PP substrate was placed on top of the adhesive with a gentle pressure to make sure 1″×1″ of bond area. A 1 Kg weight was placed on top of the bond area for at least one hour. Adhesive thickness was 0.5-0.7 mm. After cooling, the excess adhesive was removed with a knife.

SAFT temperature measurement followed ASTM D4498-07 “Standard Test Method for Heat-Fail Temperature in Shear of hot Melt Adhesives.” After conditioning at room temperature for at least 24 hours, specimens were placed in a programmable oven with Cheminstruments 30-Bank tester (West Chester Township, OH). The static load was 1 Kg. The heating program was set to run from 20° C. to 150° C. at a ramp rate of 0.5° C./minute. The program recorded the time when the bonding failed (the weight dropped) and converted to the bonding failure temperature. A total of five specimens were tested and the average reported.

### 2.2 Birch Wood and Birch Wood, 500 g SAFT

The procedure was the same with PP/PP bonding except using birch wood/birch wood substrates. A 500 grams static load was used for measurement.

### 2.3 Kraft Paper and Kraft Paper, 500 g (Packaging SAFT)

SAFT values were obtained by following an internal procedure for sample preparation and ASTM D4498-07 “Standard Test Method for Heat-Fail Temperature in Shear of hot Melt Adhesives” for temperature measurement. Two pieces of approximately 6″ wide×14″ long Kraft paper were placed on the working surface with the inside of the Kraft paper roll facing up. An 8″ wide×14″ long bonding template with a 1″ wide×12″ long opening was placed on top of one piece of Kraft paper and held template in place. The adhesive was melted at 180-200° C. for at least 20 minutes, and an approximately ¼″ wide bead of adhesive was decanted onto the Kraft paper in the opening of the template. The second piece of Kraft was placed inside-surface down on top of the adhesive. A 4.5 lb hand roller was used to make two passes over the bond line. The bonded Kraft paper was cut into 1″ wide strips, and the strips were conditioned for 24 hours in a constant temperature and humidity (CTH) room before testing. Standard CTH conditions are 70° F.+/−3° F. (21° C.+/−2° C.) and 50% (+/−5%) relative humidity.

The substrate was 40 lb virgin Kraft paper. The adhesive thickness was approximately 15-20 mil, and the bonded area was 1″×1″. A static load of 500 g was used in a programmable oven with Cheminstruments 30-Bank tester with a heating rate of 0.5° C./minute, in accordance with ASTM D4498.

### 3. 180 Degree Peel Strength

180 degree peel strength of laminate PP/TPO or ABS/TPO (TPO-1 or TPO-2) was measured on an MTS Criterion Model 43 Electromechanical Universal Test System at a speed of 300 mm/min. The bonding was allowed to age for at least 24 hours prior to the peel strength determination. The substrate size was 4″×1″. After each measurement, the peeled specimen was observed and its failure mode was recorded, which included cohesive failure (Coh), adhesive failure (Adh), mixture of adhesive and cohesive failure (A+C), adhesion failure to foil (AFF), adhesion failure to substrate (AFS) and TPO foil failure (FF).

When 180 degree peel strength was tested at 90° C. or 120° C., the aged specimen was pulled off using an MTS tester located within a thermal chamber with corresponding temperature. The specimen stayed within this chamber for 5 minutes prior to the measurement.

### 4. Thermal Creep Test

### 4.1 Laminate of PP and TPO-2

Lamination of PP and TPO-2 was same as with 180 degree peel strength, with bonding length of about two inches (50 mm). After bonding, the laminate PP/TPO-2 with size 4″×1″ and bonding area 2″×1″ on one end of PP was stayed at room temperature for 24 hours or more. Then a weight of 100 gram was attached to TPO foil so that the TPO and substrate PP became an angle of 90° when the laminate was tested. The laminate was placed in an oven at preset temperature for 24 hours. After 24 hours the TPO peel-off distance from PP was measured and recorded as a creep length. Triplicate specimens were tested, pass was indicated if average creep length was not more than 5 mm.

### 4.2 Laminate of Veneer Paper and MDF Wood Board

An adhesive film was prepared using a 6″×6″ PET frame with thickness of 5 mil, which was under a Carver press with applied pressure of 0 psi and kept at 193° C. for 1.5 minutes. After cooling down, the adhesive film was cut into a 1″×4″ strip and placed onto a 2″×6″ MDF board. A 1″×4.5″ strip of Tecofoil™ was laid on top of the adhesive strip, and a metal plate was placed on top of the Tecofoil. The assembled specimen was placed in the Carver press and pressed with 0 psi at 193° C. until the adhesive strip was melted and the MDF and Tecofoil were laminated together.

After the specimen rested for 24 hours, it was fixed in a testing bracket, and a 10-gram or a 40-gram weight was attached to the Tecofoil tail to form a 90-degree angle between the MDF and Tecofoil tail/weight. The testing assembly was then placed into an oven at the desired starting temperature. The oven temperature was raised by 10° C. per hour. When the delaminated distance of Tecofoil from MDF reached 7 cm, the temperature was recorded as the specimen failure temperature. Triplicate specimens were tested, and average failure temperature was reported.

### 5. Dead Load Test

Dead load test specimen was made according to General Motors specification GM 9986384 (purchased specification). Two polypropylene (PP-1) cubes with 1″×1″×1″ size and a small hole in the middle were bonded together by applying adhesive on one of the cubes then mating to another. A 1 Kg weight was placed on top of the bonded pieces until they came to room temperature. A total of 3 specimens were made with adhesive thickness 0.5-0.7 mm.

The specimens were hung on the rack of an oven with a weight attached. The weight was predetermined with 200 g, 300 g or 500 g, while the oven temperature was selected at 110° C., 120° C. or 130° C. Pass was recorded if no bonding failed after 24 hours.

### 6. Weathering or Climatized Test

The climatized test was selected according to BMW PR308.2 “Climatic test for bonded joints and composite materials on trim parts”. The Test was performed within an Espec BTX-475 Temperature and Humidity Chamber (ESPEC North America, Inc., Hudsonville, MI, USA). The test was 20 cycles, and the duration of one cycle was 12 hours. Each test cycle is consisted of the following sequence: (a) heating up from 23° C. with 20% relative humidity (RH) in 1 hour; (b) in 90° C. with 80% RH for 4 hours; (c) cooling and dehumidifying in 1 hour; (d) in 23° C. with 20% RH for 1 hour; (e) in −30° C. for 4 hours; (f) heating up to 23° C. with 20% RH in 1 hour.

### 7. Lap Shear Strength Test

The bonding procedure was as described above for SAFT birch wood lamination except substrate size was 4″×1″ and bonding area was 1″×0.5″. The strength was measured on an MTS Criterion Model 43 Electromechanical Universal Test System at a speed of 12.7 mm/min. A minimum of five specimens of each sample were tested and the average values were reported.

### 8. Packaging Cardboard Fiber Tear Test

Samples for adhesion testing were prepared by applying a bead of 350° F. (177° C.) adhesive to the bonding surface of corrugated cardboard and immediately bringing a piece of the interior surface of corrugated cardboard into firm contact; the cardboard flutes of the two substrates were perpendicular. Samples were conditioned at room temperature for a minimum of 4 hours before testing, or samples were conditioned at room temperature overnight and then conditioned at 60° C. for 4 h+0.5 minutes to standardize any migration of components that might affect adhesion performance. The bonded cardboard substrates were pulled apart by hand at room temperature or immediately after removal from the conditioning oven. Substrates were examined visually, and the percent of fiber tear estimated to the nearest 5%. At least three samples were tested.

Table 5 lists the Inventive propylene-ethylene copolymers used in the inventive compositions that were formulated and tested for application performance, including the convenience family designation for the inventive copolymers from Table 1A and Table 1B: (1) High viscosity, high tensile and high RBSP polymers, (2) medium viscosity, high tensile and high RBSP polymers (3) Ultra-high viscosity and high RBSP polymers and (4) low viscosity and high RBSP polymers. Table 6 lists the properties of Comparative polyolefinic polymers that were tested with a corresponding polymer family designation based only on the viscosity of the commercially available comparative polymers tested.

Inventive propylene-ethylene copolymers in family 1 are preferred for hygiene adhesives; propylene-ethylene copolymers in family 2 and family 3 are preferred for lamination, wood working, and edge banding adhesives. Of particular note are inventive propylene-ethylene copolymers in family 4 Inventive Examples 22, 23 and 24 with lower viscosity (3,000 to 6,000 cp) and high RBSP that were surprisingly useful for packaging adhesives. Table 5C also shows three commercial polyolefin polymers used as comparative examples.

TABLE 5

| | Inventive | | |
|---|---|---|---|
| | copolymer family 1, | Viscosity@190° | |
| Example | 2, 3, or 4 | C., cP | RBSP, ° C. |
| Inv Ex 22 | 4 | 2,950 | 146 |
| Inv Ex 23 | 4 | 5,608 | 147 |
| Inv Ex 8 | 4 | 6225 | 144 |
| Inv Ex 1 | 1 | 26830 | 145 |
| Inv Ex 7 | 3 | 46700 | 144 |
| Inv Ex 4 | 1 | 22280 | 150 |
| Inv Ex 5 | 1 | 17850 | 146 |
| Inv Ex 9 | 1 | 17230 | 144 |
| Inv Ex 6 | 1 | 15870 | 138 |
| Inv Ex 10 | 1 | 22230 | 148 |
| Inv Ex 11 | 2 | 13480 | 141 |
| Inv Ex 12 | 1 | 19,920 | 142 |
| Inv Ex 13 | 1 | 25830 | 145 |
| Inv Ex 14 | 2 | 9,500 | 145 |
| Inv Ex 2 | 1 | 21,600 | 145 |
| Inv Ex 15 | 2 | 8,725 | 146 |
| Inv Ex 16 | 1 | 23,280 | 147 |
| Inv Ex 17 | 2 | 7,928 | 144 |
| Inv Ex 18 | 1 | 21700 | 146 |
| Inv Ex 19 | 1 | 22650 | 143 |
| Inv Ex 20 | 1 | 20350 | 145 |
| Inv Ex 21 | 1 | 18000 | 143 |
| Inv Ex 3 | 1 | 15730 | 158 |
| Comp Ex 7 | Viscosity like 1 | 25000 | 161 |
| Comp Ex 8 | Viscosity like 2 | 8000 | 118 |
| Comp Ex 9 | Viscosity like 2 | 8000 | 157 |

TABLE 6
Properties of Commercially Available
Comparative Polymer Examples

| | Comp | Comp | Comp |
|---|---|---|---|
| | Ex 7 | Ex 8 | Ex 9 |
| Inventive copolymer family | Viscosity | Viscosity | Viscosity |
| 1, 2, 3, or 4 | like 1 | like 2 | like 2 |
| Viscosity@190° C., cP | 25,000 | 8,000 | 8,000 |
| RBSP, ° C. | 161 | 118 | 157 |
| Needle Penetration, 0.1 mm | 22 | 5 | 10 |
| Heat of crystallization (HTc, | 11 | 16 | 23 |
| 20° C./min cooling rate, J/g) | | | |
| Heat of fusion (HTf, 20° C./min, | Not tested | Not tested | Not tested |
| J/g) | | | |
| Ethylene wt. % NMR calc. | 15 | 11 | 5 |
| Triad tacticity mm content % | Not tested | Not tested | 55 |
| Tensile strength, MPa | 1 | 7 | 3 |
| Elongation, % | 550 | 80 | 470 |

### Inventive Examples 24-43 and Comparative Examples 10-12: Comparison of Polymers in Standard Composition

All Examples were prepared as previously described under “Preparation of hot melt adhesives” in the experimental section. Example compositions are given in weight percent (wt %) based on the weight of the total composition. The amount of antioxidant added was based on the total weight of the other ingredients.

Tables 7A, 7B, and 7C give the performance of the Inventive propylene-ethylene copolymers and Comparative polymers in a typical formulation containing 70 wt % polymer with the same kind and same amount of tackifier resin, wax, and antioxidant. Inventive Examples exhibited high softening point of 142 to 151° C., high tensile strength ranging from 3 MPa to 7 MPa, and high elongation (450-780%), except Inventive Examples 3 and 4 that comprise a lower elongation polymer.

The hot-melt adhesive compositions Inventive Examples 24 to 43 demonstrated strong 180 degree peel strength tested at 25° C., indicating sufficient adhesion capabilities to bond substrates polypropylene and TPO-1, which are frequently used in automotive components. The shear adhesion failure temperatures (SAFT) as measured by ASTM D4498 were a surprising 124° C. or higher, compared to Comparative Example 7 or 8 (116° C. and 95° C.), illustrating that the inventive polymers and adhesive compositions have sufficient heat resistance at elevated temperatures for use in automotive interior components and other applications that require elevated heat resistance.

Inventive Examples 25-43 were prepared using Inventive polymers from Family (1) and can be compared to Comparative Example 10 that was prepared using a commercially available polymer in the same viscosity range.

The Inventive Examples comprised polymers with ring and ball softening points of 138-158° C., and surprisingly the formulated compositions had RBSP 142-151° C., with a reduction in RBSP of 7° C. or less, compared to the starting polymer. In contrast, comparative Example 10 comprising a polymer with RBSP 161° C. resulting in a formulated composition with RBSP 150° C., with a reduction in RBSP of 11° C. Comparing Inventive Examples 25-43 to Comparative Example 10, the RBSP of the compositions are maintained, allowing the Inventive Examples to be used in place of the Comparative example when an RBSP has been specified for a product while also allowing improvement in the composition properties as discussed below.

While maintaining RBSP similar to the Comparative Example 10, the Inventive Examples 25-43 had viscosity at 190° C. from about 6800 cP to about 12500 cP, as much as a surprising 57% lower than Comparative Example 10, allowing the possibility of better processing, lower add-on, or lower application temperature, among other commercial benefits. Surprisingly, Inventive Examples 25-43 all had SAFT values, measured PP-PP as described previously, from about 9 to about 28% greater than Comparative Example 10, with SAFT values ranging from about 125° C. to about 150° C.

Inventive Examples maintained or had greater 180 degree peel strength at 25° C. between PP and TPO-1 foil substrates, with Inventive Example 43 having a surprising 91% greater peel strength than the Comparative Example 10, with peel values as high as about 80 N/25 mm at 25° C. on the specified substrates and test conditions. Unexpectedly, the Inventive Examples had peel strengths as much as 188% greater (Inventive Example 40) than Comparative Example 10, with peel values as high as about 5 N/25 mm at 90° C.

Inventive Examples 25-43 also had from about 42% greater to about 250% greater tensile than the comparative example; some Inventive Examples simultaneously had comparable elongation at break, where the value is less than 20% below the elongation at break of the Comparative Example.

Inventive Examples 32, 35, 37 and 38 were prepared using Inventive polymers from Family (2) and can be compared to Comparative Examples 11 and 12 that were each prepared using commercially available polymers in the same viscosity range.

For Family (2), there was not a difference in RBSP shift polymer to formulated composition.

Inventive Examples 32, 35, 37, and 38 have a surprising 26-30% higher RBSP, about 255 to about 400% greater elongation at break, and about 30% to about 45% than Comparative Example 11. Inventive Examples 35, 37 and 38 surprisingly simultaneously have from about 69% to about 26% higher 180 degree peel strength at 90° C., PP/TPO-1, demonstrating improved performance in high heat environments. Additionally, Inventive Examples 35, 37 and 38 also unexpectedly and simultaneously maintained comparable viscosity at 190° C. and comparable 180 degree peel strength at 25° C., PP/TPO-1, compared to Comparative Example 11

Inventive Examples 35, 37 and 38 have similar viscosity to Comparative Example 12 but unexpectedly had about 25% to about 50% higher tensile. Inventive Examples 37 and 38 also have 35-84% higher 180 degree peel strength at 90° C., PP/TPO-1 compared to Comparative Example 12, demonstrating improved performance in high heat environments.

TABLE 7A

| Composition | Inv | Inv | Inv | Inv | Inv | Inv | Inv | Inv | Inv | Inv | Inv |
|---|---|---|---|---|---|---|---|---|---|---|---|
| Example Number | Ex 24 | Ex 25 | Ex 26 | Ex 27 | Ex 28 | Ex 29 | Ex 30 | Ex 31 | Ex 32 | Ex 33 | Ex 34 |
| Ingredients | | | | | | | | | | | |
| Polymer used | Inv | Inv | Inv | Inv | Inv | Inv | Inv | Inv | Inv | Inv | Inv |
| | Ex 8 | Ex 1 | Ex 7 | Ex 4 | Ex 5 | Ex 9 | Ex 6 | Ex 10 | Ex 11 | Ex 12 | Ex 13 |
| Polymer | 70 | 70 | 70 | 70 | 70 | 70 | 70 | 70 | 70 | 70 | 70 |
| Eastotac ™ H-130R | 25 | 25 | 25 | 25 | 25 | 25 | 25 | 25 | 25 | 25 | 25 |
| Epolene ™ E43 | 5 | 5 | 5 | 5 | 5 | 5 | 5 | 5 | 5 | 5 | 5 |
| Irganox ™ 1010 | 0.2 | 0.2 | 0.2 | 0.2 | 0.2 | 0.2 | 0.2 | 0.2 | 0.2 | 0.2 | 0.2 |
| Properties | | | | | | | | | | | |
| Viscosity at | 4,450 | 11,180 | 20,200 | 10,190 | 8,800 | 8,800 | 6,880 | 10,880 | 6,320 | 10,400 | 12,300 |
| 190° C., cP | | | | | | | | | | | |
| RBSP, ° C. | 143 | 144 | 144 | 146 | 144 | 143 | 142 | 146 | 143 | 143 | 144 |
| Tensile strength, MPa | 3 | 7 | 7 | 7 | 6 | 5 | 3 | 5 | 3 | 5 | 6 |
| Elongation, % | 600 | 530 | 570 | 190 | 450 | 530 | 6610 | 570 | 780 | 620 | 490 |
| 180 degree peel | 56 | 46 | 59 | 42 | 46 | 37 | 47 | 47 | 45 | 49 | 64 |
| strength at 25° C., | | | | | | | | | | | |
| PP/TPO-1, N/25 mm | | | | | | | | | | | |
| 180 degree peel | 1.2 | 3.3 | 3.5 | 1.4 | 1.9 | 1.8 | 0.7 | 2.3 | 0.3 | 1.3 | 4.1 |
| strength at 90° C., | | | | | | | | | | | |
| PP/TPO-1, N/25 mm, | | | | | | | | | | | |
| SAFT, PP/PP, ° C. | 133 | 144 | 144 | 149 | 146 | 138 | 127 | 145 | 124 | 134 | 141 |

TABLE 7B

| Composition | Inv | Inv | Inv | Inv | Inv | Inv | Inv | Inv | Inv | Inv | Comp | Comp | Comp |
|---|---|---|---|---|---|---|---|---|---|---|---|---|---|
| Example Number | Ex 35 | Ex 36 | Ex 37 | Ex 38 | Ex 39 | Ex 40 | Ex 41 | Ex 42 | Ex 43 | Ex. 97 | Ex 10 | Ex 11 | Ex 12 |
| Ingredients | | | | | | | | | | | | | |
| Polymer used | Inv | Inv | Inv | Inv | Inv | Inv | Inv | Inv | Inv | Inv | Comp | Comp | Comp |
| | Ex 14 | Ex 2 | Ex 15 | Ex 16 | Ex 17 | Ex 18 | Ex 19 | Ex 20 | Ex 21 | Ex. 3 | Ex 7 | Ex 8 | Ex 9 |
| Polymer | 70 | 70 | 70 | 70 | 70 | 70.0 | 70.0 | 70.0 | 70.0 | 70 | 70 | 70 | 70 |
| Eastotac ™ H-130R | 25 | 25 | 25 | 25 | 25 | 25 | 25 | 25 | 25 | 25 | 25 | 25 | 25 |
| Epolene ™ E43 | 5 | 5 | 5 | 5 | 5 | 5 | 5 | 5 | 5 | 5 | 5 | 5 | 5 |
| Irganox ™ 1010 | 0.2 | 0.2 | 0.2 | 0.2 | 0.2 | 0.2 | 0.2 | 0.2 | 0.2 | 0.2 | 0.2 | 0.2 | 0.2 |
| Properties | | | | | | | | | | | | | |
| Viscosity at | 4,390 | 9,550 | 4,420 | 10250 | 4,190 | 11220 | 10420 | 9,750 | 8,690 | 7530 | 15920 | 4,750 | 3,905 |
| 190° C., cP | | | | | | | | | | | | | |
| RBSP, ° C. | 144 | 144 | 148 | 144 | 144 | 147 | 144 | 144 | 144 | 152 | 150 | 114 | 151 |
| Tensile strength, MPa | 4 | 5 | 4 | 6 | 3 | 6 | 5 | 5 | 5 | 4 | 2 | 4 | 3 |
| Elongation, % | 530 | 630 | 670 | 460 | 730 | 650 | 690 | 530 | 630 | 170 | 800 | 150 | 700 |
| 180 degree peel | 53 | 60 | 46 | 73 | 52 | 66 | 62 | 72 | 76 | 64 | 40 | 55 | 66 |
| strength at 25° C., | | | | | | | | | | | | | |
| PP/TPO-1, N/25 mm | | | | | | | | | | | | | |
| 180 degree peel | 5.7 | 4.0 | 2.7 | 1.7 | 4.2 | 4.6 | 4.1 | 1.2 | 3.9 | 1.2 | 1.6 | 1.6 | 3.1 |
| strength at 90° C., | | | | | | | | | | | | | |
| PP/TPO-1, N/25 mm, | | | | | | | | | | | | | |
| SAFT, PP/PP, ° C. | 137 | 139 | 138 | 140 | 136 | 142 | 140 | 142 | 138 | 149 | 116 | 95 | 144 |

TABLE 7C

| | Composition Example No. | | | | | | | | | | | | |
|---|---|---|---|---|---|---|---|---|---|---|---|---|---|
| | Inv | Inv | Inv | Inv | Inv | Inv | Inv | Inv | Inv | Inv | Inv | Inv | Inv |
| | Ex 113 | Ex 114 | Ex 115 | Ex 116 | Ex 117 | Ex 118 | Ex 119 | Ex 120 | Ex 121 | Ex 122 | Ex 123 | Ex 124 | Ex 125 |
| Ingredients | | | | | | | | | | | | | |
| Polymer | Inv | Inv | Inv | Inv | Inv | Inv | Inv | Inv | Inv | Inv | Inv | Inv | Inv |
| used | Ex 98 | Ex 99 | Ex 100 | Ex 101 | Ex 102 | Ex 103 | Ex 104 | Ex 105 | Ex 106 | Ex 100 | Ex 100 | Ex 105 | Ex 105 |
| Polymer | 70 | 70 | 70 | 70 | 70 | 70 | 70 | 70 | 70 | 60 | 80 | 60 | 80 |
| Easotac ™H- | 25 | 25 | 25 | 25 | 25 | 25 | 25 | 25 | 25 | 35 | 15 | 35 | 15 |
| 130R | | | | | | | | | | | | | |
| Epolene ™E43 | 5 | 5 | 5 | 5 | 5 | 5 | 5 | 5 | 5 | 5 | 5 | 5 | 5 |
| Irganox ™1010 | 0.2 | 0.2 | 0.2 | 0.2 | 0.2 | 0.2 | 0.2 | 0.2 | 0.2 | 0.2 | 0.2 | 0.2 | 0.2 |
| Properties | | | | | | | | | | | | | |
| Viscosity at | 6390 | 8740 | 11560 | 11730 | 11200 | 11550 | 14420 | 13550 | 12780 | 8300 | 16020 | 11800 | 20610 |
| 190° C. (cP) | | | | | | | | | | | | | |
| RBSP (° C.) | 142 | 142 | 143 | 144 | 144 | 143 | 143 | 144 | 143 | 143 | 145 | 143 | 146 |
| Tensile | 7 | 9 | 8 | 7 | 8 | 12 | 9 | 8 | 10 | 6 | 8 | NT | NT |
| strength at | | | | | | | | | | | | | |
| break (MPa) | | | | | | | | | | | | | |
| Elongation at | 520 | 560 | 310 | 600 | 600 | 570 | 560 | 440 | 540 | 170 | 430 | NT | NT |
| break %) | | | | | | | | | | | | | |
| Open time, | NT | NT | 15 | NT | NT | NT | NT | NT | NT | NT | NT | NT | NT |
| 0.1 mm (sec.) | | | | | | | | | | | | | |
| Open time, | NT | NT | 35-40 | NT | NT | 40-45 | NT | 30-35 | NT | NT | NT | NT | NT |
| 0.5 mm (sec.) | | | | | | | | | | | | | |
| SAFT, | 128 | 134 | 144 | 135 | 138 | 138 | 139 | 145 | 140 | 138 | 145 | NT | NT |
| PP/PP, ° C. | | | | | | | | | | | | | |

NT = not tested

### 2. High Heat Resistance

A selection of previously prepared compositions are shown In Table 8 with viscosity at 190° C. 9000-16000 cp and around 4000 cp. The open time of the Inventive Examples were over 40 seconds, which is an acceptable working time for many assembly, automotive and woodworking applications. These open times can be further optimized by those skilled in the art, and the effect of varying the wax used in the composition is illustrated later in this disclosure.

In addition to forming acceptable initial bonds, it is desirable that the bonds are maintained after exposure to the outside environment, as simulated by testing known in the art as weathering or climatized testing. The results in Table 8 are discussed below, illustrating the surprising retention after climatized testing of SAFT and peel strength for the laminates PP/PTO-1 and ABS/TPO-1 for the Inventive compositions.

Inventive Examples 25, 36, 38, 40 and 41 were prepared using Inventive polymers from Family (1) and can be compared to Comparative Example 10 that was prepared using a polymer in the same viscosity range. All the Inventive Examples had about 20-25% higher PP/PP SAFT temperature than Comparative Example 10. about 51-86% higher PP/TPO-1 180 degree peel strength at 25° C., and about 31% higher ABS/TPO-1 180 degree peel strength at 25° C. showing superior retention of heat resistance properties after weathering compared to Comparative Example 10.

As is typical, all Examples had lower SAFT and peel values after the weathering/climatized testing cycles; however, after the climatized test Inventive Example 36 had an unexpected about 27% higher PP/PP SAFT temperature, and about 27% higher PP/TPO-1 180 degree peel strength at 25° C. Inventive Examples 25, 36, 38, and 41 also unexpectedly had about 18-36% higher ABS/TPO-1 180 degree peel strength at 25° C. showing superior retention of heat resistance properties after weathering compared to Comparative Example 10.

Inventive Examples 37 and 39 were prepared using Inventive polymers from Family (2) and can be compared to Comparative Examples 11 and 12. Formulated viscosities were comparable. Inventive Examples 37 and 39 has about 45% higher SAFT, PP/PP values than Comparative Example 11. As with the Examples from polymer family (1), all Examples had lower SAFT and peel values after the weathering/climatized testing cycles. Comparative Example 11 lost about 86% of its 180 degree peel strength, PP/TPO-1 and ABS/TPO-1 at 25° C. Inventive Examples 37 and 39 and comparative Example 12 all maintained acceptable 180 degree peel strength, PP/TPO-1 and ABS/TPO-1 at 25° C. after the weathering/climatization exposure. Inventive Example 39 unexpectedly had a higher SAFT, PP/PP (about 5%) after the climatized test than Comparative Example 12, although Comparative Example 12 had a higher starting SAFT, PP/PP value.

TABLE 8

| | Inv | Inv | Inv | Inv | Inv | Comp | Inv | Inv | Comp | Comp |
|---|---|---|---|---|---|---|---|---|---|---|
| | Ex 25 | Ex 36 | Ex 38 | Ex 40 | Ex 41 | Ex 10 | Ex 37 | Ex 39 | Ex 11 | Ex 12 |
| Viscosity at 190° C., | 11,180 | 9,550 | 10,250 | 11,220 | 10,420 | 15,920 | 4,420 | 4,190 | 4,750 | 3,905 |
| cP | | | | | | | | | | |
| Open time, | 40-45 | 50-60 | 45-50 | 45-50 | 45-50 | 65-75 | 45-50 | 60-70 | 100-110 | 55-65 |
| sec.(0.50 mm) | | | | | | | | | | |
| SAFT, PP/PP, ° C. | 144 | 139 | 140 | 142 | 140 | 116 | 138 | 136 | 95 | 144 |
| After the climatized | NT | 141 | 142 | 143 | 140 | 111 | NT | 133 | 109 | 127 |
| test | | | | | | | | | | |
| 180 degree peel | 73 | 60 | 73 | 66 | 62 | 40 | 46 | 52 | 55 | 66 |
| strength at 25° C., | | | | | | | | | | |
| PP/TPO-1, N/25 mm | | | | | | | | | | |
| After the climatized | NT | 38 | NT | NT | NT | 29.6 | NT | 26 | 7.0 | 35 |
| test | | | | | | | | | | |
| 180 degree peel | 65 | 57 | 61 | 48 | 41 | 48 | 42 | 43 | 54 | 62 |
| strength at 25° C., | | | | | | | | | | |
| ABS/TPO-1, | | | | | | | | | | |
| N/25 mm | | | | | | | | | | |
| After the climatized | NT | 27 | NT | NT | NT | 21 | NT | 18 | 7.9 | 18 |
| test | | | | | | | | | | |

NT = not tested

Tables 9A and 9B show peel strengths PP/TPO-2 measured at temperature from 25° C. to 120° C. Peel strengths at 25° C. for Inventive Examples and Comparative Examples are similar because the bonding exhibited foil failure (also called foam layer failure, FF) on TPO-2 during peeling. At higher temperature, 90° C. and 120° C., most Inventive Example adhesives demonstrated peel strengths surprisingly higher than the Comparative Examples, indicating Inventive Examples maintain strong cohesive strength behavior and high heat resistant capabilities. Family (1) Inventive Examples 25, 36, 38, 40, and 41 have about 109% to about 365% higher peel at 90° C. and about 220% to about 595% higher peel values at 120° C. than Comparative Example 10. Most surprisingly and advantageously, Inventive Example 38 had foil failure at 120° C. compared to cohesive failure of the adhesive in Comparative Example 10, indicating Inventive Example 38 adhesive even had stronger strength than TPO foil at this temperature.

After exposure to weathering effects in the climatized test, Inventive Examples 38, 40 and 41 unexpectedly and advantageously exhibited foil failure for 180 degree peel strength at 90° C., PP/TPO-2 compared to cohesive failure of the adhesive in Comparative Examples 10 and 12 and commercial adhesive Comparative Example 14. This produced peel strength values from about 575% to about 660% higher than Comparative Example 10.

After exposure to weathering effects in the climatized test, Inventive Example 38 most surprisingly and advantageously exhibited foil failure for 180 degree peel strength at 120° C., PP/TPO-2 compared to cohesive failure of the adhesive in Comparative Example 10 with peel strength values about 475% higher than Comparative Example 10. Inventive Examples 40 and 41 and Comparative Examples 10, 13 and commercial adhesive Comparative Example 13 all exhibited cohesive failure; however, the 180 degree peel strength at 120° C., PP/TPO-2, of Inventive Examples 40 and 41 were about 178% to about 211% greater than the peel value of Comparative Example 10, indicating that all the Inventive Examples tested had superior heat resistance and cohesion. Unexpectedly, Inventive Example 40 had about 84% greater and about 57% greater 180 degree peel strength at 120° C., PP/TPO-2 than the commercial adhesives tested as Comparative Examples 13 and 14. The inventors found this especially surprising since the Inventive Example formulations were not optimized while commercial adhesives will be optimized.

TABLE 9A
180 degree peel strength, PP/TPO-2 at various temperatures before and after climatized testing

| 180 degree peel | Inv | Inv | Inv | Inv | Inv | Inv | Inv | Inv | Comp | Comp | Comp | Comp | Comp |
|---|---|---|---|---|---|---|---|---|---|---|---|---|---|
| strength, PP/TPO-2 | Ex 25 | Ex 36 | Ex 38 | Ex 40 | Ex 41 | Ex 37 | Ex. 97 | Ex 39 | Ex 10 | Ex 11 | Ex 12 | Ex 13 | Ex 14 |
| Before the climatized | | | | | | | | | | | | | |
| test | | | | | | | | | | | | | |
| at 25° C., N/25 mm, | 58 | 55 | 58 | 56 | 57 | 50 | 48 | 48 | 51 | 51 | 51 | 49 | 46 |
| SD = 12 | | | | | | | | | | | | | |
| Failure mode | FF | FF | FF | FF | FF | FF | FF | FF | FF | FF | FF | FF | FF |
| at 90° C., N/25 mm, | 24 | 17 | 21 | 27 | 23 | 15 | 16 | 14 | 6 | 7 | 15 | 12 | 21 |
| SD = 12 | | | | | | | | | | | | | |
| Failure mode | FF/ | FF/ | FF/ | FF/ | FF/ | FF/ | FF/ | Coh | Coh | Coh | FF/ | Coh | FF/ |
| | Coh | Coh | Coh | Coh | Coh | Coh | Coh | | | | Coh | | Coh |
| at 120° C., N/25 mm, | 8.6 | 6.6 | 10.4 | 9.4 | 4.8 | 4.5 | 7.9 | 4.0 | 1.5 | 0 | 4.4 | 5.1 | 6 |
| SD = 0.6 | | | | | | | | | | | | | |
| Failure mode | Coh | Adh/ | FF/ | Coh | Coh | Adh/ | FF/ | Adh/ | Coh | melted | Adh/ | Coh | Coh |
| | | Coh | Coh | | | Coh | Coh | Coh | | | Coh | | |
| After the climatized test | | | | | | | | | | | | | |
| at 25° C., N/25 mm, | NT | NT | 38 | 43 | 50 | NT | NT | NT | 40 | NT | 39 | 40 | 44 |
| SD = 3 | | | | | | | | | | | | | |
| Failure mode | | | FF | FF | FF | | | | FF | | FF | FF | FF |
| at 90° C., N/25 mm, | NT | NT | 27 | 25 | 24 | NT | NT | NT | 4 | NT | 8 | 13 | 11 |
| SD = 1.4 | | | | | | | | | | | | | |
| Failure mode | | | FF | FF | FF/ | | | | Coh | | Coh | FF/ | Coh |
| | | | | | Coh | | | | | | | Coh | |
| at 120° C., N/25 mm, | NT | NT | 10.3 | 5.6 | 5 | NT | NT | NT | 1.8 | NT | 3.2 | 4.0 | NT |
| SD = 0.8 | | | | | | | | | | | | | |
| Failure mode | | | FF/ | Coh | Coh | | | | Coh | | Coh | Coh | |
| | | | Coh | | | | | | | | | | |

FF = foil failure (in foam layer);
coh = cohesive failure of adhesive composition;
adh = adhesive failure of adhesive composition;
NT = not tested

TABLE 9B
180 degree peel strength, PP/TPO-2 at various temperatures of adhesive compositions
comprising inventive copolymers produced with Gen 5/6 catalysts

| 180 degree | | | | | | | | | |
|---|---|---|---|---|---|---|---|---|---|
| peel strength | Inv | Inv | Inv | Inv | Inv | Inv | Inv | Inv | Inv |
| on PP/TPO-2 | Ex 113 | Ex 114 | Ex 115 | Ex 116 | Ex 117 | Ex 118 | Ex 119 | Ex 120 | Ex 121 |
| at 25° C., | 47 | 48 | 48 | 44 | 44 | 47 | 46 | 48 | 47 |
| N/25 mm, | | | | | | | | | |
| SD = 3 | | | | | | | | | |
| Failure mode | FF | FF | FF | FF | FF | FF | FF | FF | FF |
| at 90° C., | 19 | 22 | 25 | 20 | 18 | 21 | 18 | 25 | 25 |
| N/25 mm, | | | | | | | | | |
| SD = 3 | | | | | | | | | |
| Failure mode | FF/Coh | FF/Coh | FF/Coh | FF/Coh | FF/Coh | FF/Coh | FF/Coh | FF/Coh | FF/Coh |
| at 120° C., | 5.5 | 8.7 | 8.6 | 5.4 | 4.4 | 6.2 | 7.3 | 10.4 | 6.9 |
| N/25 mm, | | | | | | | | | |
| SD = 0.8 | | | | | | | | | |
| Failure mode | Coh | Coh | Coh | Coh | Coh | Coh | Coh | Coh | Coh |

FF = foil failure (in foam layer);
coh = cohesive failure of adhesive composition;
adh = adhesive failure of adhesive composition;
NT = not tested

The measurement of Thermal Creep is a critical test for automotive components, and reactive crosslinking adhesives are used when heat resistance of 120° C. is required. Tables 10A and 10B show the unexpected result that the inventive heat resistant copolymers and hot melt compositions can provide thermal creep resistance at 120° C. without crosslinking.

Measures of thermal resistance by Thermal creep and dead load tests are listed in Tables 10A and 10B. For the Thermal Creep test, the laminate was placed in an oven at preset temperature for 24 hours. A pass was indicated if the average TPO peel-off distance from PP (creep length) was not more than 5 mm (less than or equal to 5 mm). All Inventive Examples tested comprising polymers from families (1) and (2) passed thermal creep at 90° C., while all Comparative Examples comprising polymers from families (1) and (2) failed thermal creep testing at 90° C. The two commercial adhesives Comparative Example 13 and Comparative Example 14 both passed thermal creep at 90° C.

The two commercial adhesives Comparative Example 13 and Comparative Example 14 both failed thermal creep at 100° C.; however, unexpectedly Inventive Examples 25, 36, 38, 40 and 41 passed at 100° C.; Inventive Examples 25, 38, 40 and 41 passed at 110° C., and most surprisingly, Inventive Examples 25, 38, and 40 passed at 120° C. Passing a 120° C. thermal creep is a “game changer” since it can be used to replace reactive adhesives that crosslink. Some Inventive Example adhesive compositions passed thermal creep temperature as high as 110° C. even 120° C., demonstrating strong resistance against higher temperature. Unexpectedly, a positive correlation was seen between adhesive thermal creep failure temperature and the peel strength at this temperature. It means greater peel strength at the testing temperature would have a higher possibility to pass thermal creep at same temperature.

For Dead Load testing, Inventive Examples 25, 36, 38, 40 and 41 (family 1 polymers), Inventive Examples 37 and 39 (family 2 polymers) and Comparative Example 12 passed 110° C. with 200 g weight. Comparative Examples 10 and 11 both failed the dead load test at 110° C. with 200 g weight.

Inventive Examples 36, 38, 40, and 41 (family 1 polymers), Inventive Examples 37 and 39 (family 2 polymers) unexpectedly survived the 1-day dead load test at 130° C. with a 300 g weight. Surprisingly Inventive Examples 36 and 40 passed 110° C. with 500 g weight, and the inventors were most surprised that Inventive Example 41 even passed 120° C. with 500 g, exhibiting again the excellent heat resistant performance of compositions comprising the inventive polymers previously disclosed.

TABLE 10A

| | Inv | Inv | Inv | Inv | Inv | Inv | Inv | Inv | Comp | Comp | Comp | Comp | Comp |
|---|---|---|---|---|---|---|---|---|---|---|---|---|---|
| | Ex 25 | Ex 36 | Ex 38 | Ex 40 | Ex 41 | Ex 37 | Ex 39 | Ex. 97 | Ex 10 | Ex 11 | Ex 12 | Ex 13 | Ex 14 |
| Thermal Creep, | | | | | | | | | | | | | |
| PP/TPO-2 | | | | | | | | | | | | | |
| at 90° C. | Pass | Pass | Pass | Pass | Pass | Pass | Pass | Pass | FAIL | FAIL | FAIL | Pass | Pass |
| at 100° C. | Pass | Pass | Pass | Pass | Pass | FAIL | FAIL | Pass | | | | FAIL | FAIL |
| at 110° C. | Pass | FAIL | Pass | Pass | Pass | | | Pass | | | | | |
| at 120° C. | Pass | | Pass | Pass | FAIL | | | Pass | | | | | |
| Dead Load test, PP- | | | | | | | | | | | | | |
| 1/PP-1, 1 day | | | | | | | | | | | | | |
| 200 g at 110° C. | Pass | Pass | Pass | Pass | Pass | Pass | Pass | Pass | FAIL | FAIL | Pass | Pass | Pass |
| 300 g at 110° C. | FAIL | Pass | Pass | Pass | Pass | Pass | Pass | Pass | | | Pass | Pass | Pass |
| 300 g at 120° C. | | Pass | Pass | Pass | Pass | Pass | Pass | FAIL | | | FAIL | FAIL | Pass |
| 300 g at 130° C. | | Pass | Pass | Pass | Pass | Pass | Pass | | | | | | Pass |
| 500 g at 110° C. | | Pass | FAIL | Pass | Pass | FAIL | FAIL | | | | | | FAIL |
| 500 g at 120° C. | | FAIL | | FAIL | Pass | | | | | | | | |

TABLE 10B

| | Inv | Inv | Inv | Inv | Inv | Inv | Inv | Inv | Inv |
|---|---|---|---|---|---|---|---|---|---|
| | Ex 113 | Ex 114 | Ex 115 | Ex 116 | Ex 117 | Ex 118 | Ex 119 | Ex 120 | Ex 121 |
| Thermal creep | | | | | | | | | |
| PP/TPO-2 | | | | | | | | | |
| at 100° C. | Pass | Pass | Pass | Pass | Pass | Pass | Pass | Pass | Pass |
| at 110° C. | Fail | Pass | Pass | Fail | Fail | Fail | Fail | Pass | Pass |
| at 120° C. | | Fail | Fail | | | | | Pass | Fail |
| Dead Load test, | | | | | | | | | |
| PP-1/PP-1, 24 hrs | | | | | | | | | |
| 200 g at 110° C. | NT | NT | Pass | Fail | NT | Pass | Fail | Pass | Pass |
| 300 g at 120° C. | | | Fail | | | Fail | | Pass | Pass |
| 300 g at 130° C. | | | | | | | | Pass | Pass |
| 500 g at 110° C. | | | | | | | | Pass | Pass |
| 500 g at 120° C. | | | | | | | | Pass | Pass |

NT = not tested

### 3. Formula Variables

### 3.1 Tackifier Resins

Inventive Example adhesives with same copolymers but different tackifier resins were evaluated and shown in Table 11. The listed ingredients are provided in weight percentages, based on the total weight of the adhesive. The amount of antioxidant added was based on the total weight of the other ingredients. All adhesives showed strong peel strength even at higher temperature, indicating inventive copolymers had very good compatibility with broad range of hydrogenated C5, hydrogenated PMR, and hydrogenated C8/C9 tackifier resins.

TABLE 11

| | Inv Ex | Inv Ex | Inv Ex | Inv Ex | Inv Ex |
|---|---|---|---|---|---|
| | 44 | 45 | 46 | 47 | 48 |
| Ingredients | | | | | |
| Inv Ex 21 | 49 | 49 | 49 | 49 | 49 |
| Inv Ex 13 | 21 | 21 | 21 | 21 | 21 |
| Eastotac H-130R | 25 | | | | |
| Eastotac H-142R | | 25 | | | |
| REGALREZ 1126 | | | 25 | | |
| PLASTOLYN R1140 | | | | 25 | |
| Regalite R1125 | | | | | 25 |
| Epolene E43 | 5 | 5 | 5 | 5 | 5 |
| Irganox 1010 | 0.2 | 0.2 | 0.2 | 0.2 | 0.2 |
| Properties | | | | | |
| Viscosity at 190° | 8,650 | 9,200 | 6,350 | 6,890 | 8,370 |
| C., cP | | | | | |
| RBSP, ° C. | 143.4 | 143.6 | 142.9 | 142.8 | 143.0 |
| SAFT, PP/PP, ° C. | 145 | 136 | 136 | 137 | 137 |
| 180 degree peel | | | | | |
| strength, PP/TPO-2 | | | | | |
| at 25° C., N/25 mm | 47 | 45 | 51 | 53 | 53 |
| Failure mode | FF | FF | FF | FF | FF |
| at 90° C., N/25 mm | 16 | 20 | 19 | 20 | 21 |
| Failure mode | FF/Coh | FF/Coh | FF/Coh | FF/Coh | FF/Coh |
| at 120° C., N/25 mm | 4.9 | 5.6 | 4.3 | 4.2 | 3.8 |
| Failure mode | Adh | Coh | Adh/Coh | Coh | Coh |

FF = foil failure (in foam layer);
coh = cohesive failure of adhesive composition;
adh = adhesive failure of adhesive composition

### 3.2 Waxes and Acid Modified Tackifier Resins

In Table 12, Inventive Example adhesives with same copolymer and tackifier resin but different waxes were evaluated. The waxes included polypropylene (PP) waxes with maleic anhydride-grafted functional groups (Inventive Examples 44, 49-52) and PP waxes without any functional group (Inventive Examples 53 and 54). Wax viscosities at 190° C. ranged from 150 cp to 18,000 cp and 60,000 cp. Due to lower wax ratio in the formula, different waxes seemed to change little performance of the adhesives except Inventive Example 50, where maleic anhydride modified PP wax Eastman™ G3003 processed very high viscosity and contributed higher RBSP and stronger peel strength at 120° C.

Inventive Examples 53 and 54 contain wax that is not functionalized/maleated. The effect of the lower softening point of the waxes are seen in the lower SAFT of the compositions. Surprisingly Inventive Examples 54 maintained partial foil failure at 90° C. despite the lower softening point of the wax used, illustrating how the heat resistance of the inventive polymers in the compositions maintains the tensile strength, elongation at break, and 180-degree peel strength at 25° C. and 90° C. The variation in the wax type allows the formulator to adjust the open time (40-70 seconds), needle penetration or hardness (3.5 to 4.2 dmm), adhesive RBSP (138-152° C.), adhesive SAFT (135-148° C.), and adhesive viscosity (8300-11000 cP at 190° C.) to balance the adhesive properties as needed. These examples are simple illustrations using one additive level without varying other components, and one skilled in the art will be able to build on this knowledge.

TABLE 12

| | | Acid | | | | | | | |
|---|---|---|---|---|---|---|---|---|---|
| | | number | | | | | | | |
| | RBSP | (mg | Inv | Inv | Inv | Inv | Inv | Inv | Inv |
| | (° C.) | KOH/g) | Ex 44 | Ex 49 | Ex 50 | Ex 51 | Ex 52 | Ex 53 | Ex 54 |
| Inv Ex 21 | | | 49 | 49 | 49 | 49 | 49 | 49 | 49 |
| Inv Ex 13 | | | 21 | 21 | 21 | 21 | 21 | 21 | 21 |
| Eastotac ™ H-130R | | | 25 | 25 | 25 | 25 | 25 | 25 | 25 |
| Epolene ™ E43 | 157 Tm | 44-55 | 5 | | | | | | |
| Eastman ™ G 3015 Maleic | 156 Tm | 15 | | 5 | | | | | |
| Anhydride modified PP | | | | | | | | | |
| Eastman ™ G 3003 Maleic | 158 Tm | 9 | | | 5 | | | | |
| Anhydride modified PP | | | | | | | | | |
| Honeywell AC ™ 1325P | MDP | 18 | | | | 5 | | | |
| Propylene Maleic Anhydride | 149 | | | | | | | | |
| Copolymers | | | | | | | | | |
| Honeywell AC ™ 596P | MDP | 50 | | | | | 5 | | |
| Propylene Maleic Anhydride | 141 | | | | | | | | |
| Copolymers | | | | | | | | | |
| Epolene ™ N15 | 163 | <0.05 | | | | | | 5 | |
| Clariant Licocene ™ PP6102 | MDP | <0.05 | | | | | | | 5 |
| | 142-148 | | | | | | | | |
| Irganox 1010 | | | 0.2 | 0.2 | 0.2 | 0.2 | 0.2 | 0.2 | 0.2 |
| Properties | | | Inv Ex 44 | Inv Ex 49 | Inv Ex 50 | Inv Ex 51 | Inv Ex 52 | Inv Ex 53 | Inv Ex 54 |
| Viscosity at 190° C., cP | | | 8,650 | 10,227 | 10,912 | 9,022 | 9,010 | 9,313 | 8,317 |
| RBSP, ° C. | | | 143 | 151 | 152 | 143 | 138 | 146 | 138 |
| Needle Penetration, 0.1 mm | | | 5.0 | 5.2 | 4.0 | 4.8 | 4.8 | 3.7 | 3.5 |
| Open time, sec. (0.50 mm) | | | 50-60 | 40-50 | 40-50 | 50-60 | 40-50 | 45-55 | 60-70 |
| Tensile strength, MPa | | | 6 | 6 | 6 | 5 | 6 | 5 | 6 |
| Elongation, % | | | 554 | 526 | 518 | 446 | 576 | 449 | 529 |
| SAFT, PP/PP, ° C. | | | 145 | 146 | 148 | 145 | 139 | 146 | 135 |
| 180 degree peel strength, | | | | | | | | | |
| PP/TPO-2 | | | | | | | | | |
| at 25° C., N/25 mm | | | 51 | 53 | 49 | 52 | 53 | 49 | 52 |
| Failure mode | | | FF | FF | FF | FF | FF | FF | FF |
| at 90° C., N/25 mm | | | 19 | 16 | 17 | 21 | 16 | 19 | 14 |
| Failure mode | | | FF/C | FF/C | FF/C | FF/C | FF/C | Coh | FF/C |
| at 120° C., N/25 mm | | | 6.0 | 5.0 | 11 | 9.6 | 5.7 | 6.9 | 3.6 |
| Failure mode | | | Coh | Coh | Coh | Coh | Coh | Coh | Coh |

MDP = Mettler Drop Point, ASTM D-3954, reported on manufacturer technical data sheet; Acid number, ASTM D1386

In Table 13, the functional wax Epolene E43 was replaced by dimerized and partially dimerized rosin acid tackifier resins in adhesive formula. The rosin acids were compatible in the inventive copolymer formulation, and Inventive Example 56 with the partially dimerized rosin acid unexpectedly passed the Thermal Creep test at 100° C. The dimerized rosin acids didn't show improvement in adhesive adhesion at higher temperature compared to maleic anhydride-grafted polypropylene wax, based on thermal creep test.

TABLE 13

| | Softening | | | | |
|---|---|---|---|---|---|
| | point | Acid | Inv Ex | Inv Ex | Inv Ex |
| | (° C.) | number | 42 | 55 | 56 |
| Ingredients | | | | | |
| Inv Ex 20 | | | 70 | 70 | 70 |
| Eastotac H-130R | | | 25 | 25 | 25 |
| Epolene E43 | 157 Tm | 45 | 5 | | |
| Dymerex | 138 | 140 | | 5 | |
| Poly-Pale | 95 | 142 | | | 5 |
| Irganox 1010 | | | 0.2 | 0.2 | 0.2 |
| Properties | | | | | |
| RBSP, ° C. | | | 144 | 139 | 138 |
| Thermal Creep, | | | | | |
| PP/TPO-2 | | | | | |
| at 100° C. | | | pass | FAIL | pass |
| at 110° C. | | | pass | FAIL | FAIL |
| at 120° C. | | | FAIL | | |
| Dead Load test, | | | | | |
| PP-1/PP-1, 1 day | | | | | |
| 500 g at 110° C. | | | FAIL | FAIL | FAIL |

The influence of the amount of wax on the composition adhesive properties and performance are illustrated in Table 14. The ratio of inventive copolymer to tackifier resin was kept constant (70:25) in all formulas, the acid functionalized PP wax Epolene™ E43 amount was increased from 0 to 30 wt. % (Inventive Examples 57-60), and Epolene E43 was kept at 5 wt. % and Epolene N15, used a second and unmodified PP wax, was increased from 5 to 15 wt. % (Inventive Examples 61 and 62).

It was surprising to discover that Inventive Example 57, with no wax, maintained a 180-degree peel strength, PP/TPO-2 at 90° C. with substrate foil failure/cohesive failure, as well as passed the thermal creep test at 110° C. Up to 20 wt % maleated-PP wax improved performance and reduced open time, with 30 wt % ma-PP wax decreasing elongation. The combination of 5 wt % maleated-PP wax and 15 wt % PP wax (Inventive Example 62) shows the formulation flexibility of the inventive copolymers, allowing similar adjustment of the adhesive open time and viscosity if lower elongation can be tolerated. More wax amount in formulation reduced the open time due to PP wax crystallization during cooling of melted adhesive Increased wax amount also led to a drop in viscosity and tensile elongation while increasing softening point and SAFT.

TABLE 14

| | Inv | Inv | Inv | Inv | Inv | Inv | Inv |
|---|---|---|---|---|---|---|---|
| | Ex 57 | Ex 42 | Ex 58 | Ex 59 | Ex 60 | Ex 61 | Ex 62 |
| Ingredients | | | | | | | |
| Inv Ex 20 | 73.7 | 70 | 66.3 | 58.9 | 51.6 | 66.3 | 58.9 |
| Eastotac H-130R | 26.3 | 25 | 23.7 | 21.1 | 18.4 | 23.7 | 21.1 |
| Epolene E43 | 0 | 5 | 10 | 20 | 30 | 5 | 5 |
| Epolene N15 | | | | | | 5 | 15 |
| Irganox 1010 | 0.2 | 0.2 | 0.2 | 0.2 | 0.2 | 0.2 | 0.2 |
| Properties | | | | | | | |
| Viscosity at 190° C., | 10,185 | 9,750 | 7,963 | 6,164 | 4,423 | 7,718 | 5,756 |
| cP | | | | | | | |
| RBSP, ° C. | 139 | 144 | 147 | 149 | 151 | 148 | 152 |
| Tensile strength, | 5 | 5 | 4 | 4 | 5 | 4 | 3 |
| MPa | | | | | | | |
| Elongation, % | 601 | 533 | 192 | 126 | 29 | 251 | 45 |
| SAFT, PP/PP, ° C. | 134 | 142 | 145 | 149 | 154 | 146 | 153 |
| Open time, | 65-75 | 45-50 | 30-40 | 25-35 | 20-30 | 35-45 | 25-35 |
| sec.(0.50 mm) | | | | | | | |
| 180 degree peel | | | | | | | |
| strength, PP/TPO- | | | | | | | |
| 2 | | | | | | | |
| at 25° C., N/25 mm | 44 | 55 | 51 | 49 | 50 | 51 | 51 |
| Failure mode | FF/A | FF/A | FF/A | FF/A | FF/A | FF | FF/A |
| at 90° C., N/25 mm | 23 | 19 | 20 | 25 | 25 | 23 | 18 |
| Failure mode | FF/C | FF/C | FF/C | FF | FF | FF | FF/C |
| at 120° C., N/25 mm | 6.8 | 7.0 | 7.5 | 10.5 | 11.1 | 8.4 | 7.9 |
| Failure mode | Coh | Coh | Coh | FF/C | FF/C | FF/C | Coh |
| Thermal Creep, | | | | | | | |
| PP/TPO-2 | | | | | | | |
| at 110° C. | Pass | Pass | Pass | Pass | Pass | Pass | Pass |
| at 120° C. | Fail | Fail | Pass | Pass | Pass | Pass | Pass |
| Dead Load test, | | | | | | | |
| PP-1/PP-1, 1 day | | | | | | | |
| 200 g at 110° C. | Fail | Fail | Fail | Fail | Fail | Fail | Fai |

### 3.3 Ratio of Inventive Copolymer to Tackifier Resin

In Tables 15A, 15B, and 16 the ratio of tackifier resin to inventive copolymer was varied through the values of about 0:1, about 0.06:1, about 0.2:1, about 0.3:1, about 0.4:1, about 0.5:1, about 0.6:1, and about 0.9:1. Surprisingly, all inventive compositions with the ratio of tackifier resin to inventive copolymer below 0.6:1 maintained RBSP of about 140° C. or higher and passed thermal creep, PP/TPO-2, at 110° C. The inventors were surprised that Inventive Examples 38 and 64 passed thermal creep, PP/TPO-2 120° C., which is typically only passed by crosslinked adhesives. Most unexpectedly, Inventive Example 64 simultaneously passed thermal creep, PP/TPO-2, at 120° C. and passed Dead Load test, PP-1/PP-1, 500 g for 1 day 110° C.

TABLE 15A

| | Inv Ex | Inv Ex | Inv Ex | Inv Ex |
|---|---|---|---|---|
| | 63 | 38 | 64 | 65 |
| Ingredients | | | | |
| Inv Ex 16 | 65 | 70 | 75 | 70 |
| Eastotac H-130R | 30 | 25 | 20 | |
| Eastotac H-142R | | | | 25 |
| Epolene E43 | 5 | 5 | 5 | 5 |
| Irganox 1010 | 0.2 | 0.2 | 0.2 | 0.2 |
| Properties | | | | |
| Ratio tackifier resin: inventive | 0.5 | 0.4 | 0.3 | 0.4 |
| copolymer | | | | |
| RBSP, ° C. | 144 | 144 | 145 | 146 |
| Thermal Creep, | | | | |
| PP/TPO-2 | | | | |
| at 110° C. | pass | pass | pass | pass |
| at 120° C. | FAIL | pass | pass | FAIL |
| Dead Load test, | | | | |
| PP-1/PP-1, 1 day | | | | |
| 500 g at 110° C. | FAIL | FAIL | pass | FAIL |
| 500 g at 120° C. | | | FAIL | |

TABLE 15B

| | Composition Example No. | | | | | |
|---|---|---|---|---|---|---|
| | Inv | Inv | Inv | Inv | Inv | Inv |
| | Ex 122 | Ex 115 | Ex 123 | Ex 124 | Ex 120 | Ex 125 |
| Ingredients | | | | | | |
| Inv Ex 100 | 60 | 70 | 80 | | | |
| Inv Ex 105 | | | | 60 | 70 | 80 |
| Eastotac ™ H-130R | 35 | 25 | 15 | 35 | 25 | 15 |
| Epolene ™ E43 | 5 | 5 | 5 | 5 | 5 | 5 |
| Irganox ™ 1010 | 0.2 | 0.2 | 0.2 | 0.2 | 0.2 | 0.2 |
| Properties | | | | | | |
| SAFT, PP/PP, ° C. | 138 | 144 | 145 | NT | 145 | NT |
| 180 degree peel | | | | | | |
| strength on | | | | | | |
| PP/TPO-2 | | | | | | |
| at 25° C., N/25 mm | 49 | 48 | 48 | 46 | 48 | 47 |
| Failure mode | FF | FF | FF | FF | FF | FF |
| at 90° C., N/25 mm | 21 | 25 | 27 | 28 | 25 | 32 |
| Failure mode | Coh | FF/Coh | FF/Coh | FF/Coh | FF/Coh | FF/Coh |
| at 120° C., N/25 mm | 9.6 | 8.6 | 12 | 5.9 | 10.4 | 11.3 |
| Failure mode | Coh | Coh | FF/Coh | Coh | Coh | FF/Coh |
| Thermal creep on | | | | | | |
| PP/TPO-2 | | | | | | |
| at 110° C. | Pass | Pass | Pass | Pass | Pass | Pass |
| at 120° C. | Fail | Fail | Pass | Fail | Pass | Pass |
| Dead Load test, PP- | | | | | | |
| 1/PP-1, 24 hrs | | | | | | |
| 200 g at 110° C. | Pass | Pass | Pass | Pass | Pass | Fail |
| 300 g at 120° C. | Pass | Fail | Fail | Pass | Pass | |
| 300 g at 130° C. | Pass | | | Pass | Pass | |
| 500 g at 110° C. | Pass | | | Pass | Pass | |
| 500 g at 120° C. | Fail | | | Pass | Pass | |
| 500 g at 130° C. | | | | Fail | Pass | |

NT = not tested;
FF = foil failure (in foam layer);
Coh = cohesive failure of adhesive composition

It was also noted that the lower the ratio of tackifier resin to inventive copolymer in the formulation, the higher temperature was passed in thermal creep test, corresponding to increased peel strength at higher temperature. This correlation provides the formulator an opportunity to balance the heat resistance and peel strength of the composition by varying the amount of tackifier or by using no tackifier resin.

TABLE 16

| | Inv | Inv | Inv | Inv | Inv | Inv |
|---|---|---|---|---|---|---|
| | Ex 66 | Ex 67 | Ex 42 | Ex 68 | Ex 69 | Ex 70 |
| Ingredients | | | | | | |
| Inv Ex 20 | 50 | 60 | 70 | 80 | 90 | 100 |
| Eastotac H-130R | 45 | 35 | 25 | 15 | 5 | 0 |
| Epolene E43 | 5 | 5 | 5 | 5 | 5 | 0 |
| Irganox 1010 | 0.2 | 0.2 | 0.2 | 0.2 | 0.2 | 0 |
| Properties | | | | | | |
| Ratio tackifier | 0.9 | 0.6 | 0.4 | 0.2 | 0.06 | 0 |
| resin:inventive | | | | | | |
| copolymer | | | | | | |
| Viscosity at 190° C., | 4,590 | 6,857 | 9,750 | 11,284 | 14,080 | 20,350 |
| cP | | | | | | |
| RBSP, ° C. | 141 | 143 | 144 | 146 | 146 | 145 |
| Tensile strength, | 2 | 4 | 5 | 5 | 6 | 6 |
| MPa | | | | | | |
| Elongation, % | 43 | 459 | 533 | 381 | 380 | 420 |
| SAFT, PP/PP, ° C. | 127 | 136 | 142 | 142 | 147 | 145 |
| 180 degree peel | | | | | | |
| strength, PP/TPO- | | | | | | |
| 2 | | | | | | |
| at 25° C., N/25 mm | 55 | 47 | 55 | 50 | 67 | 71 |
| Failure mode | FF | FF/Adh | FF/A | FF/Adh | FF | FF |
| at 90° C., N/25 mm | 25 | 22 | 19 | 21 | 27 | 29 |
| Failure mode | FF/Coh | FF/Coh | FF/C | FF/Coh | FF | FF |
| at 120° C., N/25 mm | 5.1 | 5.8 | 7.0 | 8.7 | 13 | 13 |
| Failure mode | Adh/Cph | Adh/Cph | Coh | FF/Coh | FF | FF/Coh |
| Thermal Creep, | | | | | | |
| PP/TPO-2 | | | | | | |
| at 100° C. | FAIL | pass | | | | |
| at 110° C. | FAIL | FAIL | pass | pass | pass | pass |
| at 120° C. | | | FAIL | FAIL | pass | Pass |
| Dead Load test, | | | | | | |
| PP-1/PP-1, 1 day | | | | | | |
| 200 g at 110° C. | FAIL | FAIL | FAIL | FAIL | FAIL | FAIL |

FF = foil failure (in foam layer);
coh = cohesive failure of adhesive composition;
adh = adhesive failure of adhesive composition;
NT = not tested

3.4 Blend with Other Polymers

Table 17, Table 18, and Table 19 show Inventive Compositions blending the Inventive heat resistant propylene-ethylene copolymers with styrene block copolymers, amorphous polyolefin polymers or metallocene-catalyzed alpha-polyolefin polymers. The listed ingredients are provided in weight percentages, based on the total weight of the adhesive. The amount of antioxidant added was based on the total weight of the other ingredients. These examples are illustrative that these classes of polymers can be blended with the inventive copolymers and maintain heat resistance and obtain an advantageous balance of properties. Those skilled in the art can use these formulations as starting points for further formulation.

In Example adhesives shown in Table 17, the inventive copolymer Example 18 was blended with Kraton G1643, a commercial triblock copolymer based on styrene and ethylene/butylene at ratios of SEBS: inventive copolymer about 0.09:1, about 0.14:1 and about 0.17:1. The blend of inventive copolymers and SEBS Inventive Example 40 had foil failure at 90° C. 180 degree peel strength, PP/TPO-2, passed 120° C. thermal creep testing, PP/TPO-1, and passed Dead Load test, PP-1/PP-1, 1 day, 500 g at 110° C., demonstrating a surprising retention of heat resistance from the inventive copolymer in the composition.

The presence of the SEBS polymer in a formulation with tackifier resin and wax(es) generally reduced the 120° C. heat resistance of the inventive compositions, as shown by the cohesive failure in 180 degree peel strength testing at 120° C. and failure at 120° C. thermal creep testing, PP/TPO-1. Including Epolene N-15 wax in the inventive compositions with both polymers and wax generally improved the peel performance.

TABLE 17

| | Inv | Inv | Inv | Inv | Inv | Inv | Inv | Inv |
|---|---|---|---|---|---|---|---|---|
| | Ex 40 | Ex 71 | Ex 72 | Ex 73 | Ex 74 | Ex 75 | Ex 76 | Ex 77 |
| Ingredients | | | | | | | | |
| Inv Ex 18 | 69.9 | 65.9 | 62.7 | 63.5 | 60.5 | 54.4 | 51.9 | 49.5 |
| Eastotac H-130R | 25.0 | 23.5 | 22.4 | 22.7 | 21.6 | 31.8 | 30.3 | 28.9 |
| Kraton ™ G 1643 | | 5.6 | 5.4 | 9.1 | 8.6 | 9.1 | 8.6 | 8.3 |
| MS | | | | | | | | |
| Epolene E43 | 5.0 | 4.7 | 4.5 | 4.5 | 4.3 | 4.5 | 4.3 | 4.1 |
| Epolene N15 | | | 4.9 | | 4.8 | | 4.8 | 9.1 |
| Irganox 1010 | 0.2 | 0.2 | 0.2 | 0.2 | 0.2 | 0.2 | 0.2 | 0.2 |
| Properties | | | | | | | | |
| Ratio | 0 | 0.09 | 0.09 | 0.14 | 0.14 | 0.17 | 0.17 | 0.17 |
| SEBS:inventive | | | | | | | | |
| copolymer | | | | | | | | |
| Viscosity at 190° C., | 11,220 | 15,650 | | 17,460 | | 12,430 | | |
| cP | | | | | | | | |
| RBSP, ° C. | 147 | 146 | | 146 | | 145 | | |
| Tensile strength, | 6 | 7 | | 7 | | 7 | | |
| MPa | | | | | | | | |
| Elongation, % | 654 | 701 | | 691 | | 728 | | |
| 180 degree peel | | | | | | | | |
| strength, PP/TPO- | | | | | | | | |
| 2 | | | | | | | | |
| at 25° C., N/25 mm | 56 | 42 | 45 | 42 | 48 | 41 | 48 | 45 |
| Failure mode | FF | FF | FF | FF | FF | FF | FF | FF |
| at 90° C., N/25 mm | 27 | 19 | 23 | 20 | 23 | 20 | 24 | 24 |
| Failure mode | FF/ | FF/ | FF/ | FF/ | FF/ | FF/ | FF | FF |
| | Coh | coh | coh | coh | coh | coh | | |
| at 120° C., N/25 mm | 9.4 | 5.8 | 8.6 | 8.1 | 10 | 6.7 | 11 | 10 |
| Failure mode | Coh | Coh | FF/ | Coh | FF/ | FF/ | FF/ | FF/ |
| | | | Coh | | Coh | coh | coh | coh |
| Thermal Creep, | | | | | | | | |
| PP/TPO-2 | | | | | | | | |
| at 110° C. | Pass | Pass | Pass | Pass | Pass | Pass | Pass | Pass |
| at 120° C. | Pass | Fail | Fail | Fail | Fail | Fail | Fail | Fail |
| Dead Load test, | | | | | | | | |
| PP-1/PP-1, 1 day | | | | | | | | |
| 200 g at 110° C. | Pass | Pass | Pass | Pass | Pass | Fail | Pass | Pass |
| 300 g at 120° C. | Pass | Fail | Fail | Pass | Fail | | Pass | Fail |
| 500 g at 110° C. | Pass | | | Pass | | | Pass | |
| 500 g at 120° C. | Fail | | | Pass | | | Pass | |

FF = foil failure (in foam layer);
coh = cohesive failure of adhesive composition;
adh = adhesive failure of adhesive composition;
NT = not tested

In Inventive Examples in Table 18, the heat resistant copolymer Inventive Example 18 was blended with commercial polymer Comparative Example 7 in different ratios and with or without extra wax. Unexpectedly, it was found that addition of Comparative Example 7 to the inventive copolymer reduced the heat resistance of the adhesive composition. However, the results can be viewed in the reverse in that the inventive copolymer unexpectedly improved the heat resistance of a composition based on the Comparative Example 7 polymer. Additional Epolene N15 wax seemed to improve thermal creep performance but decreased dead load performance.

TABLE 18

| | Inv | Inv | Inv | Inv | Inv | Comp |
|---|---|---|---|---|---|---|
| | Ex 40 | Ex 78 | Ex 79 | Ex 80 | Ex 81 | Ex 10 |
| Ingredients | | | | | | |
| Inv Ex 18 | 69.9 | 42.4 | 34.9 | 21.1 | | |
| Comp Ex 7 | | 21.1 | 34.9 | 42.4 | 63.5 | 69.9 |
| Eastotac H-130R | 25 | 22.7 | 25 | 22.7 | 22.7 | 25 |
| Epolene E43 | 5 | 4.5 | 5 | 4.5 | 4.5 | 5 |
| Epolene N15 | | 9.1 | | 9.1 | 9.1 | |
| Irganox 1010 | 0.2 | 0.2 | 0.2 | 0.2 | 0.2 | 0.2 |
| Properties | | | | | | |
| Ratio second | 0 | 0.5 | 1 | 2 | N.A. | N.A. |
| polymer:inventive | | | | | | |
| copolymer | | | | | | |
| 180 degree peel | | | | | | |
| strength, PP/TPO-2 | | | | | | |
| at 25° C., N/25 mm | 56 | 49 | 56 | 47 | 45 | 51 |
| Failure mode | FF | FF | FF | FF | FF | FF |
| at 90° C., N/25 mm | 27 | 16 | 13 | 17 | 11 | 6 |
| Failure mode | FF/ | FF/ | Coh | FF/ | Coh | Coh |
| | Coh | Coh | | Coh | | |
| at 120° C., N/25 mm | 9.4 | 5.7 | 4.1 | 4.3 | 2.7 | 1.5 |
| Failure mode | Coh | Coh | Coh | Coh | Coh | Coh |
| Thermal Creep, | | | | | | |
| PP/TPO-2 | | | | | | |
| at 90° C. | Pass | Pass | Pass | Pass | Fail | Fail |
| at 100° C. | Pass | Pass | Fail | Pass | | |
| at 110° C. | Pass | Pass | | Fail | | |
| at 120° C. | Pass | Fail | | | | |
| Dead Load test, | | | | | | |
| PP-1/PP-1 | | | | | | |
| 1 day, wt. 200 g at | Pass | Pass | Pass | Pass | Fail | Fail |
| 110° C. | | | | | | |
| 1 day, wt. 300 g at | Pass | Fail | Pass | Fail | | |
| 120° C. | | | | | | |
| 1 day, wt. 300 g at | Pass | | Fail | | | |
| 130° C. | | | | | | |
| 1 day, wt. 500 g at | Pass | | | | | |
| 110° C. | | | | | | |

FF = foil failure (in foam layer);
coh = cohesive failure of adhesive composition;
adh = adhesive failure of adhesive composition;
NT = not tested

In Inventive Example adhesives shown in Table 19, the Inventive Example 18 copolymer was blended with commercially available copolymer produced by Ziegler-Natta catalyst (in Inventive Example 82) or with a commercially available polyolefin copolymer produced with Metallocene catalyst (in Inventive Example 83). The inventive adhesives exhibited not only excellent tensile strength and elongation, but also high SAFT that is 22% greater than the SAFT of Comparative Example 10, and 180 degree peel strength at 25° C., PP/TPO-1, that is from about 5% to about 66% greater than Comparative Example 10, and 180 degree peel strength at 90° C., PP/TPO-1, that is from about 69% to about 190% greater than Comparative Example 10. Both the high SAFT and the higher peel strength at 90° C. illustrate the surprising heat resistance of the formulations containing the novel propylene-ethylene copolymers. The inventors noted that the Inventive Examples 40, 69 and 70 surprisingly also had tensile strengths from about 150% to about 260% greater than the tensile strength of Comparative Example 10.

TABLE 19

| | Inv Ex | Inv Ex | Inv Ex | Comp |
|---|---|---|---|---|
| | 40 | 82 | 83 | Ex 10 |
| Ingredients | | | | |
| Inv Ex 18 | 70 | 63 | 63 | |
| L-Modu ™ S901 | | | 7 | |
| Comparative Ex 7 | | | | 70 |
| Vestoplast ™ 888 | | 7 | | |
| Eastotac H-130R | 25 | 25 | 25 | 25 |
| Epolene E43 | 5 | 5 | 5 | 5 |
| Irganox 1010 | 0.2 | 0.2 | 0.2 | 0.1 |
| Properties | | | | |
| Viscosity at 190° C., cP | 11,220 | 11,400 | 14,150 | 15,920 |
| RBSP, ° C. | 147 | 146 | 144 | 150 |
| Tensile strength, MPa | 6 | 5 | 7 | 2 |
| Elongation, % | 654 | 535 | 596 | 800 |
| SAFT, PP/PP, ° C. | 142 | 141 | 141 | 116 |
| 180 degree peel | 66 | 47 | 42 | 40 |
| strength at 25° C., | | | | |
| PP/TPO-1, N/25 mm | | | | |
| 180 degree peel | 5 | 3 | 3 | 2 |
| strength at 90° C., | | | | |
| PP/TPO-1, N/25 mm, | | | | |

### 4. Woodworking Application

Woodworking applications includes profile wrapping, laminating and other wood assembly with veneer, paper, foil and plastic. The adhesive needs to have low odor, as well as a higher heat resistance and greater cohesive strength than typically available with current commercial polyolefin polymers. The inventive propylene-ethylene heat resistant copolymers address this need in formulation of woodworking adhesives.

Tables 20A and 20B compare the heat resistance (measured by SAFT & 90 degree creep test) and lap shear strength of selected Inv Exs that comprise inventive copolymers and Comparative Example 10.

Compared to the Comparative Example 10, Inv Exs 33, 36, 37, 38 and 41 all unexpectedly had about 30% higher SAFT, about 8% to about 20% higher 90-degree creep failure temperature for assembly of MDF board and Tecofoil V paper, and about 80% to about 230% higher Lap shear strength, measured as specified in the table.

TABLE 20A

| | Inv | Inv | Inv | Inv | Inv | Comp |
|---|---|---|---|---|---|---|
| | Ex 33 | Ex 36 | Ex 37 | Ex 41 | Ex 38 | Ex 10 |
| Viscosity@190° C., cP | 10,400 | 9,550 | 4,420 | 10,420 | 10,250 | 15,920 |
| RBSP, ° C. | 143 | 144 | 148 | 146 | 144 | 150 |
| Open time, sec.(0.1 mm) | NT | NT | NT | NT | NT | 20-25 |
| Open time, sec.(0.5 mm) | 45-55 | 50-60 | 45-50 | 45-50 | 45-50 | 65-75 |
| Tensile strength, Mpa | 5 | 5 | 4 | 5 | 6 | 2 |
| Elongation, % | 616 | 634 | 665 | 686 | 460 | 800 |
| SAFT, birch wood, ° C. | 139 | 138 | 138 | 138 | 138 | 105 |
| 90 degree Creep failure | 137 | 143 | 135 | 140 | 133 | 123 |
| temperature, MDF | | | | | | |
| board/Tecofoil V paper, ° C. | | | | | | |
| weight = 10 g | 137 | 143 | 135 | 140 | 133 | 123 |
| weight = 40 g | NT | NT | NT | NT | 105 | 100 |
| Lap shear strength, birch | 482 | 544 | 539 | 526 | 848 | 266 |
| wood, psi | | | | | | |

TABLE 20B

| | Inv Ex | Inv Ex | Inv Ex |
|---|---|---|---|
| | 113 | 115 | 117 |
| Viscosity at 190° C. (cP) | 6390 | 11560 | 11200 |
| RBSP (° C.) | 142 | 143.3 | 143.7 |
| Open time, 0.1 mm (sec.) | NT | 15 | NT |
| Open time, 0.5 mm (sec.) | NT | 35-40 | NT |
| Tensile strength at break | 7 | 8 | 8 |
| (MPa) | | | |
| Elongation at break (%) | 517 | 311 | 599 |
| SAFT, birch wood, ° C. | 135 | 137 | 136 |
| 90 degree Creep failure | | | |
| temperature, MDF | | | |
| board/Tecofoil V paper, ° C. | | | |
| weight = 10 g | 117 | 135 | 130 |
| weight = 40 g | NT | 110 | NT |
| Lap shear strength, birch | 754 | 825 | 632 |
| wood, psi | | | |

### 5. Packaging Application

The inventive heat resistance copolymers Inventive Examples 8, 22 and 23 in Family (4) with viscosity from 3,000 to 6,000 cp at 190° C. and RBSP over 140° C. were surprisingly highly suitable for use in packaging adhesives and addressed the need for adhesives that have resistance to the high temperatures experienced by cases, cartons, and packages when stored in warehouses that are not temperature controlled, particularly when pallets of products are stacked high. Such adhesives can be used for boxes, cases, sealing cartons, and other applications where heat resistance is needed. Illustrative formulations are given in Tables 21A, 21B, and 21C comprising the low viscosity, heat resistant propylene-ethylene copolymers, tackifier and mixture of PE wax, PP wax and functionalized PP wax. The formulations vary from 37% to 76% polymer, 5% to 35% tackifier resin, and 10% to about 33% total wax, resulting in formulated adhesive viscosity at 180° C. ranging from about 415 cP to about 4000 cP. The additional level of the maleated-PP wax was either 2% or 5%, based on the total weight of the formulation. The selection of waxes and the ratio of the PE wax, PP wax, and maleated-PP wax used can be varied by one skilled in the art to adjust the balance of the formulated adhesive viscosity, RBSP, SAFT, adhesion and other properties. Baker-Hughes Polywax 850 (PE wax) has a melting point of 107° C., and viscosity of 10 cP at 150° C., per the technical data sheet, and Honeywell MAPP AC-596 Maleic Anhydride copolymer has a Mettler Drop Point (ASTM D-3954) of 141° C. and viscosity of 150 cP at 10° C., per the technical data sheet. The examples given are not all encompassing but indicate the wide range of properties that can be obtained while maintaining heat resistance, as evidenced by the fiber tear at 60° C. performance.

Inventive Examples 84, 89 and 96 had a weight ratio of polymer/tackifier/wax around 75/15/10 by weight and a surprisingly desirable combination of viscosity, room temperature fiber tear on corrugated cardboard, 60° C. fiber tear on corrugated cardboard and shear adhesion failure temperature range for packaging application. This composition also contributed to the best fiber tear percentage tested on both room temperature and 60° C., and showed excellent thermal resistance based on SAFT (132° C. to 134° C.).

Surprisingly, Inventive Example 89 with almost 17% total wax content had excellent fiber tear at room temperature (93%) and at 60° C. (97%) and a 134° C. SAFT; the overall formula was 70/30/17 polymer/tackifier/wax.

Unexpectedly, Inventive Examples 93 and 95, with formula 50/27/23, had excellent 60° C. fiber tear (92-98%) and acceptable room temperature fiber (55-65%) accompanied by a very low viscosity (657-675 cP at 180° C.) that is highly desirable for high-speed packaging lines.

TABLE 21A

| | Inv | Inv | Inv | Inv | Inv | Inv | Inv |
|---|---|---|---|---|---|---|---|
| | Ex 84 | Ex 85 | Ex 86 | Ex 87 | Ex 88 | Ex 89 | Ex 90 |
| Ingredients | | | | | | | |
| Inv Ex 22 | 76 | | | 37 | | | |
| Inv Ex 23 | | 37 | | | 76 | 70.3 | |
| Inv Ex 8 | | | 37 | | | | 76 |
| Regalite ™ | 14 | 30 | 30 | | 14 | 13 | 14 |
| R1125 | | | | | | | |
| Eastotac ™ | | | | 35 | | | |
| H130W | | | | | | | |
| Polywax ™ 850, | 6 | 26 | 26 | 11 | 6 | 11.1 | 6 |
| PE wax | | | | | | | |
| Licocene ™ PP | 2 | 2 | 2 | 12 | 2 | 3.7 | 2 |
| 6102, PP wax | | | | | | | |
| AC ™-596, Ma- | 2 | 5 | 5 | 5 | 2 | 2 | 2 |
| PP wax | | | | | | | |
| Irganox ™ 1010 | 0.2 | 0.2 | 0.2 | 0.2 | 0.2 | 0.2 | 0.2 |
| Formulation | | | | | | | |
| Properties & | | | | | | | |
| Performance | | | | | | | |
| Room | flexible | brittle | brittle | slightly | very | slightly | slightly |
| temperature | | | | flexible | flexible | flexible | flexible |
| flexibility | | | | | | | |
| Molten | Clear | Clear | Clear | Clear | Clear | Clear | Clear |
| appearance | | | | | | | |
| Viscosity @ | 1,940 | 419 | 583 | 480 | NT | 2,080 | NT |
| 180° C., cP | | | | | | | |
| RBSP, ° C. | 140 | 130 | 127 | 133 | NT | 141 | NT |
| (ASTM E-28) | | | | | | | |
| room | 100 | 0 | 0 | 5 | 100 | 93 | 100 |
| temperature | | | | | | | |
| fiber tear (%, avg | | | | | | | |
| of 2) | | | | | | | |
| 60° C. fiber tear | 100 | 20 | 5 | 20 | 88 | 97 | 90 |
| (%, avg of 3) | | | | | | | |
| PAFT, ° C., | 37 | NT | NT | NT | NT | 50 | NT |
| ASTM, Kraft, | | | | | | | |
| 100 g | | | | | | | |
| SAFT, ° C., | 133 | NT | NT | NT | NT | 134 | NT |
| ASTM, Kraft, | | | | | | | |
| 500 g | | | | | | | |

TABLE 21B

| | Inv | Inv | Inv | Inv | Inv | Inv |
|---|---|---|---|---|---|---|
| | Ex 91 | Ex 92 | Ex 93 | Ex 94 | Ex 95 | Ex 96 |
| Ingredients | | | | | | |
| Inv Ex 22 | | 56 | 50 | 56 | 50 | 85 |
| Inv Ex 23 | | | | | | |
| Inv Ex 8 | 74.5 | | | | | |
| Regalite ™ | 13.7 | 30 | 26.8 | | | 5 |
| R1125 | | | | | | |
| Eastotac ™ | | | | 30 | 26.8 | |
| H130W | | | | | | |
| Polywax ™ 850, | 5.9 | 10 | 17.8 | 10 | 17.8 | 6 |
| PE wax | | | | | | |
| Licocene ™ PP | 3.9 | 2 | 3.6 | 2 | 3.6 | 2 |
| 6102, PP wax | | | | | | |
| AC ™-596, Ma- | 2 | 2 | 1.8 | 2 | 1.8 | 2 |
| PP wax | | | | | | |
| Irganox ™ 1010 | 0.2 | 0.2 | 0.2 | 0.2 | 0.2 | 0.2 |
| Formulation | | | | | | |
| Properties & | | | | | | |
| Performance | | | | | | |
| Room | slightly | extremely | slightly | extremely | slightly | slightly |
| temperature | flexible | flexible | brittle | flexible | brittle | flexible |
| flexibility | | | | | | |
| Molten | Clear | Clear | Clear | Clear | Clear | Clear |
| appearance | | | | | | |
| Viscosity @ | 3980 | NT | 675 | NT | 657 | 2340 |
| 180° C., cP | | | | | | |
| RBSP, ° C. | 139 | NT | 131 | NT | 132 | 142 |
| (ASTM E-28) | | | | | | |
| room | 100 | 88 | 65 | 98 | 55 | 99 |
| temperature | | | | | | |
| fiber tear (%, avg | | | | | | |
| of 2) | | | | | | |
| 60° C. fiber tear | 100 | 77 | 92 | 100 | 98 | 80 |
| (%, avg of 3) | | | | | | |
| PAFT, ° C., | 43 | NT | NT | NT | NT | NT |
| ASTM, Kraft, | | | | | | |
| 100 g | | | | | | |
| SAFT, ° C., | 132 | NT | NT | NT | NT | NT |
| ASTM, Kraft, | | | | | | |
| 500 g | | | | | | |

TABLE 21C
Performance properties of adhesive composition comprising
inventive copolymer produced with Gen 5/6 catalysts.

| | Inv Ex 126 |
|---|---|
| Ingredients | |
| Inv Ex 107 | 76 |
| Regalite ™ R1125 | 14 |
| Polywax ™ 850, PE wax | 6 |
| Licocene ™ PP 6102, PP wax | 2 |
| ACTM-596, Ma-PP wax | 2 |
| Irganox ™ 1010 | 0.2 |
| Formulation Properties | |
| & Performance | |
| Room temperature flexibility | flexible |
| Molten appearance | Clear |
| Viscosity @ 180° C., cP | 2,070 |
| RBSP, ° C. (ASTM E-28) | 138.5 |
| room temperature fiber tear (%, avg of 3) | 100 |
| 60° C. fiber tear (%, avg of 3) | 95 |
| PAFT, ° C., ASTM, Kraft, 100 g | 38 |
| SAFT, ° C., ASTM, Kraft, 500 g | 133 |

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “about” refers to any value in the range of 90% to 110% of the specified value. However, it should be noted that all values associated with “about” include support of the specific value itself and the range associated with “about” the specific value. For example, “about 10” provides support for a specific value of “10” and a value ranging from 9 to 11. Furthermore, the term “about” may be associated with any specific value recited herein.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

When a numerical sequence is indicated, it is to be understood that each number is modified the same as the first number or last number in the numerical sequence or in the sentence. For example, each number is “at least,” or not more than,” as the case may be and each number is in an “or” relationship. In an exemplary scenario, “at least 10, 20, 30, 40, 50, 75 weight percent . . . ” means the same as “at least 10 weight percent, or at least 20 weight percent, or at least 30 weight percent, or at least 40 weight percent, or at least 50 weight percent, or at least 75 weight percent.”

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A propylene-ethylene copolymer comprising propylene and ethylene; wherein the propylene-ethylene copolymer:
(a) comprises 89 to 98 weight percent of propylene,
(b) has a Ring and Ball softening point of at least 135° C.,
(c) has a triad tacticity (mm %) of at least 50 percent, and
(d) has a heat of crystallization (Hc, 20° C./min cooling rate) of at least 25 J/g.

2. The propylene-ethylene copolymer according to claim 1, wherein the propylene-ethylene copolymer comprises 0.5 to 11 weight percent of ethylene.

3. The propylene-ethylene copolymer according to claim 1, wherein the propylene-ethylene copolymer has a viscosity at 190° C. of 1,000 to 50,000 cP.

4. The propylene-ethylene copolymer according to claim 1, wherein the propylene-ethylene copolymer:
(a) has a viscosity at 190° C. of 2,000 to 7,000 cP,
(b) exhibits a needle penetration of 0.1 to 21 dmm,
(c) exhibits a tensile strength at break of 1.5 to 8 MPa, and
(d) a heat of crystallization of 25 to 55 J/g.

5. The propylene-ethylene copolymer according to claim 1, wherein the propylene-ethylene copolymer:
(a) has a viscosity at 190° C. of 7,000 to 15,000 cP,
(b) exhibits a needle penetration of 0.1 to 21 dmm,
(c) exhibits a tensile strength at break of 3 to 10 MPa, and
(d) a heat of crystallization of 25 to 55 J/g.

6. The propylene-ethylene copolymer according to claim 1, wherein the propylene-ethylene copolymer:
(a) has a viscosity at 190° C. of 15,000 to 27,000 cP,
(b) exhibits a needle penetration of 0.1 to 21 dmm,
(c) exhibits a tensile strength at break of 3 to 14 MPa, and
(d) a heat of crystallization of 25 to 55 J/g.

7. The propylene-ethylene copolymer according to claim 1, wherein the propylene-ethylene copolymer:
(a) has a viscosity at 190° C. of greater than 27,000 cP,
(b) exhibits a needle penetration of 0.1 to 21 dmm,
(c) exhibits a tensile strength at break of at least 7 MPa, and
(d) a heat of crystallization of 25 to 50 J/g.

8. The propylene-ethylene copolymer according to claim 1, wherein the propylene-ethylene copolymer has:
(a) a Ring and Ball softening point ranging from 135 to 160° C.,
(b) a triad tacticity ranging from 50 to 70 percent,
(c) a needle penetration ranging from 0.1 to 21 dmm,
(d) a tensile strength at break ranging from 1.5 to 14 MPa, and
(e) an elongation at break of greater than 300 percent.

9-13. (canceled)

14. The propylene-ethylene copolymer according to claim 1, wherein the propylene-ethylene copolymer:
(a) exhibits a needle penetration of 0.1 to 21 dmm,
(b) has a heat of crystallization of 25 to 55 J/g, and
(c) has one of the following characteristics—
(i) has a viscosity at 190° C. of 2,000 to 7,000 cP and exhibits a tensile strength at break of 1.5 to 8 MPa, or
(ii) has a viscosity at 190° C. of 7,000 to 15,000 cP and exhibits a tensile strength at break of 3 to 8 MPa,
(iii) has a viscosity at 190° C. of 15,000 to 27,000 cP and exhibits a tensile strength at break of at 3 to 14 MPa, or
(iv) has a viscosity at 190° C. of greater than 27,000 cP, exhibits a tensile strength at break of at least 7 MPa, and a heat of crystallization of 25 to 50 J/g.

15. (canceled)

16. The propylene-ethylene copolymer according to claim 1, wherein the propylene-ethylene copolymer:
(a) has a viscosity at 190° C. of 15,000 to 50,000 cP,
(b) exhibits a tensile strength at break of at least 3 MPa, and
(c) exhibits an elongation at break of at least 300 percent.

17. (canceled)

18. (canceled)

19. An adhesive composition comprising:
(a) 5 to 100 weight percent of at least one propylene-ethylene copolymer, wherein the propylene-ethylene copolymer comprises ethylene and propylene, wherein the propylene-ethylene copolymer—
(i) comprises 89 to 98 weight percent of propylene,
(ii) has a Ring and Ball softening point of at least 135° C.,
(iii) has a triad tacticity (mm %) of at least 50 percent, and
(iv) has a heat of crystallization (Hc, 20° C./min cooling rate) of at least 25 J/g;
(b) 0 to 90 weight percent of at least one second polymer;
(c) not more than 70 weight percent of at least one tackifier;
(d) not more than 20 weight percent of a processing oil; and
(e) not more than 35 weight percent of at least one wax.

20. (canceled)

21. (canceled)

22. The adhesive composition according to claim 19, wherein the adhesive composition has:
(a) a shear adhesion failure temperature at least 135° C., and
(b) a thermal creep length of 5 mm or less at 120° C.

23. The adhesive composition according to claim 19, wherein the adhesive composition comprises:
(a) 10 to 70 weight percent of the propylene-ethylene copolymer,
(b) 5 to 55 weight percent of the second polymer,
(c) not more than 70 weight percent of the tackifier,
(d) not more than 20 weight percent of the processing oil, and
(e) not more than 20 weight percent of the wax.

24-27. (canceled)

28. The adhesive composition according to claim 19, wherein the propylene-ethylene copolymer comprises 0.5 to 11 weight percent of ethylene.

29. (canceled)

30. The adhesive composition according to claim 19, wherein the propylene-ethylene copolymer:
(a) has a viscosity at 190° C. of 2,000 to 7,000 cP,
(b) exhibits a needle penetration of 0.1 to 21 dmm,
(c) exhibits a tensile strength at break of 1.5 to 8 MPa, and
(d) a heat of crystallization of 25 to 55 J/g.

31. The adhesive composition according to claim 19, wherein the propylene-ethylene copolymer:
(a) has a viscosity at 190° C. of 7,000 to 15,000 cP,
(b) exhibits a needle penetration of 0.1 to 21 dmm,
(c) exhibits a tensile strength at break of 3 to 10 MPa, and
(d) a heat of crystallization of 25 to 55 J/g.

32. The adhesive composition according to claim 19, wherein the propylene-ethylene copolymer:
(a) has a viscosity at 190° C. of 15,000 to 27,000 cP,
(b) exhibits a needle penetration of 0.1 to 21 dmm,
(c) exhibits a tensile strength at break of 3 to 14 MPa, and
(d) a heat of crystallization of 25 to 55 J/g.

33. The adhesive composition according to claim 19, wherein the propylene-ethylene copolymer:
(a) has a viscosity at 190° C. of greater than 27,000 cP,
(b) exhibits a needle penetration of 0.1 to 21 dmm,
(c) exhibits a tensile strength at break of at least 7 MPa, and
(d) a heat of crystallization of 25 to 50 J/g.

34. The adhesive composition according to claim 19, wherein the propylene-ethylene copolymer has:
(a) a Ring and Ball softening point ranging from 135 to 160° C.,
(b) a triad tacticity ranging from 50 to 70 percent,
(c) a needle penetration ranging from 0.1 to 21 dmm,
(d) a tensile strength at break ranging from 1.5 to 14 MPa, and
(e) an elongation at break of greater than 300 percent.

35-39. (canceled)

40. The adhesive composition according to claim 19, wherein the propylene-ethylene copolymer:
(a) exhibits a needle penetration of 0.1 to 21 dmm,
(b) has a heat of crystallization of 25 to 55 J/g, and
(c) has one of the following characteristics—
(i) has a viscosity at 190° C. of 2,000 to 7,000 cP and exhibits a tensile strength at break of 1.5 to 8 MPa, or
(ii) has a viscosity at 190° C. of 7,000 to 15,000 cP and exhibits a tensile strength at break of 3 to 8 MPa,
(iii) has a viscosity at 190° C. of 15,000 to 27,000 cP and exhibits a tensile strength at break of at 3 to 14 MPa, or
(iv) has a viscosity at 190° C. of greater than 27,000 cP, exhibits a tensile strength at break of at least 7 MPa, and a heat of crystallization of 25 to 50 J/g.

41. (canceled)

42. The adhesive composition according to claim 19, wherein the propylene-ethylene copolymer:
(a) has a viscosity at 190° C. of 15,000 to 50,000 cP,
(b) exhibits a tensile strength at break of at least 3 MPa, and
(c) exhibits an elongation at break of at least 300 percent.

43. An article comprising the adhesive composition of claim 19, wherein the article is selected from the group consisting of adhesives, sealants, caulks, roofing membranes, waterproof membranes, compounds and underlayments, carpet, laminates, laminated articles, tapes, labels, mastics, polymer blends, wire coatings, molded articles, heat seal coatings, disposable hygiene articles, insulating glass (IG) units, bridge decking, bitumen modification, asphalt modification, electronic housings, water proofing membranes, cable flooding/filling compounds, sheet molded compounds, dough molded compounds, overmolded compounds, rubber compounds, polyester composites, glass composites, fiberglass reinforced plastics, wood-plastic composites, polyacrylic blended compounds, lost-wax precision castings, investment casting wax compositions, book bindings, candles, windows, tires, films, gaskets, seals, o-rings, motor vehicles, motor bicycles, motor vehicle molded parts, motor vehicle extruded parts, clothing articles, rubber additive/processing aids, and fibers, wherein the adhesives comprise packaging adhesives, food contact grade adhesives, indirect food contact packaging adhesives, product assembly adhesives, woodworking adhesives, edge banding adhesives, profile wrapping adhesives, flooring adhesives, automotive assembly adhesives, structural adhesives, flexible laminating adhesives, rigid laminating adhesives, flexible film adhesives, flexible packaging adhesives, water activated adhesives, home repair adhesives, industrial adhesives, construction adhesives, furniture adhesives, mattress adhesives, pressure sensitive adhesives (PSA), PSA tapes, PSA labels, PSA protective films, self-adhesive films, laminating adhesives, flexible packaging adhesives, heat seal adhesives, industrial adhesives, hygiene nonwoven construction adhesives, hygiene core integrity adhesives, or hygiene elastic attachment adhesives.
